(19) United States
(12) Patent Application Publication
(10) Pub. No.: US 2006/0234390 A1
(43) Pub. Date: Oct. 19, 2006

(54) Process for determining target function and identifying drug leads

(76) Inventor: Alfred E. Slanetz, Cohasset, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/514,764

(22) PCT Filed: May 19, 2003
(86) PCT No.: PCT/US03/15831

§ 371 Date: Nov. 21, 2005

(30) Foreign Application Priority Data
May 17, 2002 (US) 60381607

(51) Int. Cl. C40B 30/04

(52) U.S. Cl. 436/518

(57) ABSTRACT

The present invention relates to methods for using chemical ligands to determine target function and identify drug leads.

### BACKGROUND OF THE INVENTION

### 1. INTRODUCTION

The present invention relates to a method of exposing targets to a plurality of potential ligands, collecting ligand-target pairs, using the ligand to analyze the target's biological function, and optionally identifying the ligand chemically and/or structurally. In one embodiment of the invention ligands are selected which bind to pharmaceutically relevant targets. In another embodiment of the invention, ligand-target pairs are collected and analyzed on a genomic scale. The invention further relates to a method of screening a plurality of potential ligands in at least one bioassay for a change in phenotype and using the hit(s) to identify the corresponding molecular target.

### 2. BACKGROUND OF THE INVENTION

2.1. Traditional Approach to Drug Discovery

In general drugs discovered in the last 50 years are based on a few hundred targets and there are presently about 450 validated targets used for screening by all of the pharmaceutical companies combined. These targets have typically been developed using the traditional approach to drug discovery in which the target is validated using reductionist biology including gene over-expression, gene knockout, gene sequence homology searching for functional domains, x-ray crystallography, or specific cellular and biological assays. Furthermore in drug discovery as it is practiced today, target validation, assay development, high throughput screening and lead generation are performed in series.

2.2. Genomics

The large number of uncharacterized genes from the completion of the sequencing of the human genome makes it difficult but essential for a pharmaceutical company to validate and choose only the right target to unleash the value of the human genome sequence. It is estimated that of the 100,000 or more genes in the human genome, at most 10,000 of these genes will be pharmaceutically useful targets. This huge number of genes is overwhelming the reductionist approach to gene validation thereby presenting a major bottleneck in drug discovery.

The accumulating mass of DNA sequence data has given rise to the field of functional genomics that promises to alleviate the bottleneck. Gene expression profiling can be studied using DNA arrays (De Risi J L et al., 1997, Science 278; 680). Protein expression profiling can be performed using protein arrays (Paweletz C P et al., 2000, Drug Dev. Research 49:34). Gene function can be studied by the introduction or mutation of a gene to induce a conditional change in phenotype. Alternatively, an antisense or ribozyme version of a gene may be expressed in a variety of cell lines or organisms including transgenic or knockout mice, C. elegans, zebra fish, Drosophila or yeast (Couture L A et al., 1996, Trends in Genetics 12:510; Nadeau J H et al., 1998, Curr. Opin. Genet. Dev. 8, 311).

Differential gene expression can be detected using a variety of techniques including: differential screening (Tedder T F et. al. 1988 PNAS 85:208), subtractive hybridization (Hedrick S M et. al. 1984, Nature 308:149), differential display (Liang P and Pardee A 1993 U.S. Pat. No. 5,262,311), gene microarray (Lockhart, D et al., 1996, Nature Biotechnology 14:1675; Schena M et. al., 1995, Science 270: 467; 2000, Nature Genetics 24:236), representational difference analysis (Hubank M et al., 1994, Nucleic Acids Research 22:5640), large scale sequencing of expressed sequence tags (EST's), reverse transcriptase PCR, serial analysis of gene expression (SAGE; Nacht M et al., 1999, Cancer Res. 59:5464) and laser capture microdissection (Sgroi D C et al., 1999, Cancer Research 59:5656). Microarray technology represents the current state of the art for genomics and has been used to study cell cycles, biochemical pathways, genome wide expression in yeast, cell growth, cell differentiation, cell responses to a single compound, genetic diseases (M. Schena, 1998, TIBTECH 16:301).

2.3. Identification and Characterization of Protein Targets

Using classical biochemical techniques, previously unknown receptors for small molecules have been identified at the protein level using in vitro biochemical methods including photo-crosslinking, radiolabeled ligand binding and affinity chromatography (Jakoby W B et al., 1974, Methods in Enzymology 46:1). These methods require purification of the protein. In order to clone the gene for the receptor, the peptide must be further sequenced and this sequence used to clone the cDNA for the protein. Small molecules can be radiolabeled and used to determine the molecular target (Kwon H J et. al., 1998, PNAS 95:3356). Alternatively, small molecules can be immobilized on an agarose matrix and used to screen extracts of a variety of cell types and organisms. For example, purvalanol B (a known inhibitor of cyclin-dependent kinases) was immobilized on an agarose matrix and used to screen extracts from a diverse collection of cell types and organisms and a number of proteins with kinase activity were isolated (Knockaert M et. al., 2000, Chem. Biol. 7:411). Alternatively, trapoxin is a cyclotetrapeptide that inhibits histone deacetylation and arrests the cell cycle. Two nuclear proteins co-purified with histone deacetylase activity from fractionated cell extracts on an affinity matrix covalently modified with trapoxin. Subsequently the proteins were sequenced and cDNAs encoding the proteins were cloned from a cDNA library (Taunton J et al., 1996, Science 272:408).

Currently, the primary system for studying protein-protein interactions is the yeast two hybrid system. In this approach, one protein is fused to the DNA binding domain and another protein is bound to the DNA activation domain of a eukaryotic transcription factor and expressed in the presence of a reporter gene which allows the yeast to grow. If the two heterologous proteins bring the two domains together, then the yeast containing the proteins which interact are selected by growth (Fields S et al., 1989, Nature 340:245).

A yeast “three hybrid” transcription activation system has been used to clone a gene encoding a previously identified receptor for the drug FK506. This three hybrid system displays an anchored derivative of the active ligand against a library of cDNAs fused to the transcriptional activation domain (Borchardt A. et al., 1997, Chem. Biol. 4:961; Licitra E J et al., 1996, PNAS 93:12817). In Licitra et al., the hormone binding domain of the rat glucocorticoid receptor was fused to the Lex A DNA binding domain, a cDNA encoding the FK506 receptor (FKBP12) was fused to the transcriptional activation domain and the two were expressed in the yeast two hybrid system. The yeast cells were plated on medium containing a heterodimer of covalently linked dexamethasone and FK506 and the cells grew in a way that may be inhibited by undimerized FK506. When the experiment was repeated with a cDNA expression library fused to the transcriptional activation domain in place of the cDNA encoding FK506 binding protein, the yeast which grew contained cDNA clones encoding the FK506 binding protein. However, this experiment was done using a chemical interacting with an known target. In Borchardt A et al., yeast cells in the presence of a FKBP12-GAL4 DNA binding domain fusion, the FR domain of the FK506 binding protein rapamycin associated protein, and rapamycin transcribe the HIS3 3 reporter genes allowing the cells to grow in the absence of histidine (Borchardt A et al., 1997, Chem Biol 4:961).

Expression cloning can be used to test for the target within a small pool of proteins (King R W et. al., 1997, Science 277:973). Peptides (Kieffer et. al., 1992, PNAS 89:12048), nucleoside derivatives (Haushalter K A et. al., 1999, Curr. Biol. 9:174), and drug-bovine serum albumin (drug-BSA) conjugate (Tanaka et. al., 1999, Mol. Pharmacol. 55:356) have been used in expression cloning.

Another useful technique to closely associate ligand binding with DNA encoding the target is phage display. In phage display, which has been predominantly used in the monoclonal antibody field, peptide or protein libraries are created on the viral surface and screened for activity (Smith G P, 1985, Science 228:1315). Phage are panned for the target which is connected to a solid phase (Parmley S F et al., 1988, Gene 73:305). One of the advantages of phage display is that the cDNA is in the phage and thus no separate cloning step is required. Dyax has used a phage display affinity column to isolate macromolecules but not small molecules (US97/04425).

Recently, Sche et al. used the natural product FK506 as an affinity probe to clone FKBP12 from a T7 cDNA phage display library. They used an affinity matrix bearing biotinylated FK506 to screen a phage library prepared with human brain cDNA. The phage particles remaining after two rounds of affinity selection shared a common 450 bp insert which corresponded to full length FKBP12.

Alternatives to phage display include plasmid display (Cull et al., 1992, PNAS 89:1865; Schatz P J et al., 1996, Methods Enzymol 267:171), polysome display (Mattheakis L C et al., 1996, PNAS 91:9022; Mattheakis L C, 1996, Methods Enzymol 267:195), protein tagging (Whitehom E A et al., 1995, Biotechnology 13:1215), ribosome display (Hanes J et al., 1998, PNAS 95:14130), and cell surface display in bacteria and eukaryotes (Georgiou G et al., 1997, Nat. Biotechnol 15:29; Chesnut J et. al., 1996, J. 1 mm Methods 193:17). Peptides or proteins can also be linked chemically via puromycin to the mRNA that encodes it (Roberts R et al., 1997, PNAS 94: 12297).

2.4. Chemical Genetics

Chemical genetics is a new and potentially powerful approach to defining gene function through the use of chemicals to cause a conditional change in gene expression or gene function. However, to date, it has not advanced far from traditional drug discovery using traditional high throughput cell based screening assays against known targets to which drugs are already available to find more hits to those targets. The current status of chemical genetics is demonstrated in the work of Haggarty S J et. al. (2000, Chem Biol 7:275) in which 139 compounds were identified from a high throughput screen of the Chembridge Diverset library for inhibition of mitosis in a cell based assay and then assayed in an in vitro tubulin polymerzation assay. Of the 139 compounds, 52 were antagonists which destabilized tubulin by the same mechanism as colchicines. One compound was demonstrated to be an agonist which stabilized tubulin by the same mechanism as taxol. 86 compounds had no effect and thus likely modulated mitosis via non-tubulin targets. For the compounds targeting non-tubulin targets based upon visible effects on the chromosomes and cytoskeleton, 7 were believed to be weak antagonists of tubulin and one (monasterol) was demonstrated to inhibit the kinesin-related protein Eg5 (Mayer et. al., 1999, Science 286:971). In the case of Haggarty S J et al., low affinity ligands were selected since assays were performed using a ligand concentration of 20 to 50 μM. However, low affinity ligands are of limited value in determining target function.

Rosania G R et. al. identified a novel small molecule, myoseverin, by a cell morphological screen which binds to tubulin to induce the reversible fission and proliferation of muscle cells. Unlike the current invention, Schulz is relying on the standard functional genomics DNA array approach to understand the mechanism (Rosania G R et. al., 2000, Nat Biotechnol 18:304). Chemicals have been used to study function since colchicines were shown to have an effect on mitosis in 1889 (Eigsti O, 1949, Science 110:692). However, current practice is limited to identifying ligands which bind to known targets or to unidentified targets which result in a particular phenotype.

Previous efforts to characterize the function of unknown genes are exemplified by orphan receptor analysis. Orphan receptors are encoded by genes which share DNA sequence similarity with previously identified receptors. On that basis, such sequences are placed into a receptor superfamily for which the natural physiological role and ligand are unknown. The present state of the art is to use genetic techniques or to use drugs or protein ligands known to bind to other members of the family to determine their function (Werme M et. al., 2000, Brain Res 863:112; Bordji K. et. al., 2000, J. Biol. Chem. 275:12243; Yang C., 1999, Cancer Res. 59:4519; Chiou L, 1999, Br. J. Pharmacol 128:103; Williams C, 2000, Curr. Opinion in Biotechnology 11:42).

2.5. Chemical Target Characterization

Once a target is validated, two major screening categories are applied: bioassays and mechanism based assays (Gordon et. al., 1994, J. Med. Chem. 37:1386). Bioassays measure an effect on a cell of the compounds being screened on viability or metabolism. For example, penicillin was discovered by its growth inhibition in bacterial culture. Mechanism based assays include biochemical assays measuring an effect on enzymatic activity, cell based assays in which the target and a reporter system (e.g., luciferase or β-galactosidase) have been introduced into a cell (Monks A et. al., 1997, Anticancer Drug Des. 12: 533), or binding assays. Binding assays can be performed with the target fixed to a well, bead (Boswoth N et al., 1989, Nature 1989, 341:167; Meldal M, 1994, PNAS 91, 3314) or chip (Sunberg S, 2000, Curr. Opin. In Biotechnol 11:47) or captured by an immobilized antibody, and the bound ligands are detected usually using calorimeter or by measuring fluorescence (Sunberg S, 2000, Curr. Opin. In Biotechnology 11:47).

In some newer binding assays, molecules binding to a target of known function have also been resolved by capillary electrophoresis (U.S. Pat. No. 5,783,397; US99/15458). In other new assays, libraries were weight-coded and deconvoluted using mass spectroscopy (Carell T et al., 1995, Chem Biol. 2: 171; Fang A S et. al., 1998, Comb Chem High Throughput Screen 1:23; US 99/23837; US99/00024). HPLC has also been used with mass spectroscopy to characterize combinatorial library purity and to analyze metabolites in plasma samples (Korfmacher W A et al., 1999, Rapid Commun Mass Spectrom 13:1991; Zeng L et al., 1998, Comb Chem High Throughput Screen 1:101; Nedved M L et al., 1996, Anal Chem 68: 4228; Zimmer D et al., 1999, J. Chromatogr A 854:23; Aubagnac J L, Comb Chem High Throughput Screen 2:289).

### 3. SUMMARY OF THE INVENTION

The present invention relates to the use of a target of unknown function to select for small molecules from a chemical library which are then used in an assay to determine the target's function. According to the invention, members of the chemical library are mixed with the protein in a biochemical binding assay and those that bind are then (sequentially or in parallel) used in a in vitro or in vivo bioassay to determine the function of the gene by a change in a measurable phenotype in a biological or pathological condition.

Alternatively, the invention uses chemicals which induce a phenotypic change in a bioassay to determine the identity of the target. The invention provides a method of screening a plurality of potential ligands in at least one bioassay, selecting ligands which produce a change in phenotype in a bioassay, and using the ligand to screen candidate targets to identify the particular target(s) responsible for the altered phenotype.

The invention can be used to define the function of genes and to simultaneously validate the drug target and generate a drug lead thus streamlining the drug discovery process. The structure activity relationship information provided by the parallel comparison of a large number of structurally diverse hits which bind to the target but have different activities in phenotypic assays can be used to rapidly optimize the lead. Using the invention, the massive numbers of genes provided by genomics can be systematically sorted and useful drug targets can be validated and selected for a given disease.

The present invention is different from the art because the latter describes screening against a known target while the present invention does not require any prior knowledge of target identity or function. Furthermore, the present invention does not absolutely require the constraint of a predetermined subunit of a particular mass in the construction of its library. According to the invention, virtually any ligand library produced by combinatorial or noncombinatorial means may be used. Non-limiting examples include chemical, peptide, natural product, natural product-like, sugar or antibody libraries. Peptides and proteins can be made to cross the cell membrane using a sequence from HIV TAT, HSV VP22 or Antennapedia peptides containing protein transduction domains (Swartz S R et al., 2000, Trends in Cell Biology 10:290). Libraries may consist of pools of ligands or may be collections of single ligands screened individually.

Accordingly, in one aspect, the invention features a method for selecting a candidate ligand which binds a target molecule. This method involves contacting an in vitro sample including a target molecule with a library of candidate ligands under conditions that allow complex formation between the target molecule and one or more of the candidate ligands. The complex is isolated, and one or more of the candidate ligands are recovered from the complex. Additionally, one or more recovered candidate ligands are identified.

In various embodiments of the above aspect, the target molecule is a molecule of unknown biological function or a molecule that has not been previously validated as a drug target. In other embodiments, the library includes at least two different chemical scaffolds or includes at least 11 different compounds. In other embodiments, the complex is isolated using size exclusion or biphasic chromatography (e.g., chromatography using an internal surface reverse phase (ISRP), GFF, or GFFII resin). In other embodiments, MS, IR, FTIR, NMR, and/or UV analysis is used to identify the recovered candidate ligand. In yet other embodiments, the method includes determining the mass to charge ratio of a parent peak, a fragment peak, and/or an isotope peak in the mass spectrum of the recovered candidate ligand. In one embodiment, the method also includes contacting the sample with a competitor ligand known to bind the target molecule. This competitor may reduce the number of low affinity candidate ligands that bind the target molecule, allowing the higher affinity candidate ligands to be selected.

In another aspect, the invention features another method for selecting a candidate ligand which binds a target molecule. This method involves contacting an in vitro sample including a first target molecule and a second target molecule with a library of candidate ligands under conditions that allow complex formation between the first target molecule and one or more of the candidate ligands and allow complex formation between the second target molecule and one or more of the candidate ligands. A first complex including the first target molecule bound to a candidate ligand and a second complex including the second target molecule bound to a candidate ligand are isolated. One or more of the candidate ligands from the first complex and/or from the second complex are recovered and identified. In one embodiment, the method also includes contacting the sample with a competitor ligand known to bind the first target molecule or the second target molecule.

Additionally, the invention provides various methods for determining the biological function of a target molecule, such as a naturally or non-naturally occurring protein, nucleic acid, carbohydrate, or other organic molecule. The methods may be used to determine the function of a gene or a protein of interest, such as gene or protein that is upregulation or downregulated in a particular disease state or in the presence of a particular biological stimuli (such as TNFα). The methods may also be used to identify therapeutically active compounds for the treatment of a disease state.

In one such aspect, the invention provides a method for determining the biological function of a target molecule. This method includes contacting an in vitro sample including a target molecule with a library of candidate ligands under conditions that allow one or more of the candidate ligands to bind the target molecule. A candidate ligand which binds the target molecule is selected. The effect of the selected candidate ligand in a biological assay is measured, thereby determining the biological function of the target molecule. In various embodiments, target molecule is a molecule of unknown biological function or a molecule that has not been previously validated as a drug target. In other embodiments, the target molecule is upregulated or downregulated in a disease state, in the presence of a physiological stimulus (e.g., a cytokine such as TNF), or during a specific cellular or biological process. In particular embodiments, the target molecule is upregulated or downregulated during angiogenesis, differentiation, proliferation, or insulin secretion. In one embodiment, the selected candidate ligand is identified using a method such as MS, IR, FTIR, NMR, UV, or any other appropriate method. In particular embodiments, the selected candidate ligand increases the activity of the target molecule in the biological assay. For example, the candidate ligand may activate an activity of the target molecule (such as an enzymatic activity), promote the production of the target molecule, increase the stability of the target molecule, alter the localization of the target molecule, or promote the association of the target molecule with another molecule. In other embodiments, the selected candidate ligand decreases the activity of the target molecule in the biological assay. For example, the candidate ligand may inhibit an activity of the target molecule, inhibit the production of the target molecule, decrease the stability of the target molecule, alter the localization of the target molecule, or inhibit the association of the target molecule with another molecule. Exemplary biological assays include a throughput screen using a nontransfected cell line, cell, tissue, or other biological system where the target is not previously known. In other embodiments, the biological assay involves determining the effect of the selected candidate ligand on a tissue from a organism having a disease or disorder or undergoing a specific cellular or biological process in the presence or absence of a physiological stimulus is measured, thereby determining the biological function of the target molecule. In one embodiment, the tissue is a mammalian tissue, such as a human tissue.

Methods for crosslinking or reacting two or more ligands which bind the same target molecule are also provided. These methods allow one or more target surfaces to promote or catalyze the reaction between two ligands. These methods may be used to screen a library of ligands to determine what ligands bind the target molecule and what products containing a combination of ligands bind the target molecule with the highest affinity. The products may be used as lead compounds in the development of therapeutics or used to characterize the active site of the target molecule. Related methods may be used to crosslink or react two or more ligands which bind different target molecules. These methods may be used to determine what target molecules interact with a target molecule of interest, thereby determining what molecules are in the same pathway as the target molecule of interest.

In another aspect, the invention features a method for reacting two or more ligands that bind a target molecule of interest. This method involves contacting a cell or in vitro sample including a target molecule with a first ligand (e.g., a first ligand having a first crosslinker) and with a second ligand under conditions that allow the target molecule to bind both the first ligand and the second ligand and allow the first ligand or the first crosslinker to covalently bind the second ligand, thereby generating a product including the first ligand and the second ligand. In some embodiments, target molecule is a molecule of unknown secondary or tertiary structure. In other embodiments, the location or the tertiary structure of the binding site in the target molecule for the first ligand or the second ligand is unknown. In a particular embodiment, the affinity of the product for the target molecule is greater than the affinity of the first ligand or the second ligand for the target molecule. In another embodiment, the product is used for drug discovery or development, lead optimization, or development of an agricultural or environmental agent. In yet another embodiment, the target molecule promotes or catalyzes the reaction between the first and second ligands. In another embodiment, the first ligand is reacted with a crosslinker prior to being contacted with the target molecule. In yet another embodiment, the first ligand, the second ligand, and a crosslinker are reacted in the presence or absence of the target molecule. In preferred embodiments, the method also includes identifying the products with the greatest affinity for the target molecule. For example, the method may also include (a) contacting an in vitro sample including the target molecule with one or more products under conditions that allow complex formation between the target molecule and one or more products, (b) isolating the complex, (c) recovering one or more products from the complex, and (d) identifying one or more recovered products.

In a related aspect, the invention features a method for selecting a candidate ligand which binds a target molecule. This method includes contacting an in vitro sample including a target molecule with a library of candidate ligands under conditions that allow complex formation between the target molecule and one or more candidate ligands. The complex is isolated, and one or more candidate ligand are recovered from the complex. In a preferred embodiment, more than one candidate ligand is identified in this manner. A cell or in vitro sample including the target molecule is contacted with a first recovered ligand and a second recovered ligand. The contacting is conducted under conditions that allow the target molecule to bind the first recovered ligand and the second recovered ligand and allow the first recovered ligand to covalently bind the second recovered ligand, thereby generating a product including the first recovered ligand and the second recovered ligand that has an affinity for the target molecule that is greater than the affinity of the first recovered ligand or the second recovered ligand for the target molecule. In some embodiments, the method also includes contacting an in vitro sample including the target molecule with one or more products under conditions that allow complex formation between the target molecule and one or more products. The complex is isolated, and one or more products are recovered from the complex and identified.

In another related aspect, the invention features another method for selecting a candidate ligand which binds a target molecule. This method includes contacting an in vitro sample including a target molecule with a library of candidate ligands under conditions that allow complex formation between the target molecule and more than one candidate ligand. The complex is isolated, and more than one candidate ligand is recovered from the complex. A first recovered ligand and a second recovered ligand are reacted, thereby generating a product including the first recovered ligand and the second recovered ligand that has an affinity for the target molecule that is greater than the affinity of the first recovered ligand or the second recovered ligand for the target molecule. In preferred embodiments, the method also includes contacting an in vitro sample including the target molecule with one or more products under conditions that allow complex formation between the target molecule and one or more products. The complex is isolated, and one or more products are recovered from the complex and identified.

In another aspect, the invention features a method for reacting two ligands that bind different target molecules. This method includes contacting a cell or in vitro sample including a first target molecule and a second target molecule with a first ligand (e.g., a first ligand having a first crosslinker) and with a second ligand. The contacting is conducted under conditions that allow (i) the first target molecule to bind the first ligand, (ii) the second target molecule to bind the second ligand, and (iii) the first ligand or the first crosslinker to covalently bind the second ligand, thereby generating a product including the first ligand and the second ligand. In one embodiment, the location or the tertiary structure of the binding site in the first target molecule for the first ligand and/or the location or the tertiary structure of the binding site in the second target molecule for the second ligand is unknown. In one embodiment, the generation of the product indicates that the first target molecule (e.g., a protein) and the second target molecule (e.g., a protein) interact in vivo or are part of the same biological pathway. In another embodiment, the product is used for drug discovery or development, lead optimization, or development of an agricultural or environmental agent. In yet another embodiment, one or both target molecules promote or catalyze the reaction between the first and second ligands. In another embodiment, the first ligand is reacted with a crosslinker prior to being contacted with the target molecules. In yet another embodiment, the first ligand, the second ligand, and a crosslinker are reacted in the presence or absence of the target molecules.

In another aspect, the invention provides a method for isolating a second protein which binds a first protein. This method involves contacting a cell or an in vitro sample including a first protein and a second protein with a first ligand (e.g., a first ligand having a first crosslinker) and with a second ligand. The contacting is conducted under conditions that allow (i) the first protein to bind the first ligand, (ii) the second protein to bind the second ligand, and (iii) the first ligand or the first crosslinker to covalently bind the second ligand, thereby generating a product including the first ligand and the second ligand and generating a complex including the product, the first protein, and the second protein. The complex is isolated, and the first protein and/or the second protein in the complex or recovered from the complex is identified. In one embodiment, the first and/or second protein includes a detectable group. In another embodiment, the second ligand includes a crosslinker. In one embodiment, the generation of the product indicates that the first protein and the second protein interact in vivo or are part of the same biological pathway. In another embodiment, the product is used for drug discovery or development, lead optimization, or development of an agricultural or environmental agent.

The invention also provides numerous methods for selecting a target molecule which binds a compound of interest. For example, the compound may be a molecule that appears to promote or inhibit a disease state. The selected target molecule may be used, for example, to study the disease, to identify other molecules associated with the disease, and to identify therapeutics with bind or modulate the activity of the target molecule or another member of the disease pathway.

In another aspect, the invention provides a method for selecting a candidate target molecule which binds a small molecule of interest. The method involves contacting an in vitro sample including a small molecule of interest with a library of candidate target molecules under conditions that allow complex formation between the small molecule of interest and one or more of the candidate target molecules. The complex is isolated, and one or more of the candidate target molecules are recovered from the complex, thereby selecting one or more candidate target molecules which bind the small molecule of interest. In various embodiments, the library of candidate target molecules is recombinantly produced or is obtained from an extract from a cell, tissue, or organism. The library of candidate target molecules can be unpurified, partially purified, or completely purified from other components prior to being contacted with the small molecule of interest. In various embodiments, the target molecules are expressed on the surface of phage or are not expressed on the surface of phage. In one embodiment, prior to contacting the small molecule with the library of candidate target molecules, the small molecule of interest is selected from a library of small molecules based on its effect in a biological assay. In one embodiment, the method also includes identifying the selected target protein. In particular embodiments, the small molecule of interest has a moiety other than an amino acid or has a molecular weight less than 5000, 4000, 3000, 2000, 1000, 750, 500, or 250 daltons.

In another aspect, the invention provides a method for selecting a target protein which binds a small molecule of interest. This method includes expressing in a population of cells a protein fusion including a target protein covalently linked to surface protein, the expression being carried out under conditions that allow the display of the protein fusion on the surface of the cells. The cells are contacted with a small molecule of interest, and the cells which bind the small molecule of interest are selected, thereby selecting the target proteins which bind the small molecule of interest. Exemplary cells include mammalian, bacterial, yeast, and insect cells. In one embodiment, the method also includes identifying the selected target protein. In particular embodiments, the small molecule of interest has a moiety other than an amino acid or has a molecular weight less than 5000, 4000, 3000, 2000, 1000, 750, 500, or 250 daltons

In another aspect, the invention features another method for selecting a target protein which binds a small molecule of interest. This method involves expressing in a population of cells a protein fusion including a target protein covalently linked to surface protein, the expression being carried out under conditions that allow the display of the protein fusion on the surface of viruses released from the cells infected with the virus. The viruses are contacted with a small molecule of interest, and the viruses which bind the small molecule of interest are selected, thereby selecting the target proteins which bind the small molecule of interest. In one embodiment, the method also includes identifying the selected target protein. In various embodiments, the virus is a bacteriophage or adenovirus. In particular embodiments, the small molecule of interest has a moiety other than an amino acid or has a molecular weight less than 5000, 4000, 3000, 2000, 1000, 750, 500, or 250 daltons. In yet other embodiments, the small molecule of interest does not contain biotin or is not naturally produced by bacteria. In still other embodiments, the small molecule of interest is a nucleic acid, lipid, or carbohydrate. In still other embodiments, the small molecule of interest is immobilized on a solid surface such as a magnetic or fluorescent bead. In other embodiments, an adenovirus is used to infect 293 cells or perc6 cells, or a bacteriophage is used to infect bacteria.

In another aspect, the invention features a method for selecting a target protein which binds a small molecule of interest. This method involves expressing in a population of cells or an in vitro sample a library of target proteins in which each target protein is covalently linked to a nucleic acid encoding the target protein. The cells or in vitro sample are contacted with a small molecule of interest, and the target proteins which bind the small molecule of interest are selected. In one embodiment, the method also includes identifying the selected target protein. In particular embodiments, the small molecule of interest has a moiety other than an amino acid or has a molecular weight less than 5000, 4000, 3000, 2000, 1000, 750, 500, or 250 daltons

In various embodiments of any of the above methods for selecting a target molecule or target molecule which binds a small molecule of interest, at least 2, 5, 10, 20, 50, 100, 1000, 10000, or more target molecules are contacted with the small molecule. In other embodiments, a target peptide or protein is associated with a polynucleotide encoding the target, using standard methods such as phage display, cell surface display, plasmid display, ribosome display, viral display). In other embodiments, the small molecule is immobilized on a solid surface, such as a column, bead, or magnetic bead. In other embodiments, the small molecule contains a fluorescent group, or the small molecule is indirectly or directly linked to a fluorescent group (e.g., linked through the binding of a fluorescently labeled antibody), and the complex of the small molecule and a target molecule is isolated using FACS sorting. In other embodiments, the small molecule of interest is a non-naturally occurring molecule or a naturally occurring molecule from an organism other than bacteria (e.g., such as a naturally occurring human molecule).

The invention also provides methods for identifying compounds that bind a target molecule before the target molecule is experimentally validated as a drug target. Additionally, methods are provided for identifying ligands for two or more target molecules. For example, binders can be simultaneously identified for multiple target molecules by performing an assay containing multiple target molecules or by performing multiple assays in parallel. These high throughput assays greatly increase the number of target molecules that can be analyzed.

Accordingly, in one aspect, the invention provides a method for selecting a candidate compound that binds or modulates the activity of a target molecule prior to validation of the target molecule as a drug target. This method involves contacting a cell or an in vitro sample including a target molecule that has not been previously validated as a drug target with a library of candidate compounds under conditions that allow one or more of the candidate compounds to bind or modulate the activity of the target molecule. A candidate compound which binds or modulates the activity of the target molecule is selected. In one embodiment, the selected candidate compound is identified. In other embodiments, the method also includes measuring the effect of the selected candidate compound in a biological assay, thereby determining the biological function of the target molecule. In yet other embodiments, the cell or in vitro sample includes at least 2, 5, 10, 20, 30, 50, 100, or more target molecules, and for each of the target molecules, a candidate compound is selected that binds or modulates the activity of the target molecule.

In another aspect, the invention features a method for selecting candidate compounds that bind or modulate the activity of target molecules. This method involves contacting a cell or an in vitro sample including a first target molecule and a second target molecule with a library of candidate compounds under conditions that allow one or more of the candidate compound to bind or modulate the activity of the first target molecule and allow one or more of the candidate compound to bind or modulate the activity of the second target molecule. A candidate compound which binds or modulates the activity of the first target molecule is selected, and a candidate compound which binds or modulates the activity of the second target molecule is selected. In one embodiment, one or more of the selected candidate compounds are identified. In other embodiments, the method also includes measuring the effect of one or more of the selected candidate compounds in a biological assay, thereby determining the biological function of the target molecule. In yet other embodiments, the cell or in vitro sample includes at least 5, 10, 20, 30, 50, 100, or more target molecules, and for each of the target molecules, a candidate compound is selected that binds or modulates the activity of the target molecule.

The invention also features a variety of databases. These databases are useful for storing the information obtained in any of the methods of the invention. These databases may also be used in the development of therapeutics and in the selection of a preferred therapeutic for a particular patient or class of patients. Many other uses of these databases are described herein.

In one such aspect, the invention features an electronic database including at least 10, 10², 10³, 10⁴, 10⁵, 10⁶, 10⁷, 10⁸, or 10⁹ records of target molecules correlated to records of ligands and their ability to bind or modulate the activity of the target molecules. In a related aspect, the invention provides an electronic database including a plurality of records of target molecules that have not been previously validated as drug targets and/or target molecules of unknown biological function correlated to records of ligands and their ability to bind or modulate the activity of the target molecules. In another related aspect, the invention features an electronic database including at least 10, 10², 10³, 10⁴, 10⁵, 10⁶, 10⁷, 10⁸, or 10⁹ records of target molecule domains correlated to records of ligands and their ability to bind the domains. By “domain” is meant a domain found in one or more proteins that catalyze the same type of reaction or that bind the same type of molecules; or the domains are identified as different protein structural motifs or functional families based upon the analysis of DNA or amino acid sequences, x ray crystal structures, or biological assays. For example, the database may contain records of ligands and their ability to bind a kinase domain (i.e., able to bind one or more kinases) or a phosphatase domain (i.e., able to bind one or more phosphatases). This database may be used, for example, for characterizing the binding sites of proteins or other target molecules and for determining the selectivity of ligands for particular binding sites or particular families of compounds.

In various embodiments of the above databases, the database includes records for at least 0.5, 1, 5, 10, 20, 30, 40, 50, 60, 70, 80, 90, or 100% of the proteins or protein domains in the proteome of an organism, such as a bacteria, yeast, or mammal. In particular embodiments, the database includes records for at least 0.5, 1, 5, 10, 20, 30, 40, 50, 60, 70, 80, 90, or 100% of the proteins or protein domains in the human proteome. In yet other embodiments, the database includes records for at least one protein expressed by an open reading frame for at least 0.5, 1, 5, 10, 20, 30, 40, 50, 60, 70, 80, 90, or 100% of the open reading frames in the genome of an organism.

In another aspect, the invention features a computer including a database of the invention and a user interface (i) capable of displaying one or more ligands that bind or modulate the activity of a target molecule whose record is stored in the computer or (ii) capable one or more target molecules that bind or have an activity that is modulated by a ligand whose record is stored in the computer. Exemplary databases include at least 10 records of target molecules, such as target molecules that have not been previously validated or target molecules of unknown biological function. In another aspect, the invention provides an electronic database including at least 10², 10³, 5×10³, 10⁴, 10⁵, 10⁶, 10⁷, 10⁸, or 10⁹, records of compounds correlated to records of a phenotype in one or more biological assays that are effected by the compounds. The biological assay involves a cell or in vitro sample that does not contain an exogenous copy of a nucleic acid encoding a protein that binds the compound or does not contain an exogenous reporter gene.

In another aspect, the invention features computer including the database of the above aspect and a user interface (i) capable of displaying one or more phenotypes in one or more biological assays for a compound whose record is stored in the computer or (ii) capable of displaying one or more compounds that effects a phenotype whose record is stored in the computer.

In another aspect, the invention provides electronic database including at least 10 records of target molecules correlated to records of an expression profile or activity of the target molecules. In another aspect, the invention features an electronic database including a plurality of records of target molecules that have not been previously validated as drug targets and/or target molecules of unknown function correlated to records of an expression profile or activity of the target molecules. In various embodiments of either database, the database includes records for at least 0.5, 1, 5, 10, 20, 30, 40, 50, 60, 70, 80, 90, or 100% of the proteins in the proteome of an organism, or on at least 10², 10³, 5×10³, 10⁴, 10⁵, 10⁶, 10⁷, 10⁸, or 10⁹ target molecules. In other embodiments, the database includes records for at least 0.5, 1, 5, 10, 20, 30, 40, 50, 60, 70, 80, 90, or 100% of the proteins in the proteome of an organism (e.g., the human proteome). In yet other embodiments, the database includes records for at least one protein expressed by an open reading frame for at least 0.5, 1, 5, 10, 20, 30, 40, 50, 60, 70, 80, 90, or 100% of the open reading frames in the genome of an organism.

In yet another aspect, the invention provides a computer including a database of the invention and a user interface (i) capable of displaying one or more expression profiles or activities of a target molecule whose record is stored in the computer or (ii) capable of displaying one or more target molecules that have an expression profile or activity whose record is stored in the computer. In various embodiments, the database includes at least 10 records of target molecules, such as target molecules that have not been previously validated as drug targets or target molecules of unknown function.

Any of the databases or computers can be used in any of the following methods. Exemplary uses of these databases include clustering of chemical scaffolds and types of active sites/proteins, global indexing of binding properties such as binding uniqueness and overlap, determining the specificity of scaffold for a target, determining the potential toxicity of a compound (e.g., identifying a compound specific only for the target or a compound that doesn't bind to proteins important in metabolism and toxicity such as P450 isomers—generally binding predicts metabolism), selecting a compound to probe a particular biology or pathology, identifying compounds which bind to probe the structure of a target or generate a “chemical crystal structure” with clusters around functional domains on the protein (alone or in conjunction with other techniques, e.g., NMR, Xray crystallography, or computational chemistry approaches), identifying a protein domain by searching across the database for shared domains within proteins to which the compound binds, identifying substitutions on a chemical scaffold which modulate binding to create a mini SAR, selecting a target molecule responsible for the action of a particular compound, discovering alternative targets/indications for a compound (e.g., a drug or experimental compound), discovering alternative compounds (e.g, preferably alternative chemical structures or scaffolds) which bind to a target, selecting a therapy based on pharmacogenomics, and selecting scaffolds to serve as leads for optimization of a drug.

In one such aspect, the invention features a method of identifying a target molecule associated with a phenotype of interest. This method involves using an electronic database including a plurality of records of phenotypes in a biological assay correlated to records of the ligands and their ability to cause or contribute to the phenotypes. A selection of a phenotype of interest is received, and one or more ligands which contribute to the phenotype of interest are identified. An electronic database including a plurality of records of ligands correlated to records of the target molecules that bind the ligands or have an activity that is modulated by the ligands is used to identify one or more target molecules that bind or are modulated by the ligand(s) which contribute to the phenotype of interest, thereby identifying one or more target molecules associated with the phenotype of interest. In one embodiment, the phenotype of interest is associated with a disease state, and the target molecule is determined to promote or inhibit the disease state. In one embodiment, the method is computer implemented.

In yet another aspect, the invention features a method of identifying a phenotype that is associated with a target molecule of interest. This method involves providing an electronic database including a plurality of records of target molecules correlated to records of the ligands and their ability to bind or modulate the activity of the target molecules, and receiving a selection of a target molecule of interest. One or more ligands which bind or modulate the activity of the target molecule of interest are identified. An electronic database including a plurality of records of ligands correlated to records of phenotypes in a biological assay caused by the ligands is provided and used to identify one or more phenotypes in a biological assay caused by the ligand(s), thereby identifying one or more phenotypes associated with the target molecule of interest. In one embodiment, the method is computer implemented.

In yet another aspect, the invention features a method of identifying a ligand that binds or modulates the activity of a target molecule of interest. This method involves providing an electronic database including at least 10 records of target molecules correlated to records of the ligands and their ability to bind or modulate the activity of the target molecules, and receiving a selection of a target molecule of interest. One or more ligands which bind or modulate the activity of the target molecule of interest are identified. In various embodiments, the method includes comparing the chemical structures of two or more ligands which bind or modulate the activity of the target molecule of interest, thereby identifying functional groups in the ligands which promote the binding or modulation of the target molecule of interest. In other embodiments, the method also includes comparing the chemical structures of two or more ligands which bind or modulate the activity of the target molecule of interest, thereby determining the frequency of one or more functional groups or scaffolds in the collection of the ligands. In other embodiments, one or more compounds that have one or more functional groups that are present in two or more of the ligands for use in drug discovery or development or lead optimization. In one embodiment, the method is computer implemented.

In yet another aspect, the invention features a method of identifying a target molecule that binds or has an activity that is modulated by a ligand of interest. This method involves providing an electronic database including at least 10 records of ligands correlated to records of the target molecules that bind or have an activity that is modulated the ligands, and receiving a selection of a ligand of interest. One or more target molecules that bind or have an activity that is modulated by the ligand of interest are identified. In various embodiments, the method includes comparing the chemical structures of two or more target molecules which bind the ligand of interest, thereby identifying functional groups or domains in the target molecules which promote or contribute to the binding of the ligand of interest.

In yet another aspect, the invention features a method for determining the selectivity of a ligand of interest. This method involves providing an electronic database including at least 10 records of target molecules correlated to records of the ligands and their ability to bind or modulate the activity of the target molecules, and receiving a selection of a ligand of interest. The number of target molecules in the database that bind or are modulated by the ligand is determined, thereby determining the selectivity of the ligand of interest. In various embodiments, the ligand increases an activity of a target molecule, wherein the activity is associated with a disease state, an adverse side-effect, or toxicity and the ligand is eliminated from drug discovery or development, lead optimization, or development of an agricultural or environmental agent. In other embodiments, the ligand decreases an activity of a target molecule, wherein the activity is associated with a disease state, an adverse side-effect, or toxicity and the ligand is selected for discovery or development, lead optimization, or development of an agricultural or environmental agent. In one embodiment, the method is computer implemented.

In yet another aspect, the invention provides a method for selecting a therapy for a subject for the treatment, stabilization, or prevention of a disease or disorder. This method involves providing an electronic database including at least 10 records of target molecules correlated to records of the therapeutics and their ability to bind or modulate the activity of the target molecules, and determining a target molecule in the subject that has a mutation associated with the disease or disorder. A therapeutic is selected from the database that binds or modulates the activity of the target molecule and thereby treats, stabilizes, or prevents the disease or disorder. In other embodiment, the subject or a group of subjects having the mutation is selected for a clinical trial for the therapy or is classified in a particular subgroup for the clinical trial. In particular embodiments, the target molecule is a protein or nucleic acid. In one embodiment, the method is computer implemented.

In yet another aspect, the invention features another method for selecting a therapy for a subject for the treatment, stabilization, or prevention of a disease or disorder. This method involves providing an electronic database including at least 10 records of target molecules correlated to records of the therapeutics and their ability to bind or modulate the activity of the target molecules, and determining a target molecule in the subject that has a mutation associated with the disease or disorder. A therapeutic is selected from the database that does not bind or modulate the activity of the target molecule. In one embodiment, the mutation decreases the affinity of the target molecule for one or more therapeutics in the database and thus may decrease the efficacy of the therapeutic in that subject compared to subjects without the mutation. According to this embodiment, a therapeutic that binds a molecule other than the target molecule is selected. In other embodiment, the subject or a group of subjects having the mutation is excluded from a clinical trial for a therapeutic having decreased affinity for the mutant form of the target molecule, or the subject or a group of subjects is classified in a particular subgroup for the clinical trial. In yet other embodiment, the subject or a group of subjects having the mutation is selected for a clinical trial for a therapeutic that binds a molecule other than the target molecule, or the subject or a group of subjects is classified in a particular subgroup for the clinical trial. In particular embodiments, the target molecule is a protein or nucleic acid. In one embodiment, the method is computer implemented.

The invention also features improved methods for using mass spectrometry to determine whether a compound of interest is present in a sample. These methods may be used to identify ligands for particular target molecules.

In one such aspect, the invention provides a method of determining whether a compound of interest is present in a sample. This method involves determining or providing (i) reference mass spectra for two or more compounds from a library of compounds and (ii) a test mass spectrum of a sample including one or more compounds from the library. Whether or not one or more of the peaks of a reference mass spectrum are included in the test mass spectrum is determined, thereby determining whether the compound that generated the reference mass spectrum is present in the sample. In various embodiments, the reference mass spectra are sequentially or simultaneously analyzed until all of the peaks in the test mass spectrum have been assigned to a compound. In other embodiments, the determination of whether or not the peaks of a reference mass spectrum are included in the test mass spectrum includes a sequential determination of whether the peaks of one or more reference mass spectrum are included in the test mass spectrum. In yet other embodiments, the determination of whether or not the peaks of a reference mass spectrum are included in the test mass spectrum is repeated until either (i) all of the peaks in the reference mass spectrum are determined to be present in the test mass spectrum, thereby determining that the compound that generated the reference mass spectrum is present in the sample, or (ii) a peak in the reference mass spectrum is determined to be absent in the test mass spectrum, thereby determining that the compound that generated the reference mass spectrum is not present in the sample.

In yet another aspect, the invention provides another method of determining whether a compound of interest is present in a sample. This method involves determining or providing (i) reference mass spectra of two or more compounds from a library of compounds and (ii) a test mass spectrum of a sample including one or more compounds from the library. One or more peaks of the test mass spectrum are analyzed to determine whether they are included in a reference mass spectrum. For a reference mass spectrum containing a peak that is present in the test mass spectrum, one or more of the other peaks in the reference mass spectrum are analyzed to determine whether they are present in the test mass spectrum, thereby determining whether the compound that generated the reference mass spectrum is present in the sample. In particular embodiments, the determination of whether the peaks in a reference mass spectrum are present in the test mass spectrum includes a sequential or simultaneous determination of whether the peaks of one or more reference mass spectrum are included in the test mass spectrum. In other embodiments, the determination of whether a peak in a reference mass spectrum is present in the test mass spectrum is repeated until either (i) all of the peaks in the reference mass spectrum are determined to be present in the test mass spectrum, thereby determining that the compound that generated the reference mass spectrum is present in the sample, or (ii) a peak in the reference mass spectrum is determined to be absent in the test mass spectrum, thereby determining that the compound that generated the reference mass spectrum is not present in the sample.

In various embodiments of either of the above methods of determining whether a compound of interest is present in a sample, the mass spectrum of each compound in the library is determined. In yet other embodiments, at least one of the peaks in the reference spectrum is an isotope peak, a fragment peak, or a parent peak. In particular embodiments, the method involves determine whether all of the peaks in a reference spectrum are present in the test mass spectrum. In other embodiments, the reference mass spectrum are contained in a database including records of one or more properties of mass spectra correlated to records of compounds that generate the mass spectra. In particular embodiments, the database contains data on one or more properties selected from the group consisting of the mass to charge ratio of an isotope peak, the mass to charge ratio of a fragment peak, the mass to charge ratio of a parent peak, the intensity of an isotope peak, the intensity of a fragment peak, and the intensity of a parent peak. In still other embodiments, one or more of the steps for determining whether a peak in a test mass spectrum is present in a reference mass spectrum are computer implemented.

In invention also provides a computer-readable memory having stored thereon a program for determining whether a compound of interest is present in a sample. This computer-readable memory includes computer code that receives as input mass spectrometry data including the mass to charge ratio for one or more peaks in a reference mass spectra (i.e., the mass spectrum of an individual compound from a library of compounds). This computer-readable memory also includes computer code that receives as input mass spectrometry data including the mass to charge ratio for one or more peaks in a test mass spectra (i.e., the mass spectrum of a sample including one or more compounds from the library). The computer-readable memory also has computer code that determines whether the peaks of a reference mass spectrum are included in the test mass spectrum, thereby determining whether the compound that generated the reference mass spectrum is present in the sample.

In a related aspect, the invention features a computer-readable memory having stored thereon a program for determining whether a compound of interest is present in a sample. The memory includes computer code that receives as input mass spectrometry data including the mass to charge ratio for one or more peaks in a reference mass spectra (i.e., the mass spectrum of an individual compound from a library of compounds), and computer code that receives as input mass spectrometry data including the mass to charge ratio for one or more peaks in a test mass spectra (i.e., the mass spectrum of a sample including one or more compounds from the library). The memory also includes computer code that determines whether one or more peaks of the test mass spectrum are included in a reference mass spectrum, and computer code that determines whether all of the peaks in a reference mass spectrum are present in the test mass spectrum, thereby determining whether the compound that generated the reference mass spectrum is present in the sample.

The invention also features methods for the automated production of expression vectors or the automated production and purification of proteins.

In one such aspect, the invention features a method of producing two or more vectors encoding proteins of interest. This method involves robotically contacting a first nucleic acid encoding a first protein of interest with a first backbone nucleic acid in a robotic device under conditions that allow the their reaction, thereby producing a first vector encoding the first protein, and robotically contacting a second nucleic acid encoding a second protein of interest with a second vector nucleic acid in the robotic device under conditions that allow their reaction, thereby producing a second vector encoding the second protein. In some embodiments, the method also includes robotically contacting the first vector with a first cell under conditions that allow the insertion of the first vector into the first cell, and robotically contacting the second vector with a second cell under conditions that allow the insertion of the second vector into the second cell. In various embodiments, at least 3, 4, 5, 8, 10, 15, 30, 60, 90, or more vectors are produced simultaneously. In other embodiments, the backbone nucleic acids are linearized expression vectors, and an insert encoding a protein of interest is ligated to the expression vector under conditions that generate a circularized expression vector containing the insert. In other embodiments, the first and second vectors or cells are contained in different flasks or wells in the robotic device. In other embodiments, the first cell expresses the first protein, and the second cell expresses the second protein. In yet other embodiments, the first protein and the second protein are purified as described in the aspect below. In other embodiments, the first cell and/or the second cell are bacteria such as E. coli, insect cells such as Drosophila cells, or mammalian cells such as Cos, HEK293, or CHO cells. In other embodiments, the first vector and the second vector are transferred from the first cell and the second cell to cells of another cell type, such as insect or mammalian cells, for the production of the first protein and the second protein. In other embodiments, a roller bottle system, Stir tank system, capillary cell culture system, or bioreactor is used to grow the cells. The first vector and/or the second vector can be used to produce protein to be used in any of the methods of the invention (e.g., to identify ligands that bind the protein).

One protein production and/or purification method of the invention involves expressing a first protein in a first cell under conditions that result in the secretion of the first protein into a first medium in a robotic device and expressing a second protein in a second cell under conditions that result in the secretion of the second protein into a second medium in the robotic device. The robotic device transfers the first medium to a first chromatography column and transfers the second medium to a second chromatography column. In one embodiment, the first protein and the second protein are isolated, thereby purifying the first protein and the second protein. In various embodiments, at least 3, 4, 5, 8, 10, 15, 30, 60, 90, or more proteins are purified simultaneously. In other embodiments, the first and second cells are contained in different flasks or wells in the robotic device. In other embodiments, the first cell and/or the second cell are bacteria such as E. coli, insect cells such as Drosophila cells, or mammalian cells such as Cos, HEK293, or CHO cells. In other embodiments, the first cell and/or second cell are transiently transfected Cos, HEK293, Drosophila cells or CHO cells or stably transfected Cos, HEK293, CHO, E coli, or Drosophila cells. In yet other embodiments, the first protein and/or the second protein are glycosylated in mammalian or insect cells. In various embodiments, the first protein or the second protein naturally contain a secretion signal or are genetically modified to contain a secretion signal so that they are secreted by the cells into the medium. The first protein and/or the second protein can be used in any of the methods of the invention (e.g., to identify ligands that bind the protein). In other embodiments, the robotic device can be used to contact the first protein and/or the second protein with a library of candidate ligands to select ligands that bind the protein(s) using any of the methods described herein. In yet other embodiments, the first protein and/or the second protein are used as members of a library of target molecules that are robotically contacted with a small molecule of interest to select the target molecules that bind the small molecule of interest using any of the methods described herein.

The invention also features linear DNA molecules that can be used in the automated production and purification of proteins. In one such aspect, the invention features a linear DNA molecule that is less than 3, 500, 3,000, 2,000, 1,000, 750, 500, or 300 nucleotides in length and includes a promoter operably linked to a secretory or leader sequence. Preferred DNA molecules are labeled with topoisomerase (i.e., covalently or non-covalently bonded to topoisomerase). In a related aspect, the invention features a linear DNA molecule that is less than 3,000, 2,000, 1,000, 750, 500, or 300 nucleotides in length, includes a promoter, and is labeled with topoisomerase. In another aspect, the invention provides a linear DNA molecule that is less than 3, 500, 3,000, 2,000, 1000, 750, 500, or 300 nucleotides in length and includes a nucleic acid segment encoding an affinity tag (e.g., a histidine tag with, for example, 6, 10, or 12 histidines, a FLAG tag, a myc tag, or a GST tag) and a nucleic acid segment encoding a polyA region. Preferred DNA molecules are labeled with topoisomerase. Preferably, the DNA molecule of any of the above aspects is between 500 and 300 nucleotides in length.

The DNA molecules of the above aspects can be used to construct linear DNA molecules encoding proteins of interest. In one such aspect, the invention features a linear DNA molecule including a first promoter operably linked to (i) a nucleic acid segment encoding a first protein of interest and an affinity tag (e.g., a histidine tag with, for example, 6, 10, or 12 histidines, a FLAG tag, a myc tag, or a GST tag), and (ii) a first polyA region. Preferably, the nucleic acid segment encoding the first protein is operably linked to a secretory or leader sequence. In some embodiments, the DNA molecule is less than 3,000, 2,000, or 1,000 nucleotides in length. Preferably, the DNA molecule is labeled with topoisomerase. In some embodiments, the DNA molecule also includes a nucleic acid segment encoding a second protein of interest operably linked to the first promoter. In certain embodiments, DNA molecule also includes a second promoter operably linked to (i) a nucleic acid segment encoding a second protein of interest and (ii) a second polyA region. The second protein of interest may or may not have an affinity tag (e.g., a histidine tag with for example, 6, 10, or 12 histidines, a FLAG tag, a myc tag, or a GST tag). In other embodiments, the DNA molecule encodes 3, 4, 5, 6, or more different proteins.

In another aspect, the invention features a method of producing a linear DNA molecule encoding a protein of interest. This method involves robotically contacting (i) a linear, topoisomerase labeled DNA molecule that has a promoter, (iii) a linear DNA molecule encoding a first protein of interest, and (iii) a linear, topoisomerase labeled DNA molecule that has a nucleic acid segment encoding an affinity tag (e.g., a histidine tag, a FLAG tag, a myc tag, or a GST tag) and a nucleic acid segment encoding a polyA region in a first compartment in a robotic device under conditions that permit their reaction, thereby producing a first linear DNA molecule encoding the first protein. In preferred embodiments, the method also includes robotically contacting (i) a linear, topoisomerase labeled DNA molecule that has a promoter, (iii) a linear DNA molecule encoding a second protein of interest, and (iii) a linear, topoisomerase labeled DNA molecule that has a nucleic acid segment encoding an affinity tag (e.g., a histidine tag, a FLAG tag, a myc tag, or a GST tag) and a nucleic acid segment encoding a polyA region in a second compartment in the robotic device under conditions that permit their reaction, thereby producing a second linear DNA molecule encoding the second protein. Preferably, the method also involves robotically contacting the first linear DNA molecule with a first cell under conditions that allow the insertion of the first linear DNA molecule into the first cell, and robotically contacting the second linear DNA molecule with a second cell under conditions that allow the insertion of the second linear DNA molecule into the second cell. In some embodiments, the first and/or second linear DNA molecule is circularized (e.g., ligated using standard methods) prior to insertion in to a cell. Preferably, the first cell expresses the first protein, and the second cell expresses the second protein. In other preferred embodiments, at least 3, 4, 5, 8, 10, 15, 30, 60, 90, or more linear DNA molecules are produced simultaneously. Preferably, each topoisomerase labeled DNA molecule is less than 3,000, 2,000, 1,000, 750, 500, or 300 nucleotides in length.

In another aspect, the invention features a method of purifying a protein. This method involves expressing a first protein in a first cell including a linear DNA molecule of the invention (or a circularized version of a linear molecule of the invention) under conditions that result in the secretion of the first protein into a first medium in a robotic device, robotically transferring the first medium to a first chromatography column, and purifying the first protein. In preferred embodiments, the method also includes expressing a second protein in a second cell including a linear DNA molecule of the invention (or a circularized version of a linear molecule of the invention) under conditions that result in the secretion of the second protein into a second medium in the robotic device, robotically transferring the second medium to a second chromatography column, and purifying the second protein. In other preferred embodiments, at least 3, 4, 5, 8, 10, 15, 30, 60, 90, or more proteins are purified simultaneously.

In another aspect, the invention features a cell or cell line transfected (e.g., stably or transiently transfected) with a nucleic acid of the invention. In various embodiments the cell is a bacteria such as E. coli, an insect cell such as a Drosophila cell, or a mammalian cell such as a Cos, HEK293, or CHO cell.

In another aspect, the invention features a CHO cell that is transiently transfected with a nucleic acid encoding an mRNA or protein of interest. In some embodiments, the transfected nucleic acid is a linear DNA molecule, such as a linear DNA molecule of the invention. Preferably, the cell is transiently or stably transfected with a nucleic acid encoding SV40 T antigen.

In various embodiments of any of the aspects of the invention, the ligand binds a target molecule covalently or non-covalently. In other embodiments, the ligand directly binds the target molecule or binds another molecule in the same pathway as the target molecule and thereby activates or inhibits the target molecule. In other embodiments, the ligand has a molecular weight of less than 5000, 4000, 3000, 2000, 1000, 750, 500, or 250 daltons. In other embodiments, the ligand has less than 5, 4, 3, or 2 hydrogen-bond donors or less than 10, 8, 6, 4, or 3 hydrogen-bond acceptors. In yet other embodiments, the ligand has a c logP of less than 4.15. In still other embodiments, the ligand is not FK506. In other embodiments, the selected candidate ligands bind the target molecule with a K_{d} of less than 1 fM, between 1 fM and 1 nM, between 1 nM and 1 μM, or less than 1 μM. In other embodiments, the selected candidate ligands are subjected to analysis by IR, MS, NMR, UV, amino acid sequencing, nucleic acid sequencing, or a combination thereof. In other embodiments, an isotope or fragment peak is used to identify a candidate ligand that has the same mass as another candidate ligand in the library.

In various other embodiments of any of the aspects of the invention, candidate ligands and/or the target molecules are in solution phase. In other embodiments, the ligand or the target molecule is immobilized on a solid surface such as a bead or chip. In other embodiments, the assay medium is fractionated by chromatography. In particular embodiments, the complex is isolated using size exclusion (e.g., using silca or polymer resin), multimodal, bimodal, or biphasic chromatography (e.g., chromatography based on more than a single characteristic such as size exclusion and reverse phase, size exclusion and anionic exchange, size exclusion and cation exchange, or chromatography using an internal surface reverse phase (ISRP), GFF, or GFFII resin). Exemplary resins include diol, sepharose, superose, and polymethyl methacrylate. Other desirable resins are stable above 5, 50, 500, 5000, or 7000 psi. In particular embodiments, columns containing resins with different separation characteristics are combined in series. In other embodiments, column chromatography is used to isolate the complex, and the complex elutes from the column in less than 60, 30, 20, 15, 10, 5, 3, 2, or 1 minute; the void volume is less than 20, 15, 10, 5, 4, 3, 2, or 1 mL; or the column diameter is less than 5, 4, 3, 2, or 1 mm. In other embodiments, HPLC, spin columns, capillary chromatography, or filtration are used to isolate the complex. In other embodiments, a decrease in the UV absorbance of an HPLC or other chromatography peak corresponding to unbound ligand is used to detect a decrease in the amount of unbound ligand (and thus an increase in the amount of bound ligand). In still other embodiments, the complex of a target molecule and bound candidate ligands is subjected to a chromatography step that separates the bound ligands from the target molecule. In yet other embodiments of any of the aspects of the invention, an immobilized target is contacted with candidate ligand(s), and the support is washed with medium lacking candidate ligands and treated in manner that releases any bound ligands from the target. In still other embodiments, following exposure of the target to the candidate ligand(s), the support is washed with medium lacking target molecules, and treated in a manner that dislodges the candidate ligand molecules and any bound target molecules from the support. In other aspects, one, multiple, or all the steps in the method are robotically automated or computer implemented.

In still other embodiments of any of the aspects of the invention, the function or activity of a selected target is characterized by a chemical assay, biochemical assay, enzymatic assay, biological assay, or a combination thereof. In particular embodiments, the target function is characterized by an apoptosis assay, proliferation assay, necrosis assay, angiogenesis assay, invasion assay, or a combination thereof. In other embodiments, the candidate target molecules are isolated from biochemical extracts, cells, tissues, organisms, or recombinant sources. In yet other embodiments, a selected target molecule is identified using NMR, IR, UV, MS (e.g., MALDITOF, MALDI, single quad, triple quad, or electrospray MS or MS-MS), amino acid sequencing, or nucleic acid sequencing. In other embodiments, the candidate target molecule is a full-length protein or a fragment from a protein that is less than full-length. Exemplary targets include enzymes and receptors such as GPCRs, kinases, ion channels, nuclear receptors, proteases, phosphatases, and methylases. Targets may include molecules or classes of molecules for which therapeutically active compounds have or have not been previously developed.

In various embodiments, a method or databases of the invention is used to determine specificity of a scaffold for a target, determine potential toxicity, identify a compound to probe a particular biology or pathology, identify a compound to probe a target, perform mini SAR, select a target responsible for action of a particular compound, “greening” of portfolio and patent life extension for products (e.g., identifying other uses for patented compounds, identifying other target molecules that patented compounds bind, or identifying other compounds that bind useful targets), select a compound based on pharmacogenetics, or select scaffolds to serve as leads for optimization of a drug.

It is noted that all of the embodiments of the various aspects of the invention for candidate ligands apply to small molecules of interest.

Herein, by “target molecule that has not been previously validated as a drug target” is meant a target molecule whose modulation has not been previously experimentally determined to promote or inhibit a disease state in an animal model of the disease, as described in a publication or public presentation. For example, unvalidated target molecules include molecules for which the activation or inhibition of the molecules or the decrease or increase in the expression level of the molecules has not been experimentally shown to modulate a disease state in an animal model of the disease. In contrast, validated drug targets include molecules for which increasing or decreasing the amount or an activity of the molecules has been experimentally determined to promote or inhibit a disease state in an animal model. Examples of validated targets include targets whose overexpression or inactivation due to a knockout mutation or other gene silencing methods (e.g., antisense inhibition of gene expression) has been experimentally demonstrated to promote or inhibit a disease state in an animal model.

By “target molecule of unknown biological function” is meant a target molecule for which an activity has not been previously experimentally demonstrated, as described in a publication or public presentation. In various embodiments, the target molecule of unknown function is a nucleic acid or protein having less than 60, 50, 40, 30, 20, or 10% sequence identity to nucleic acids or proteins for which an activity has been experimentally demonstrated. In other embodiments, the nucleic acid or protein has not previously been assigned a putative function. Sequence identity is typically measured using sequence analysis software with the default parameters specified therein (e.g., Sequence Analysis Software Package of the Genetics Computer Group, University of Wisconsin Biotechnology Center, 1710 University Avenue, Madison, Wis. 53705). This software program matches similar sequences by assigning degrees of homology to various substitutions, deletions, and other modifications.

By “target molecule of unknown secondary or tertiary structure” is meant a target molecule for which the secondary or tertiary structure has not been previously experimentally determined, as described in a publication or public presentation. In some embodiments, the secondary or tertiary structure has not previously been predicted or modeled based on the known structure of a homologous molecule. In other embodiments, the location or tertiary structure of a binding site or active site in the target molecule has not been previously experimentally determined.

By “scaffold” is meant a core chemical structure that is contained in two or more different molecules in a library of candidate compounds. In various embodiments, at least 5, 10, 10², 10³, 10⁴, 10⁵, 10⁶, or more molecules in the library contain the scaffold. In some embodiments, the library contains at least 2, 2, 5, 10, 10², 10³, 10⁴, 10⁵, or more different scaffolds.

By “library” is meant a collection of 2, 5, 10, 10², 10³, 10⁴, 10⁵, 10⁶, 10⁷, 10⁸, 10⁹, or more different molecules. In various embodiments, each members of a library has a different mass. In other embodiments, at least 2, 5, 10 15, 20, 30, 40, 50, or more of the members have the same mass or a mass than differs by less than 1, 0.5, 0.1, 0.05, or 0.01 daltons from the mass of another library member.

By “crosslinker” is meant a molecule or moiety that contains one or more functional groups capable of reacting with another molecule.

By “proteome” is meant all the proteins expressed by an organism. The proteome includes all of the alternative splice variants of a protein that are expressed by the organism.

By “purified” is meant separated from other components that naturally accompany it. Typically, a compound is substantially pure when it is at least 50%, by weight, free from proteins, antibodies, and naturally-occurring organic molecules with which it is naturally associated. In other embodiments, the compound is at least 75%, 90%, or 99%, by weight, pure. A substantially pure compound may be obtained by chemical synthesis, separation of the compound from natural sources, or production of the compound in a recombinant host cell that does not naturally produce the compound. Proteins and organic compounds may be purified by one skilled in the art using standard techniques such as those described by Ausubel et al. (Current Protocols in Molecular Biology, John Wiley & Sons, New York, 2000). The degree of purification compared to the starting material can be measured using standard methods such as polyacrylamide gel electrophoresis, column chromatography, optical density, HPLC analysis, or western analysis (Ausubel et al., supra). Exemplary methods of purification include immunoprecipitation, column chromatography such as immunoaffinity chromatography, magnetic bead immunoaffinity purification, and panning with a plate-bound antibody.

The methods of the present invention have numerous advantages. For example, the methods allow the expression and purification of every protein in the proteome of an organism (e.g., the human proteome) and the identification of high-affinity, drug-like scaffolds for each protein. The methods also allow a theoretically unlimited number of candidate compounds and candidate scaffolds to be screened. Because the methods of the invention are so rapid and can be performed on such a large scale, they are useful for assaying target molecules that have not been previously validated as drug targets or target molecules of unknown biological function to select ligands that bind and/or modulate the activity of the target molecules. In contrast, current methods for selecting ligands that bind a target molecule have been limited to target molecules that have been validated as drug targets. Thus, the present methods greatly expand the number of target molecules that can be assayed. Target molecules for which high affinity binders are selected can then be validated as drug targets.

Additionally, the methods of the invention allow candidate ligands that have the same mass to be distinguished. For example, mass spectral isotope and fragment peaks typically differ between ligands of the same mass. Thus, these peaks can be used to identify a candidate ligand even if it has the same parent peak as another candidate ligand in a library of compounds. This advantage allows the use of libraries containing multiple compounds of the same or similar masses.

The solution phase embodiments of the invention allow fluid phase binding to occur as it would in a serum or cell. In contrast to many current assays which measure a specific activity of the target protein, the methods of the present invention may be readily applied to any target in the proteome without customization. The methods also use a very small amount of reagents (such as <300 ug of each target for 200,000 compounds, and <35 ng of each compound for each target). The methods also allow a library of compounds to be screened without tagging or purifying individual members of the library before screening, thereby greatly decreasing the amount of time necessary to screen the library. The length of time required to screen libraries can also be reduced by using the automated embodiments of the present invention which allow multiple libraries and/or multiple targets to be analyzed in parallel.

Other advantages and embodiments of the invention will be apparent from the following detailed description and from the claims.

### 4. DESCRIPTION OF THE FIGURES

FIG. 1 is an overview of the “genotype to phenotype” approach.

FIG. 2 is an overview of the “phenotype to genotype” approach.

FIG. 3 is a set of spectra illustrating the ability of P38 MAP kinase to isolate and extract a specific ligand with micromolar affinity.

FIG. 4 is a set of UV spectra illustrating a P38 MAP kinase concentration dependant reduction of the 86002 peak but negligible reduction of the quinine peak in the HPLC separation of protein-bound compounds from free compounds.

FIG. 5 is a set of mass spectra illustrating that the compound extracted from the mixture and released from p38 MAP kinase was identified as 86002.

FIG. 6 is a list of the compounds in the 10 compound mixture and their molecular weights.

FIG. 7 is a set of spectra demonstrating a P38 concentration dependent reduction of the 86002 peak but negligible reduction of the Colchicine peak or peaks representing the other compounds in the mixture during the HPLC separation of protein-bound compounds from free compounds. When the protein fraction was collected and the mass spectrum was determined, the spectrum included the peaks characteristic of 86002 at a level far higher than other peaks.

FIG. 8 is a set of spectra illustrating a tubulin concentration dependent reduction of the Colchicine peak but negligible reduction of the 86002 peak or peaks representing the other compounds in the mixture during the HPLC separation of protein-bound compounds from free compounds. When the protein fraction was collected and the mass spectrum determined, the spectrum included the peaks characteristic of colchicine at a level far higher than other peaks.

FIG. 9 is a list of the compounds in the 100 compound mixture and their molecular weights.

FIG. 10 is a set of spectra illustrating that P38 MAP kinase binds and extracts a ligand with micromolar affinity (86002) from a 100 compound mixture in a specific and concentration dependent manner.

FIG. 11 is a set of spectra illustrating that tubulin binds and extracts a hit (Colchicine) from a 100 compound mixture in a specific and concentration dependent manner.

FIG. 12 is a set of UV spectra illustrating that excellent separation of the protein target from the unbound compounds in the 100 compound mixture is also achieved at higher flow rates.

FIG. 13 is a set of spectra illustrating the ability of spin columns to separate a compound bound to a protein target from unbound compounds. This method was used to identify Colchicine as the predominant compound from the 100 compound mixture that bound tubulin.

FIG. 14 is a schematic illustration of the steps in one embodiment of the Chemical Array Assay.

FIG. 15 is a schematic illustration of an exemplary computer.

FIG. 16 is an exemplary flow chart for one embodiment of the invention for identifying a compound in a sample.

FIG. 17 is a graph illustrating the pairing of chemical scaffolds with protein targets which can be used to produce a chemical fingerprint of the human proteome. The binding assays and the databases of the invention have many applications. For example, they may be used to determine specificity of a scaffold for a target, determine potential toxicity, identify a compound to probe a particular biology or pathology, identify a compound to probe a target, perform mini SAR, select a target responsible for action of a particular compound, “greening” of portfolio and patent life extension for products (e.g., identifying other uses for patented compounds, identifying other target molecules that patented compounds bind, or identifying other compounds that bind useful targets), select a compound based on pharmacogenetics, or select scaffolds to serve as leads for optimization of a drug. Knowledge in a database of chemical interactions with targets at the proteomic scale allows selection of better leads and validation of genomics based targets.

FIG. 18 is a schematic illustration of one embodiment for the automation and high throughput of methods of the invention to produce ligand/target pairs.

FIG. 19 s a schematic illustration of one embodiment for the high throughput production of ˜2 milligrams of each of the ˜90,000 proteins in the human proteome using automated cloning and production systems over a period of ˜3 years at a rate of ˜600 proteins per week.

FIG. 20 is a schematic illustration of steps involved in the high-throughput methods of the present invention for the generation of expression vectors.

FIG. 21 is a table of exemplary proteins that have been produced with proper translational modifications using standard methods in Drosophila cells.

FIG. 22 is a schematic illustration of steps involved in the high-throughput methods (e.g., ˜two hour) of the present invention for the generation of linear expression vectors.

FIG. 23 is a schematic illustration of steps involved in the high-throughput methods of the present invention for identifying high affinity ligands for a target molecule of interest. A library of compounds and the target molecule are applied to one of the binding assays described herein and the highest affinity compounds are selected. It is not necessary to initially bias the screening library because a large number of scaffolds can be screened to find high affinity compounds, many of which may not have been predicted to bind with such high affinity. Compounds with even higher affinity for the target can be generated by reacting the selected compounds with each other in the presence of the target molecule. Compounds that react to each other while bound to the target molecule may form products which increased affinity for the target molecule because of the larger number of functional groups in the product that interact with the target molecule. The products with highest affinity for the target molecule can be selected using one of the binding assays described herein. Thus, there is no need for prior chemical purification of the products using tradition methods prior to this binding assay.

FIG. 24 is a schematic illustration of the binding of building blocks with reactive groups (e.g., small molecules identified from a binding assay or small molecules from a library of compounds) to a target protein. The building blocks are reacted on the surface of the protein to generate a product with higher affinity for the protein.

FIG. 25 is a schematic illustration of the binding of building blocks without reactive groups (e.g., small molecules identified from a binding assay or small molecules from a library of compounds) to a target protein. The building blocks are reacted on the surface of the protein to generate a product with higher affinity for the protein.

FIG. 26 is a schematic illustration of parallel processing by injecting and assaying multiple samples at once.

FIG. 27 is a list of exemplary sequences for use in the linear DNA constructs of the invention, including SEQ ID NO: 1-9.

### 5. DETAILED DESCRIPTION OF THE INVENTION

5.1. Genotype to Phenotype

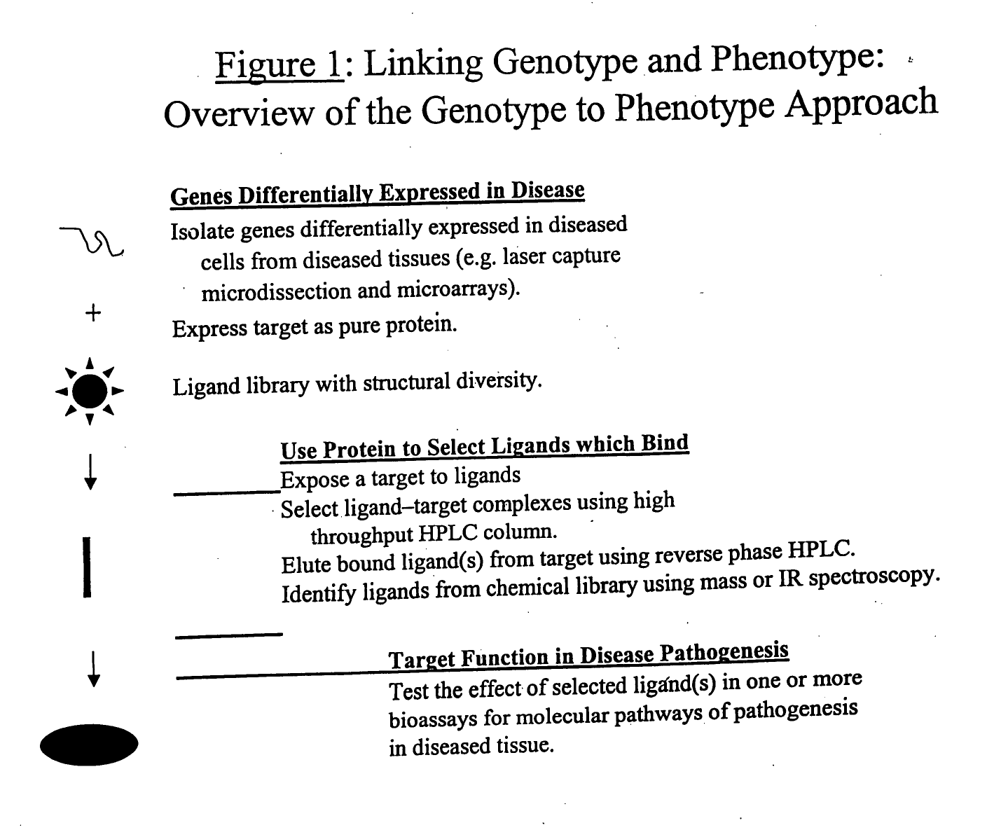

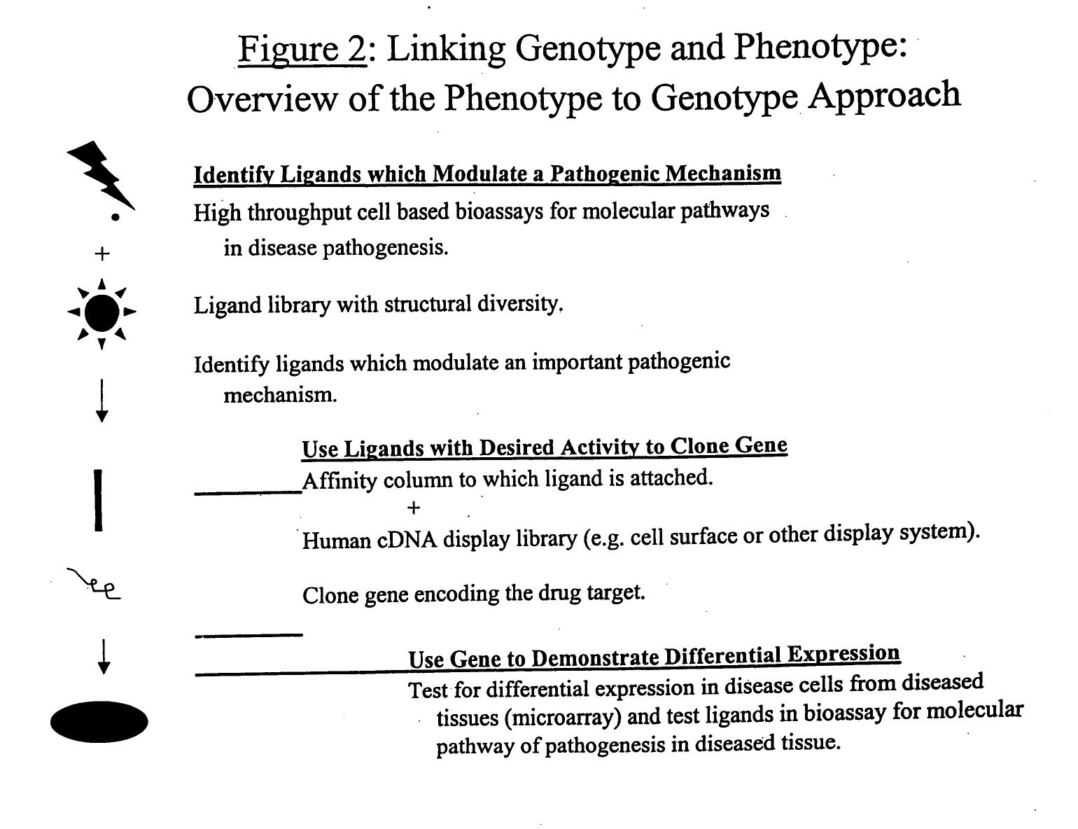

In one aspect, the present invention relates to methods of exposing protein or nucleic acid targets to a plurality of potential ligands, collecting ligand-target pairs, and using the ligand(s) which bind the target to analyze the target's biological function. One embodiment is outlined in FIG. 1. The method is used to determine the function of a target, which may be a target which has hitherto been unknown. Many other methods for selecting a candidate ligand that binds a target molecule are described herein. All of the embodiments listed below in sections 5.1.1 to 5.1.5 can be used in any of the methods of the invention.

5.1.1. Targets

According to the present invention, a target molecule is the compound for which a binding or reacting molecule is sought. In preferred embodiments, the target is the species present at the highest concentration in the reaction vessel. In various preferred embodiments, the target is present at the same concentration as the ligand in the reaction vessel. In yet other preferred embodiments, the target is present at a higher or a lower concentration than the concentration of each ligand or the total concentration of the mixture of candidate ligands. In other preferred embodiments, the target is the species present at the lowest concentration in the reaction vessel. In one embodiment of the invention, the target is the species in the reaction vessel which has the highest molecular mass. A target may be a naturally occurring biomolecule synthesized in vivo or in vitro. A target may be comprised of amino acids, nucleic acids, sugars, lipids, natural products or combinations thereof. An advantage of the instant invention is that no prior knowledge of the identity or function of the target is necessary.

In a preferred embodiment of the invention, the target is comprised of amino acids, peptides, enzymes, proteins (e.g., membrane or soluble proteins), antibodies or combinations thereof. In a first step, polynucleotides encoding the proteins of interest may be selected and introduced into an expression system. The polynucleotides may be selected by differential screening, subtractive hybridization, differential display, microarray expression analysis, representational difference analysis (RDA) or laser capture microdissection. The protein may be synthesized in vivo as in a bacterial plasmid, phage, transient cellular expression system or viral expression system. Alternatively, selected proteins may be synthesized in vitro by in vitro transcription and translation (e.g., Promega web site) or by common FMOC oligopeptide synthesis chemistry. The expressed protein may be optionally purified and then exposed to a ligand library.

According to the invention, genes can be expressed from a complete cDNA or gene library of human or other species or a subset of genes selected for differential expression in a particular disease or upon a particular stimulus. Genes that are differentially expressed in diseased or stimulated cells and tissues can be selected using but not limited to techniques such as subtractive hybridization, informatics, microarrays, SAGE, or laser capture microdissection. If partial sequences such as ESTs are recovered, full-length tissue specific cDNAs may then be cloned from full-length human cDNA libraries some of which are available from CLONTECH, STRATAGENE, Life Technologies, and NCBI. Between 20% and 60% of the genes being cloned in this way, depending upon the tissue, have not previously been identified and the functions of virtually every gene cloned have not been elucidated. In a preferred embodiment, these genes have been discovered by genomics. To produce proteins, the full-length cDNAs may be tagged with hexahistdine (6his) inserted at the carboxyl terminal end and glutathione synthetase (GST) at the amino terminal end of the gene each with a protease cleavage site. Alternatively, the intein-based self cleaving tag by New England Biolabs may be used to avoid the need for protease treatment. These genes may be expressed and secreted into the supernatant by baculovirus, for example, using the Invitrogen-Schneider 2 Drosophila system with its his tag and bip protein leader, transfection using CaPO₄, and selection by hygromicin induced expression with copper sulfate, which can produce 5-10 mg/L of protein in the supernatant which can be purified over a nickel column. Non-limiting examples of alternative expression systems include Fast Bac or another baculoviral system or mammalian expression systems (CHO, COS, 293, etc.). E. coli may also be used for protein production but does not glycosylate proteins and the baculovirus system is as reliable and does glycosylate proteins. The resulting proteins can then be purified by Ni(2+)-NTA chromatography as a first purification step and glutathione affinity chromatography as a second step followed by specific protease removal by cleavage of the tags. If the intein based affinity system is used, no protease is required. The proteins can be expressed and purified using alternative techniques as well or the complete or partial protein may be expressed in phage or bound to a surface.

In another embodiment of the invention targets are comprised of RNA or DNA as oligonucleotides or polynucleotides. In one non-limiting embodiment of the present invention, nucleic acids to be introduced into an expression system are identified by large scale sequencing of EST's. Oligonucleotide targets may be synthesized directly. Polynucleotide targets may be synthesized directly or prepared by amplification of a template polynucleotide, e.g., by PCR. The oligonucleotide or polynucleotide target may be optionally purified and then exposed to a ligand library.

In another embodiment of the invention, targets are comprised of simple or complex carbohydrates. In another embodiment of the invention, targets are comprised of lipids. In another embodiment of the invention, the target comprises natural products.

In another embodiment of the invention, the target may be derivatized. Non-limiting examples include biotin, fluorescein, digoxygenin, green fluorescent protein, radioisotope, his tag, magnetic bead, glutathione S transferase, photoactivatible crosslinker or combinations thereof.

Target preparations may contain minor quantities of other compounds as a result of partial or incomplete purification of the desired component.

5.1.2. Ligands

According to the present invention, a ligand is any molecule which has the potential to bind to a target and/or exert an effect in a bioassay. In various embodiments of the genotype to phenotype approach, the ligand or the mixture of candidate ligands is present in the reaction vessel at a lower concentration than the target. In other embodiments of the phenotype to genotype approach, the ligand or the mixture of candidate ligands is present in the reaction vessel at the same concentration as the target. In still other embodiments of the genotype to phenotype approach, the ligand or the mixture of candidate ligands is present in the reaction vessel at a higher concentration than the target. A ligand may be comprised of amino acids, nucleic acids, sugars, lipids, natural products, natural product-like compounds or combinations thereof. A ligand may be created by any combinatorial chemical method. Alternatively, a ligand may be a naturally occurring biomolecule synthesized in vivo or in vitro. The ligand may be optionally derivatized with another compound. One advantage of this modification is that the derivatizing compound may be used to facilitate ligand-target complex collection or ligand collection, e.g., after separation of ligand and target. Non-limiting examples of derivatizing groups include biotin, fluorescein, digoxygenin, green fluorescent protein, isotopes, polyhistidine, magnetic beads, glutathione S transferase, photoactivatible crosslinkers or combinations thereof.

Ligands should have low affinity for each other at the conditions under which the target is exposed to the ligand library.

Ligand libraries are mixtures of ligands which differ from each other in mass, composition, structure or combinations thereof. The present invention contemplates such libraries which comprise at least 10 different ligands or at least 100 different ligands or at least 1000 different ligands.

The ligand library used to bind to the proteins can be derived from many sources. The invention includes the use of chemicals, proteins, peptides, antibodies, sugars, lipids, natural products, natural product-like compounds or any combination thereof. These may be prepared by organic synthesis, combinatorial chemistry, recombinant DNA, biochemical extraction, purification, etc. In a preferred embodiment of the invention, natural product-like synthetic libraries are generated using diversity oriented chemistry (e.g., asymmetric split pool synthesis on beads or in solution, synthesized in parallel or in series), either combinatorial or medicinal chemistry. The subunits used in the synthesis are preferably drug-like and are as highly diversified as possible. The units may be structurally rigid or flexible. The units may undergo chemical reactions that modify their own structures (e.g., rearrangement). The units may have functional groups added.

Drug-like compounds may be made using different scaffolds with different chemistries (e.g., organic, inorganic, peptide, protein, alkaloid, carbohydrate, lipids, natural product-like compounds). Drug-like compounds may incorporate spectral identifiers. Non-limiting examples of spectral identifiers include elements which resolve into characteristic isotope fragmentation patterns in mass spectroscopy (e.g., Cl, Br, N, H). Drug-like compounds may also be made with compounds with unique fragmentation patterns upon mass spectroscopy analysis (penicillin). The libraries can also be designed to facilitate other analytical and deconvolution techniques (e.g., IR FTIR).

In another embodiment of the invention, non-limiting examples of other libraries which may be used include commercially available libraries (e.g., Pharmacopeia, ArQule, and Chembridge), focused chemical libraries, peptides, peptides or proteins including the TAT, VP22 or ANTENNAPEDIA transduction signals, structurally flexible small molecules, natural products, sugars, and monoclonal antibodies. The subunits used in the synthesis are preferably drug like and are as highly diversified as possible.

Libraries of the invention may be tagged to facilitate ligand deconvolution and resynthesis after binding has been observed. Alternatively, the ligands can be deconvoluted without tagging. The ligands can be tested individually or in a mixture. Diverse libraries synthesized as a mixture in solution phase or on solid phase supports can be used. In one embodiment, the transduction peptides or variants thereof from TAT, VP22 or ANTENNAPEDIA can be crosslinked to a small molecule to enhance its ability to cross a membrane or barrier. Alternatively, a small molecule homologue of these peptides can be developed and linked to the same.

5.1.3. Binding

According to the present invention, a ligand-target pair describes an affinity relationship between a ligand and target wherein the dissociation constant (K_{d}) is less than about 20 μM, and preferably less than about 1 μM. The invention further contemplates ligand-target interactions where K_{d}≦100 nM or K_{d}≦100 μM or K_{d}≦100 fM. The interaction between the ligand and target may be covalent or non-covalent. The ligand of a ligand-target pair may or may not display affinity for other targets. The target of a ligand-target pair may or may not display affinity for other ligands.

According to the invention a reaction vessel is any container or surface in or upon which a target may be exposed to at least one of ligand. In a preferred embodiment of the invention, reaction vessels are arranged to facilitate high throughput screening. This may be accomplished by using 96 or 384 well microtitre plates. Another possibility is depositing different target proteins on a glass slide at high density as illustrated by MacBeath et al., 2000, Science 289:1760. In other embodiments of the invention the reaction vessel may be a column, resin, membrane, matrix, bead or chip.

The conditions under which the target is exposed to the ligand library may vary. Non-limiting examples include binding reactions where the temperature is less than about 5° C. or from about 5° C. to about 25° C. or from about 25° C. to about 40° C. or over about 40° C. Further non-limiting examples include binding reaction conditions where the pH is less than about 5 or from about 5 to about 9 or over about 9. Further non-limiting examples include binding reactions in solutions which are comprised of water, an alcohol, an organic solvent or combinations thereof. Further non-limiting examples include binding reaction conditions where the additives may include ions, salts, detergents, reductants, oxidants or combinations thereof. A further non-limiting example includes binding reaction conditions where the target is immobilized. A further non-limiting example includes binding reaction conditions where ligands are immobilized. A further non-limiting example includes binding reaction conditions where targets are immobilized. A further non-limiting example includes binding reaction conditions where the target and the ligands are in solution.

A further non-limiting example includes binding reaction conditions where the ligand comprises a marker such as biotin, fluorescein, digoxygenin, green fluorescent protein, radioisotope, his tag, a magnetic bead, an enzyme or combinations thereof.

In one embodiment of the invention, the targets may be screened in a mechanism based assay. The mechanism based assay includes but is not limited to an assay to detect ligands which bind to the target. This may include a solid phase or fluid phase binding event with either the ligand, the protein or an indicator of either being detected. Alternatively, the gene encoding the protein with previously undefined function can be transfected with a reporter system (including but not limited to β-galactosidase, luciferase, green fluorescent protein, etc.) into a cell and screened against the library ideally by a high throughput or ultra high throughput (e.g., 1560 well per plate of chip) screening or with individual members of the library. In an alternative embodiment of the invention other mechanism based binding assays may be used. These include other assays including biochemical assays measuring an effect on enzymatic activity, cell based assays in which the target and a reporter system (e.g., luciferase or β-galactosidase) have been introduced into a cell, and binding assays which detect changes in free energy. Binding assays can be performed with the target fixed to a well, bead or chip or captured by an immobilized antibody or resolved by capillary electrophoresis. The bound ligands may be detected usually using colorimetric or fluorescence or surface plasmon resonance. In the column based binding assay, the binding may be performed in a well or other vessel, on a gel, etc.

While there are a number of ways these assays can be done, following inductive thought, only the chemicals which bind to the protein target are relevant and can teach its function. In addition, the fluid phase more accurately reflects the true biological conformation. Furthermore, in the reaction both the protein and the chemicals preferably are not tagged, decreasing the problem that the protein has been constrained in some way by coupling to a plate of a bead or the ligand is not in the same fluid phase confirmation which it will be in the cell or the blood. Consequently, in a preferred embodiment of the invention, 1 to 20,000 ligands (with 1000 to 10,000 preferred) may be mixed together with 1 ng to 1 mg of each protein (with 0.1 to 100 μg preferred) in a small volume (1 fL to 1 mL with preferred range of 0.1 μL to 100 μL) to have a 0.1 μM to 100 μM concentration with a preferred range of 0.1 μM to 10 μM. In particular embodiments of the invention, by looking at only the 1 to 500 ligands which would be expected to bind to each protein with micromolar to nanomolar affinity, one avoids having to screen millions of combinations individually. This overcomes the need to tag the library in any other way than the molecules own mass, isotope pattern or fragmentation pattern, because mass spectroscopy can resolve and identify the possible 1 to 5 hits per well. Alternatively, IR and/or FTIR can be used alone or in combination with mass spectroscopy to resolve and identify hits.

5.1.4. Ligand-Target Separation and Ligand Identification

In a preferred embodiment of the invention, ligand-target pairs are separated from unbound ligands and unbound targets by liquid chromatography, ligand-target pairs are separated from each other in a second liquid chromatography step, and ligands which bind are identified by mass spectroscopy. In various embodiments of the invention, the solution phase binding may occur in a well, tube or column. Capillary electrophoresis, and/or other detection methods may be used to deconvolute ligands from the library. Particularly, HPLC and mass spectroscopy or capillary electrophoresis and mass spectroscopy can measure the molecules with extreme sensitivity. In addition, this technique can be done in extremely small volumes which is critical to optimally utilize the small amounts of each member of the chemical library. For example, less than 20,000 ligands from the chemical library may be pooled with the protein for binding again in each well in 96 well plates at ≦10 μM in approximately 100 μL and 1 μg of protein. In a preferred embodiment, HPLC is performed in 96 well plates with cartridges to serve as the columns for each well. In another embodiment, the separation is performed in parallel in 384 well, 1536 well, or 10,000 or greater well formats using column, wells, cartridges, chips, or filters. Alternatively, this may be performed in a standard HPLC column, spin column, or other column. The first cartridge/column may be a gel permeation or size exclusion or gel filtration (e.g., G25 like resin, Pharmacia) to hold the unbound molecules in the resin but allow the bound ligand and protein to pass through. A small sample volume is desired (preferably 1 to 100 μL or less) yet this procedure may dilute the sample by one or more orders of magnitude. It is helpful, therefore, to use a small and narrow column (preferably having a diameter of 1 to 2 mm or less and a length of 5 to 200 mm (Rocket Column, Biorad or Pharmacia columns) to minimize dilution of the sample. Capillary Liquid Chromatography can also be used. This resin separates the protein along with small molecules bound to it with high affinity (K_{d}≦1.0 μM). The next cartridge/column would use a hydrophobic or hydrophilic reverse phase HPLC resin, the choice of which depends upon the hydrophobicity of the ligand library being used: C18 (silica hydrophobic-used with less hydrophobic ligand) C8 column (more hydrophilic, used for more hydrophobic ligands), a cyanocolumn (use for more hydrophilic ligands) or SB8U from Agilent which can be used for either hydrophilic or hydrophobic ligands. These reverse phase HPLC methods separate the bound small molecule ligands from the protein and concentrate the small molecules and protein sample via resin binding. Subsequently, the small molecules may be eluted from the protein and the resin and the eluants may be collected in a 96 well plate. Providing one knows the amount of the starting material, affinity may also be measured in this step. Alternatively, competition studies can be done at a later time to quantitate binding affinity. These eluants may then be transferred to a mass spectrometer and characterized. This may be done robotically in real time potentially even in the 96 well format perhaps using either a parallel multiple channel microchip system or a parallel spray interface. Alternatively, chip based MALDI TOF Mass spectrometry may be used. In this case, the protein fraction from the column (spin, HPLC, capillary, other) can be spotted onto a chip or a filter in a 96 well or greater format. The Omniflex or Autoflex MALDI instruments from Bruker Daltonics automatically desorb and analyze each of the samples from 100 sample and 1536 sample formats, respectively.

Nonlimiting forms of mass spectrometry that may be used include electrospray, ion trap, Fourier Transform, MALDI, single or triple quadrapole in single MS, MS-MS, or MS-MS-MS formats.

Eluents may be characterized using a software package for use with the mass spectrometer supplemented with information about the ligand library used. Mass spectroscopy may be used to identify compounds by direct detection of its mass. However, mass spectroscopy may also be used to detect compounds, scaffolds or linkers containing elements which resolve into characteristic isotope patterns (e.g., ³⁵Cl, ¹³N, ²H) or compounds having unique fragmentation patterns (e.g., penicillin). For example, chlorine-containing compounds will be comprised of ³⁵Cl and ³⁷Cl which will produce two mass peaks, 2 AMU apart with a 3:1 intensity ratio. Similarly, bromine-containing compounds will be comprised of ⁷⁹Br and ⁸¹Br which will produce two mass peaks, 2 AMU apart with a 1:1 intensity ratio. This approaches may be used as an alternative to or in combination with true molecular weight to identify a compound.

Mass spectroscopy enables the mass, isotope, and fragmentation pattern to be determined so accurately that, coupled with software, the exact member of the library may be identified except for the isomer. Following this the theoretically expected 500 or so micromolar to nanomolar hits can be pulled from the original library and synthesized in a larger scale. If the molecule is a peptide, it can be fused to the TAT transducing sequence which allows proteins to cross the cell membrane.

In another embodiment of the invention, ligands are characterized by IR or FTIR in addition to or instead of mass spectroscopy analysis. These techniques permit identification of ligand functional groups or substitutions (e.g., hydroxyl or amino groups). Used in combination with mass spectroscopy, this may facilitate differentiation between ligands of identical molecular weight.

According to the invention, the dissociation constant (K_{d}) of the ligand-target pair should be less than about 100 μM and preferably less than about 10 μM. While not dispositive, the dissociation constant (K_{d}) of the ligand-target pair is one factor which may guide those skilled in the art in determining the utility of a ligand in determining target function and as a drug lead. Thus, the invention contemplates but does not necessarily prefer ligand-target pair interactions where the dissociation constant (K_{d}) is less than about 1 μM or less than about 100 nM or less than about 10 nM or less than about 1 nM or less than about 100 pM or less than about 10 pM.

If no hits or a low number of hits with reasonable affinity are found, a structural or chemical gap in the structural diversity of the chemical library may have been identified. In such a case, target directed synthesis can be employed to fill in that gap. If low affinity binders are found, the binding can be repeated with a library containing photoactivatable (or other) linkers on one of the functional domains. After the first column when only the protein and molecules binding to it are present, the photoactivation step can be performed, after which the small molecules can be eluted by reverse phase HPLC. In this way, the target has been used as a template and because two molecules which bound with a low affinity linked together will have an increased affinity for the target. In a preferred embodiment, the increase in affinity is 2 to 100 fold.

5.1.4.1. Exemplary Chemical Array Assay Experimental Methods and Results

Methods for HPLC Based Assay

Drug-like chemical compounds representing a collection of drug-like chemical scaffolds (Sigma-Aldrich, ICN, Calbiochem) were weighed and mixed to a final concentration of 20 uM each in 50 mM ammonium acetate pH 7, 10% methanol. 1 uM to 20 uM tubulin or P38 MAP kinase (Sigma) were dispensed into HPLC low volume sample cuvettes (Waters) and mixed with 0.5 uM to 20 uM compounds. After mixing and a 15 minute 37° C. incubation, the cuvettes were placed on ice and injected into the HPLC (Waters 2690) using an autoinjector (Waters) onto a 150 mm×2.1 mm ID Pinkerton GFF II column (Regis Technologies) for dual size exclusion and phase separation with a 50 mM ammonium acetate, 10% methanol running buffer. The protein target and bound compounds eluted in the column void volume as detected using a Diode array detector and most of the compounds absorbed well at a 243 nm frequency. In some cases, using low concentrations of each compound (0.5 to 5 mM) and fewer than 10 compounds which could be easily separated from one another, it was possible to titrate in the two protein targets and observe a corresponding titration in the level of UV absorbance of the specific compound known to bind one of the protein targets but not to nonspecific control compounds.

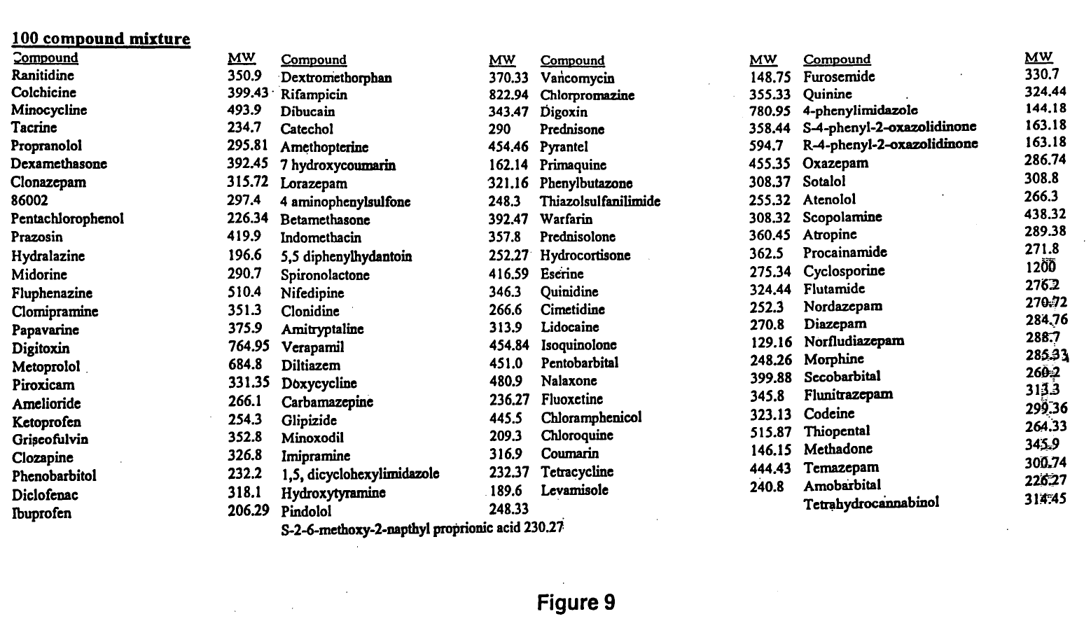

We optimized the column dimensions and the choice of resin to maximize the separation of the compounds bound to the protein targets from the unbound compounds. Resins which elute protein in the void volume and small column diameters and lengths which minimize the void volume were used. Such columns minimize the amount of dilution of the protein sample and minimize the time required for each assay, thereby minimizing the amount of bound compound that dissociates from the protein (as governed by the K_{off} rate). These features enabled the use of minimal amounts of reagents, as well as sensitive detection methods. The column lengths were such that the protein eluted in less than 2 to 3 minutes. A number of HPLC columns, including the Regis 150 mm×2.1 mm GFF II column, a 1.0 mm×100 mm YMC Diol column, a 2.1 mm×150 mm Phenomonex Polyhydroxymethacrylate (Polysep) column, and a Jordi 2.1×150 mm Divinyl Benzene column, were tested. Similarly, other running buffers were tested in which the salt and methanol concentration were varied, and the ratio of protein target to small compounds in the binding reaction was varied from 1000:1 to 1:1000. Resins representative of different classes were tested for their ability to separate the protein fraction from the drug-like small molecule compounds, and to minimize the cycle time for all of the compounds to elute from the column. These characteristics of the columns are determined by surface properties and limitations on flow rates due to resins collapsing under backpressure. Being silica based and thus resistant to pressure, the YMC diol column had a cycle time of under 10 minutes but was only able to separate approximately 50% of the compounds in the 100 compound mixture listed in FIG. 9 from the protein. The Phenomonex Polyhydroxymethacrylate column was able to separate approximately 80% of the compounds in the 100 compound mixture from the protein, and required a methanol gradient to achieve elution of many of the small molecule compounds; it tolerated a relatively low flow rate (0.18 ml/min) because of the inability to tolerate backpressures over 600 PSI. The cycle time for the Phenomonex column was 1.5 hours with the gradient, and 35 minute for a subset of compounds (15% of the total) which could be isolated without the gradient. Other polymer based columns [e.g., polyhydroxymethacrylate (Phenomonex, Shodex, Waters), polymethylmethacrylate (Shodex, TosohBiosep), Sepharose/Sephadex/Superose (Amersham Pharmacia Biotech)] also only tolerated relatively low flow rates. The Jordi DVB columns are divinyl benzene polymer columns, which were operated at high pressure (4000 PSI) and undesirably bound the protein as well as the compounds, thus giving no separation in the buffer system used. Other buffer systems are expected to allow separation of the protein from the unbound compounds. Different columns and resins were also combined in series, increasing the percentage of compounds separated from the protein but also increasing the cycle time. In applications where a longer cycle time (e.g., over 10 minutes per run) is acceptable, any of the above columns or a series of the above columns may be used.

For shorter cycle times, other columns may be used. For example, the Regis GFF II column separated the protein fraction from 97% of the compounds tested. Its pressure rating of 8000 PSI was above that of the HPLC (Waters 2690) used in these assays, which was operated at a pressure of 6000 PSI. The cycle time of this resin was demonstrated to be easily less than 8 minutes and could be further decreased by using a faster flow rate in an HPLC that tolerates pressures up to 8000 PSI. The GFF II resin and GFF resin are internal surface reversed phase resins which were developed by Thomas Pinkerton for the direct analysis of drugs and drug metabolites in serum without interference by protein adsorption. The resins consist of a porous silica support with a hydrophilic external surface and hydrophobic internal pores accessible only to molecules with a molecular weight less than 12,000 daltons. These surfaces are produced by bonding the tripeptide glycine-phenylalanine-phenylalanine (GFF) or glycidoxylpropyline-phenylalanine-phenylalanine (GFF II) to the silica surfaces. The GFF or GFF II boned beads are then treated with the exopeptidase, carboxypeptidase A, which has a molecular weight (35,000 daltons) large enough to exclude it from the pores resulting in the cleavage of the phenylalanine-phenylalanine portion from the outer surface. This treatment allows the glycine or glycidoxylpropyl to be exposed intact on the outer surface making the outer surface hydrophilic but leaving the original tripeptide intact on the inner surface, thereby making the inner surface hydrophobic (as described, for example, by the manufacture's packaging insert). The catalogue number of the column with the GFF II resin that was used is 288-4. Other columns with other catalogue numbers that are packed with these resins are also available from Regis technologies and can also be used. The outer surface thus prevents large molecules from entering the inner layer through size exclusion and hydrophilic interactions. Small molecules enter the inner surface which is comprised of the hydrophobic support which retains and separates the compounds based upon hydrophobic interactions. Given the short cycle times and the degree of separation that can be achieved with the GFF II resin, the GFF II column was used for subsequence assays; however, other resins can also be used.

Protein fractions from the HPLC columns were dissociated with 1% TFA, and a 100 uL sample was injected onto a reverse phase column (Waters Symmetry Shield) to separate the compounds that had been bound to the protein. The compounds were eluted using an acetonitrile gradient past a UV detector and into a TOF mass spectrometer (Micromass LCT). The background signal was subtracted from each sample using controls containing the protein in the absence of compounds, and the mass spectrum was determined at cone voltages high enough to achieve fragmentation of the compounds (20 to 80 volts). In other mass spectrometry instruments, fragmentation can be achieved in a collision cell. The fragmentation pattern which is characteristic for each compound consists of the larger parent peak and other peaks representing fragments of the chemical compound or their isotopes. The fragmentation pattern of the compound(s) released from the protein target was compared to the characteristic fragmentation pattern observed for a compound standard to identify the compound(s) that bound the protein target. Alternatively, one or more characteristic isotope(s) of the parent peak representing the molecular weight of the compound was compared with the standard to identify the compound that bound the protein target. In another alternative analysis, the parent peak representing the molecular weight of the compound was itself compared with the standard to identify the compound. Sometimes, the combination of these methods was also used to identify the compound. Similar methods were applied under MS conditions which did not induce fragmentation of the compound, resulting in a mass spectrum containing peaks representing the molecular weight of the compound (e.g., the parent peak) and its isotopes.

Results from HPLC Based Method

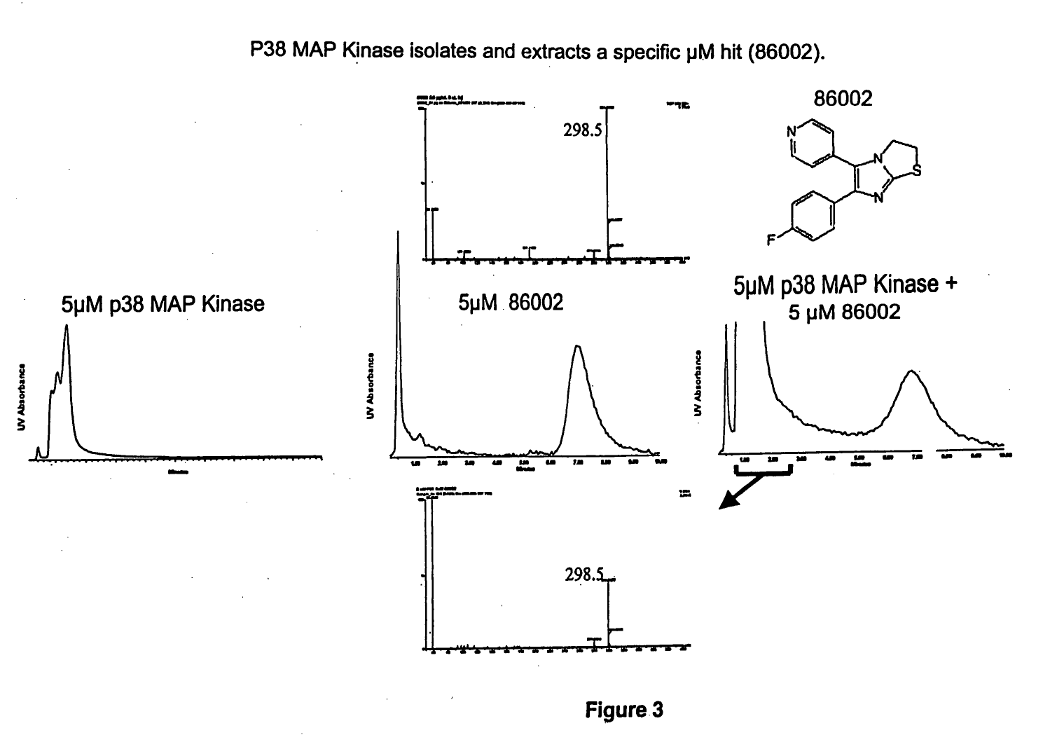

SKB86002 is a ligand with micromolar affinity for the P38 MAP kinase protein target. P38 MAP kinase (5 uM) was mixed with 5 uM 86002 and separated by HPLC on the Diol column (FIG. 3). The protein fraction was collected and analyzed by mass spectrometry. The parent peak, fragments, and isotope peaks in the spectrum corresponded to the 86002 standard indicating that the P38 MAP kinase isolates and extracts a specific ligand with micromolar affinity.

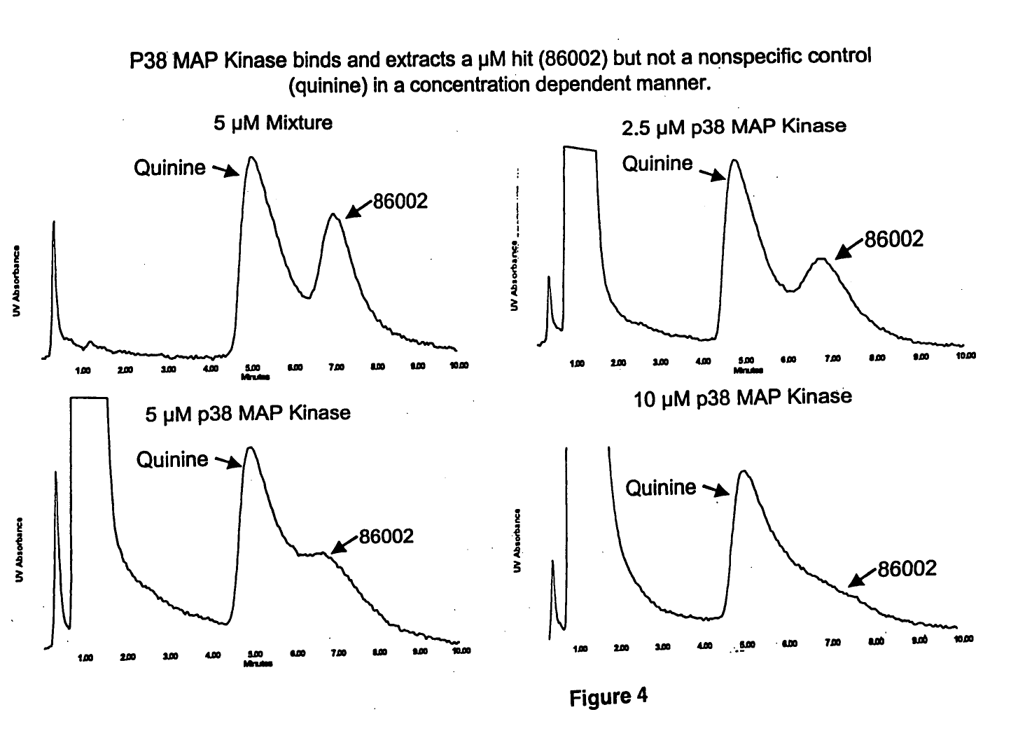

SKB86002 and quinine monohydrochloride (a nonspecific control compound) were mixed together to a final concentration of 5 uM each (FIG. 4). Increasing amounts of P38 MAP kinase protein (final concentrations 0, 2.5, 5 and 10 uM) were mixed with the compound mixture at a final concentration of 5 uM each, and the protein was separated by HPLC on the Diol column. The UV spectrum demonstrated a P38 concentration dependant reduction of the 86002 peak but negligible reduction of the quinine peak.

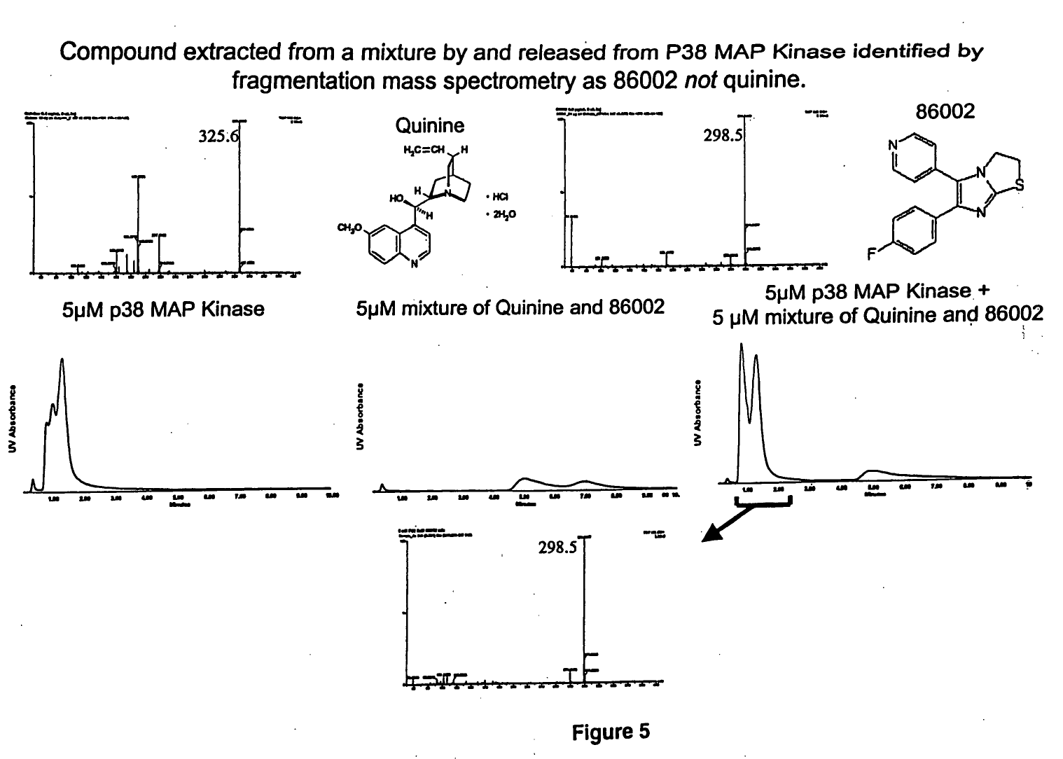

When the P38 protein fraction was collected at the mid-point in the titration (5 uM P38 MAP kinase+5 uM mixture of Quinine and 86002) illustrated in FIG. 4, the compound extracted from the mixture and released from the protein was identified as 86002, and not quinine, based on the parent peak, fragments, and isotope peaks in the mass spectrum of the released compound (FIG. 5).

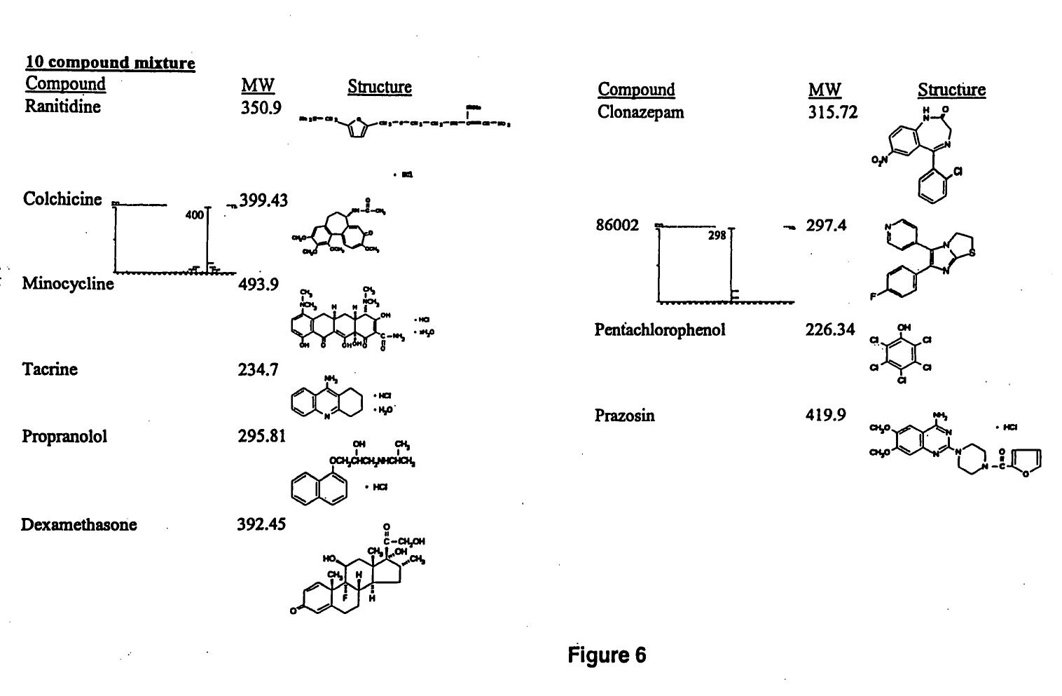

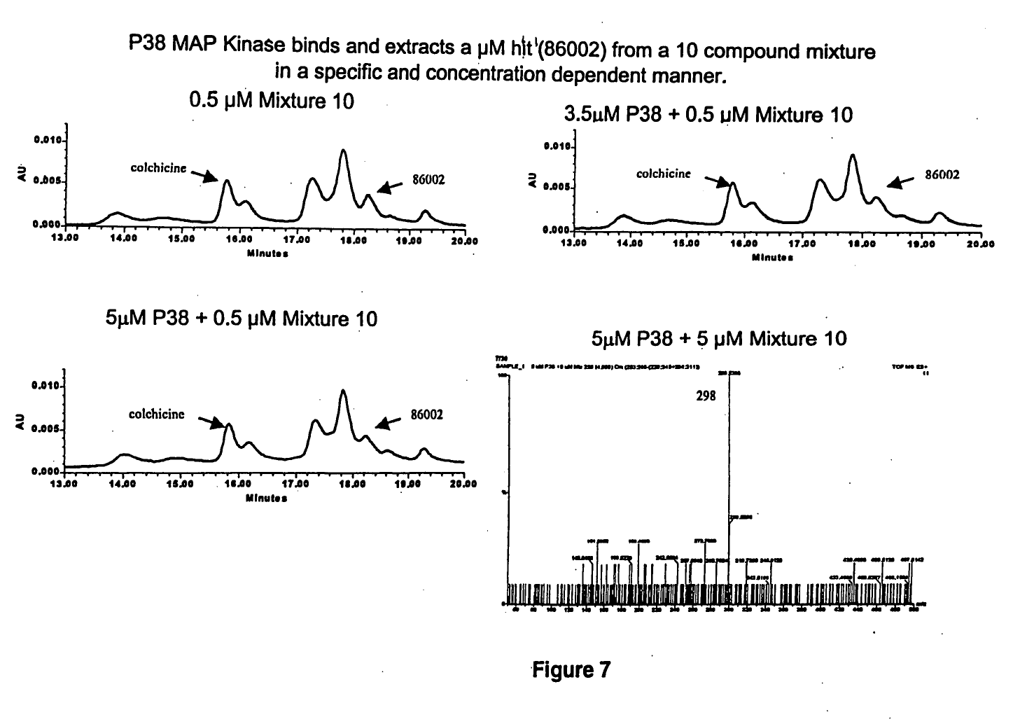

A mixture of equal amounts of 10 drug-like compounds including 86002 and colchicine was prepared (FIG. 6). Increasing amounts of P38 MAP kinase protein (final concentrations 0, 3.5, and 5 uM) were mixed with the 10 compound mixture at a final concentration of 0.5 uM of each compound, and the protein was separated by HPLC on the GFF II column (FIG. 7). The UV spectrum demonstrated a P38 concentration dependent reduction of the 86002 peak but negligible reduction of the Colchicine peak or peaks representing the other compounds in the mixture. When the protein fraction was collected and the mass spectrum was determined, the spectrum included the parent and isotope peaks characteristic of 86002 at a level far higher than other peaks.

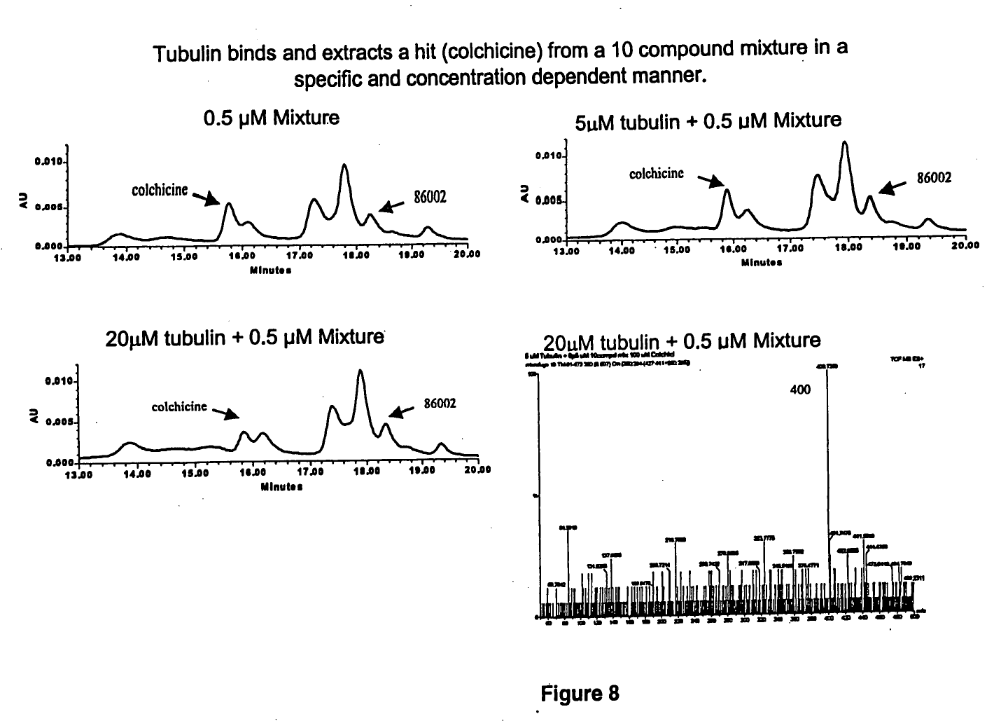

Increasing amounts of tubulin protein (final concentrations 0, 5, and 20 uM) were mixed with the 10 compound mixture at a final concentration of 0.5 uM of each compound, and the protein was separated by HPLC on the GFF II column (FIG. 8). The UV spectrum demonstrated a tubulin concentration dependent reduction of the Colchicine peak but negligible reduction of the 86002 peak or peaks representing the other compounds in the mixture. When the protein fraction was collected and the mass spectrum determined, the spectrum included the peaks characteristic of Colchicine at a level far higher than other peaks.

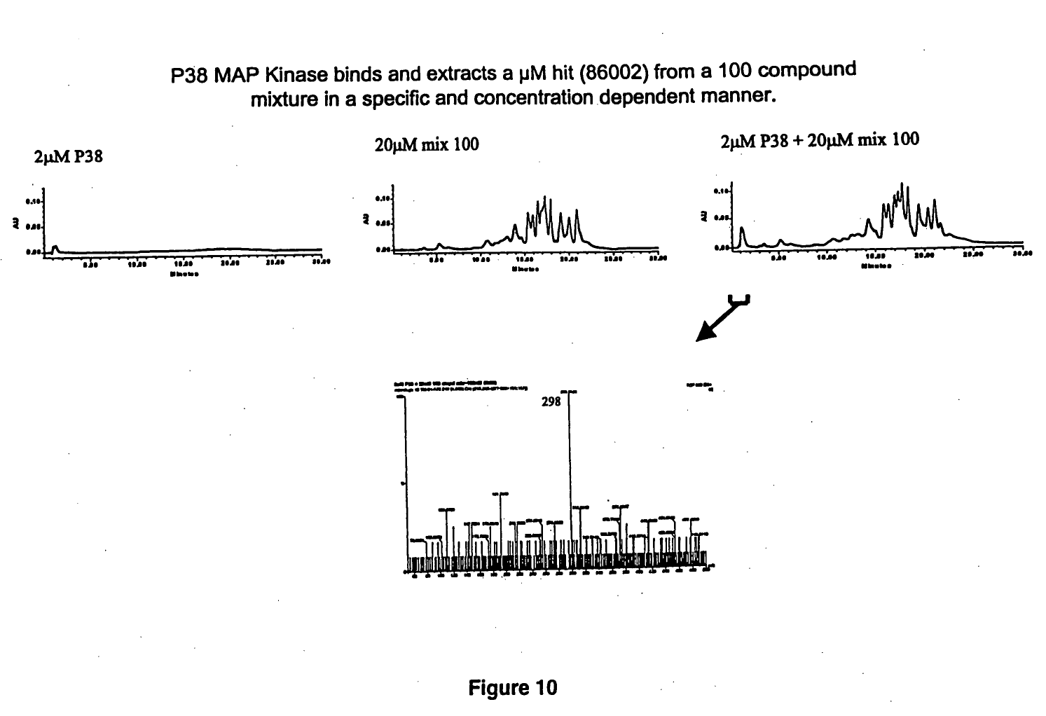

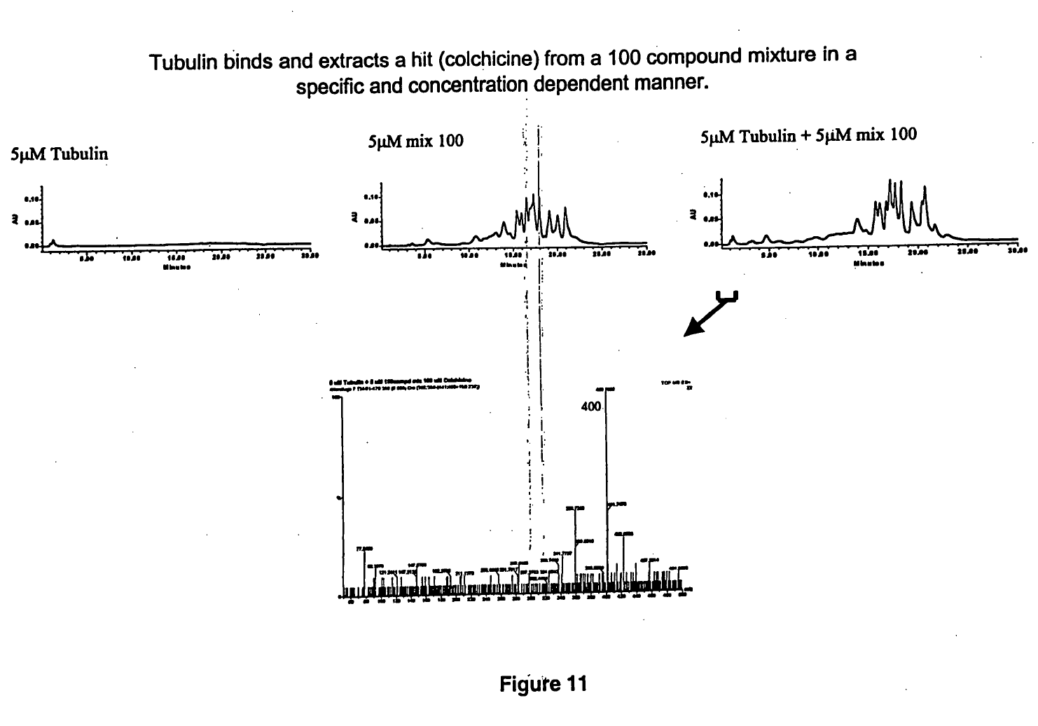

A mixture of equal amounts of 100 drug like compounds including 86002 and Colchicine was prepared (FIG. 9). P38 (2 uM) was mixed with the 100 compound mixture at a final concentration of 20 uM of each compound, and the protein was separated from the unbound compounds using the GFF II HPLC column (FIG. 10). The protein fraction was collected, the compound were released from the protein and mass spectrum was determined. The spectrum contained a peak characteristic of 86002 at a level far higher than other peaks. Thus, P38 MAP kinase binds and extracts a ligand with micromolar affinity (86002) from a 100 compound mixture in a specific and concentration dependent manner. The mass spectrum background appears to be comparable to that generated using only 10 compounds (FIG. 7), indicating that the assay should be scaleable to larger numbers of compounds (e.g., 1000's to 10,000's of compounds). For example, these methods may be used to analyze a library of over 10, 20, 40, 50, 75, 100, 200, 500, 1000, 2000, 5000, 10000, or more compounds or more chemical scaffolds.

Tubulin (5 uM) was mixed with the 100 compound mixture at a final concentration of 5 uM of each compound, and the protein was separated from the unbound compounds using the GFF II HPLC column (FIG. 11). The protein fraction was collected, the compound were released from the protein, and the mass spectrum was determined. The spectrum showed the peaks characteristic of colchicine at a level far higher than other peaks. Thus, tubulin binds and extracts a hit (Colchicine) from a 100 compound mixture in a specific and concentration dependent manner. The mass spectrum background appears to be comparable to that generated using the 10 compound mixture (FIG. 8), indicating that the assay should be scaleable to larger numbers of compounds (e.g., 1000's to 10,000's of compounds). For example, these methods may be used to analyze a library of over 10, 20, 40, 50, 75, 100, 200, 500, 1000, 2000, 5000, 10000, or more compounds or more chemical scaffolds.

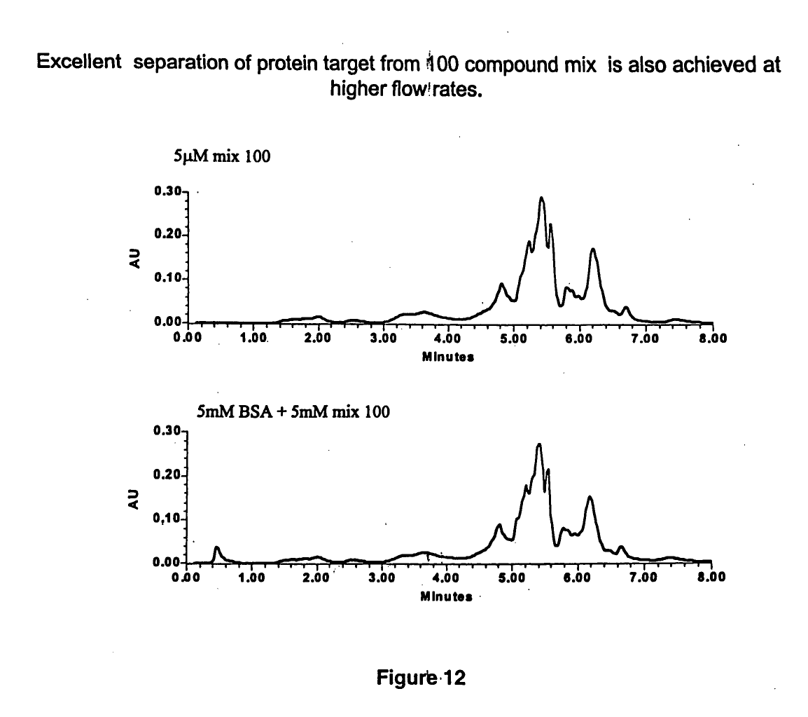

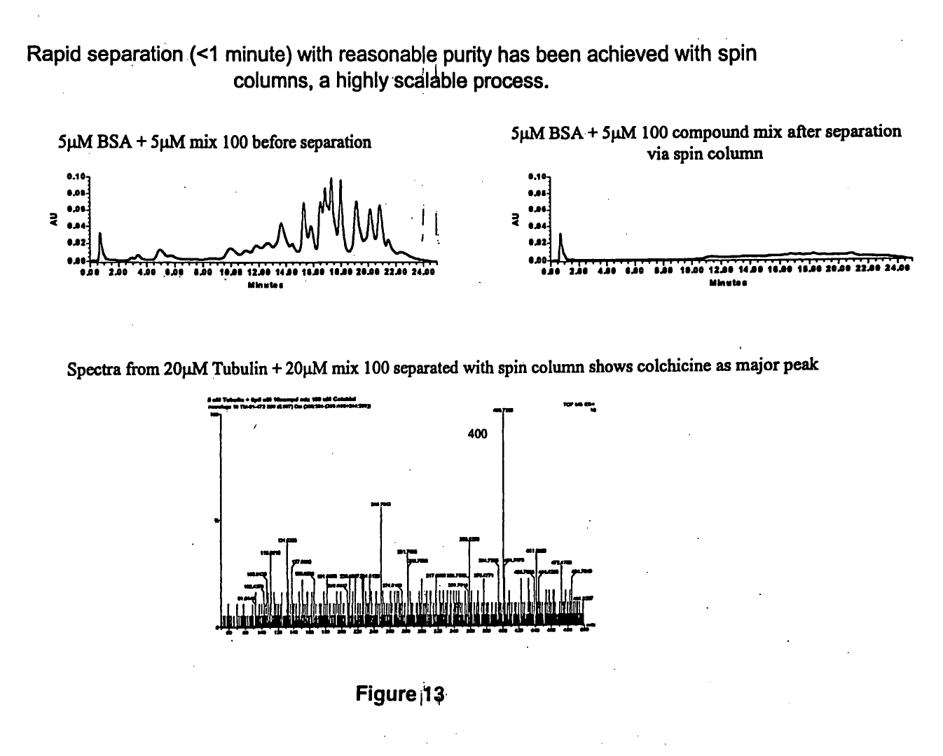

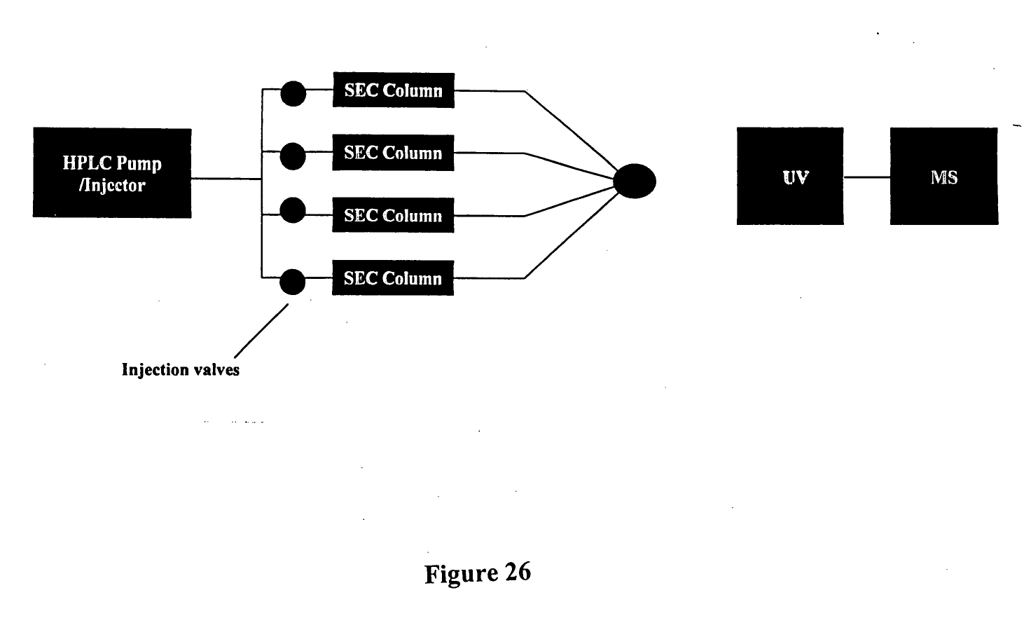

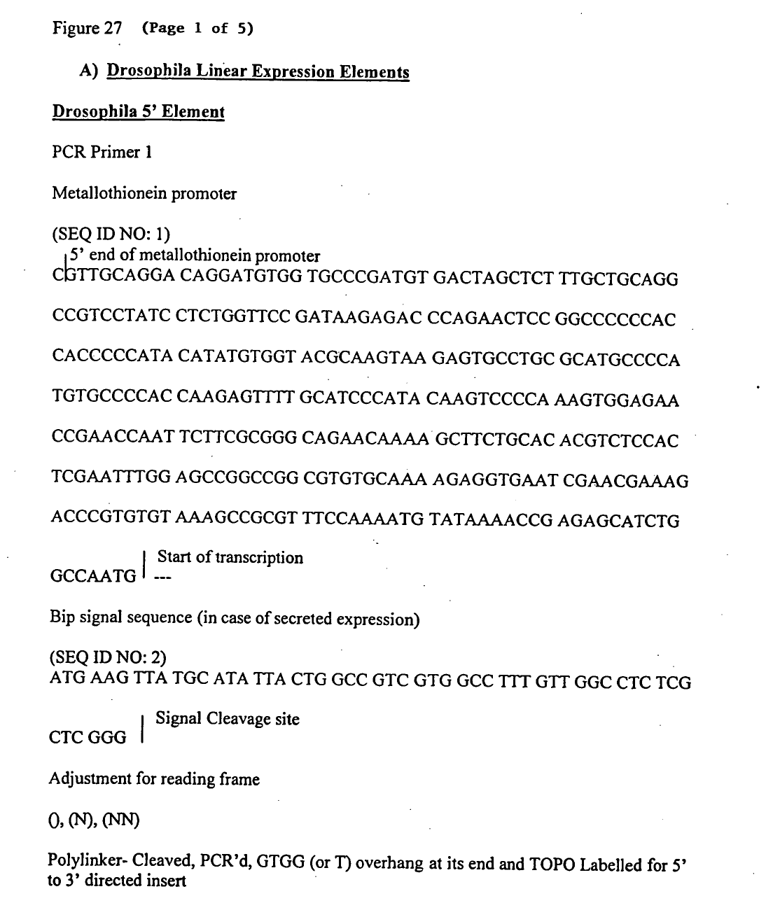

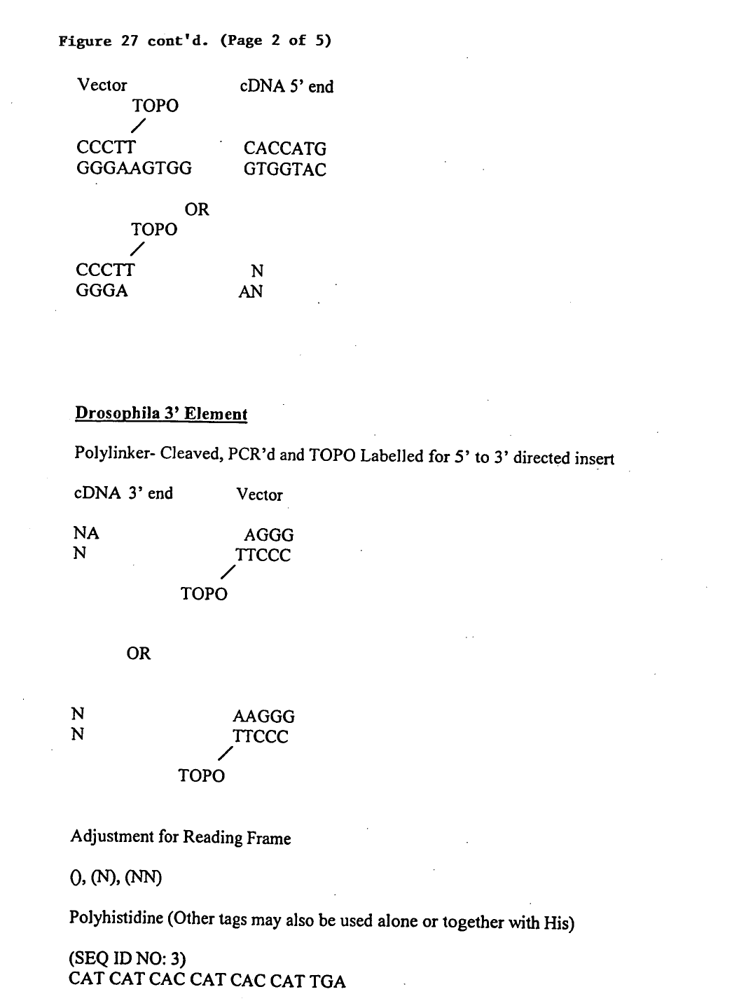

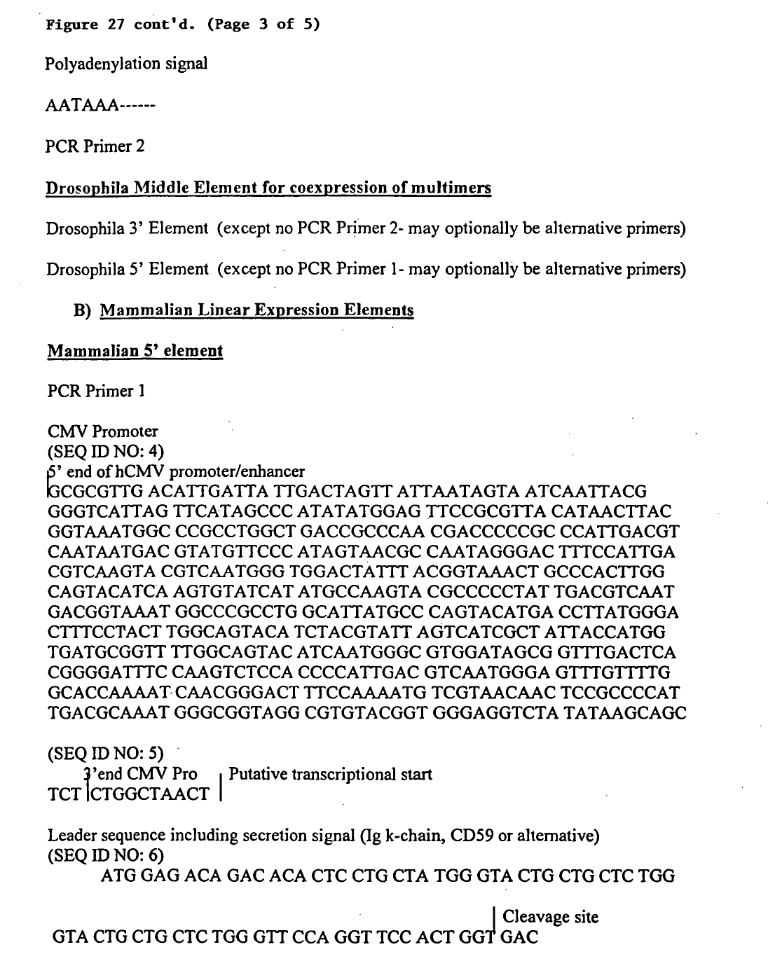

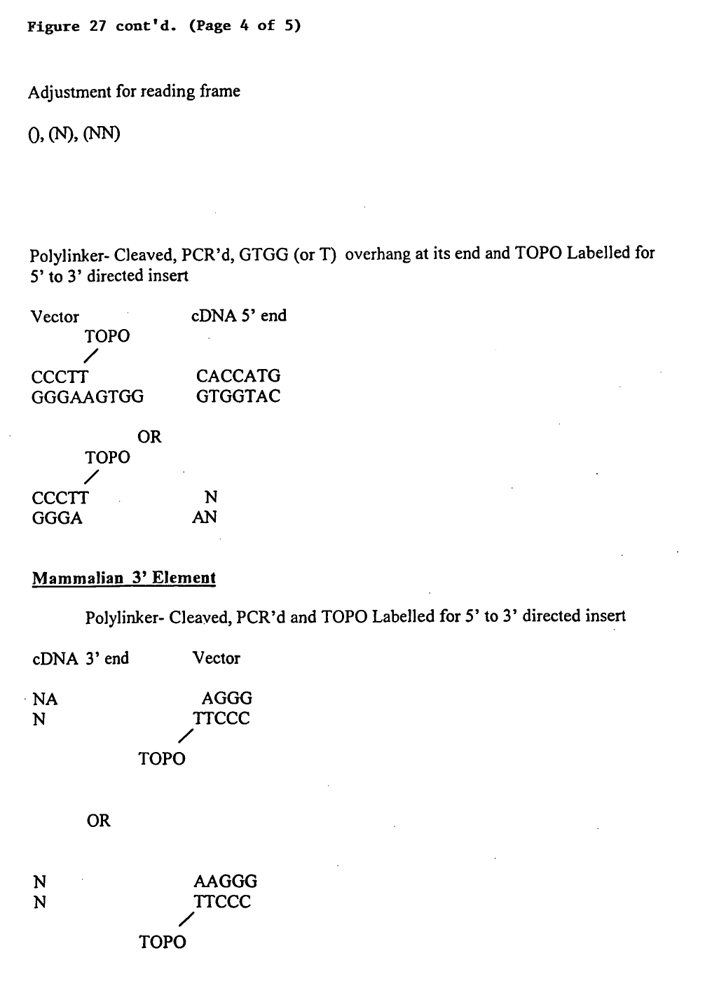

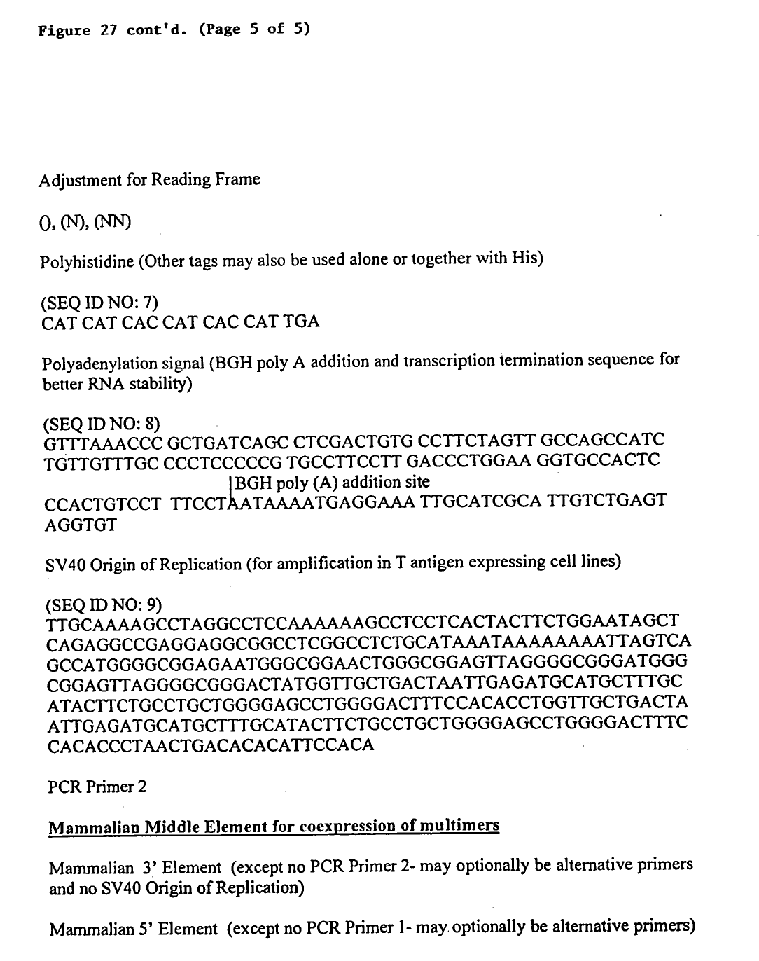

One way to increase the speed of the assay is to increase the flow rate (FIG. 12). The limiting factor affecting the maximum flow rate a column can withstand is generally the backpressure which the resin can tolerate before it collapses. One of the reasons the GFF II resin was selected is its ability to sustain pressures up to 8000 PSI compared with most size exclusion gels (e.g., Sepharose, Superose, Superdex, polymethylmethacrylate, polyhydroxymethacrylate, etc.) which have maximum back pressures of 100-1500 PSI. At high flow rates, the GFF II column still achieved excellent separation of the protein from the 100 compound mix, and all molecules have eluted from the column in approximately 6 to 7 minutes. Thus, one way to scale up the assay according to the invention is to perform HPLC using column switching devices including, but not limited to, the six column selection valves on the Waters 2790 HPLC with injection of a new sample into a newly switched column every minute. Custom column switchers can be made for two or more columns, up to approximately 10 columns (FIG. 26).

Spin-Column Chromatography Methods

Drug-like chemical compounds representing a collection of drug-like chemical scaffolds (Sigma-Aldrich, ICN, Calbiochem) were weighed and mixed to a final concentration of 20 uM each in 50 mM ammonium acetate pH 7, 10% methanol. 5 uM to 20 uM bovine serum albumin (BSA) or tubulin (Sigma) were dispensed into HPLC low volume sample cuvettes (Waters) and mixed with 5 uM to 20 uM compounds. After mixing and a 15 minute 37° C. incubation, the cuvettes were placed on ice. 50 uL of the 100 compound mixture listed in FIG. 9 was then layered on top of a MicroSpin G-25 (Amersham Pharmacia Biotech) spin column which had been previously equilibrated with two washes of binding buffer (i.e., each wash involved adding 200 uL of 50 mM ammonium acetate, 10% methanol buffer, and spinning the buffer through the column into a 1.5 mL microfuge tube (Eppindorf) at maximun setting in a microfuge (Eppindorf) for 30 seconds to a minute). Such spin columns are generally used to desalt and exchange buffer for DNA probes after labeling, though G-25 is one of the classic size exclusion resins with a 25 KD molecular weight cut off. The spin column was then placed in a 1.5 mL microfuge tube (Eppindorf) and spun for 30 seconds at maximum setting in the microfuge (Eppindorf). Alternatively, a vacuum can be used to pull solution through the spin column which is particularly useful when spin column/cartridges are arrayed in the 96 well format and a vacuum manifold is used to pull the solution through the column into a 96 well plate.

In the case of BSA, the 50 uL solution in the bottom of the microfuge tube was loaded onto the HPLC, the UV spectrum was visualized and compared with an equivalent amount of the BSA/100 compound mixture before separation. In the case of tubulin, 25 uL of the solution at the bottom of the microfuge tube was dissociated with 1% TFA and injected onto a reverse phase column (Waters Symmetry Shield), and the compounds were eluted using an acetonitrile gradient past a UV detector into a TOF MS (Micromass LCT). Background was electronically subtracted from each sample using controls containing the protein in the absence of compounds and the mass spectrum was determined at cone voltages high enough to achieve fragmentation of the compounds (20 to 80 volts). In other mass spectrometers, such fragmentation can be achieved in a collision cell. The fragmentation pattern which is characteristic for each compound consists of the larger parent peak and other peaks representing fragments of the chemical compound or their isotopes. The fragmentation pattern of the compound(s) released from the protein target was compared to the characteristic fragmentation pattern observed for a compound standard to identify the compound(s) that bound the protein target. Alternatively, a characteristic isotope of the parent peak representing the molecular weight of the compound was compared with the standard to identify the compound that bound the protein target. In another alternative analysis, the parent peak representing the molecular weight of the compound was itself compared with the standard to identify the compound. Sometimes, the combination of these methods was also used to identify the compound. Similar methods were applied under MS conditions which did not induce fragmentation of the compound, resulting in a mass spectrum containing peaks representing the molecular weight of the compound (e.g., the parent peak) and its isotopes.

Results from Spin-Column Chromatography Based Methods

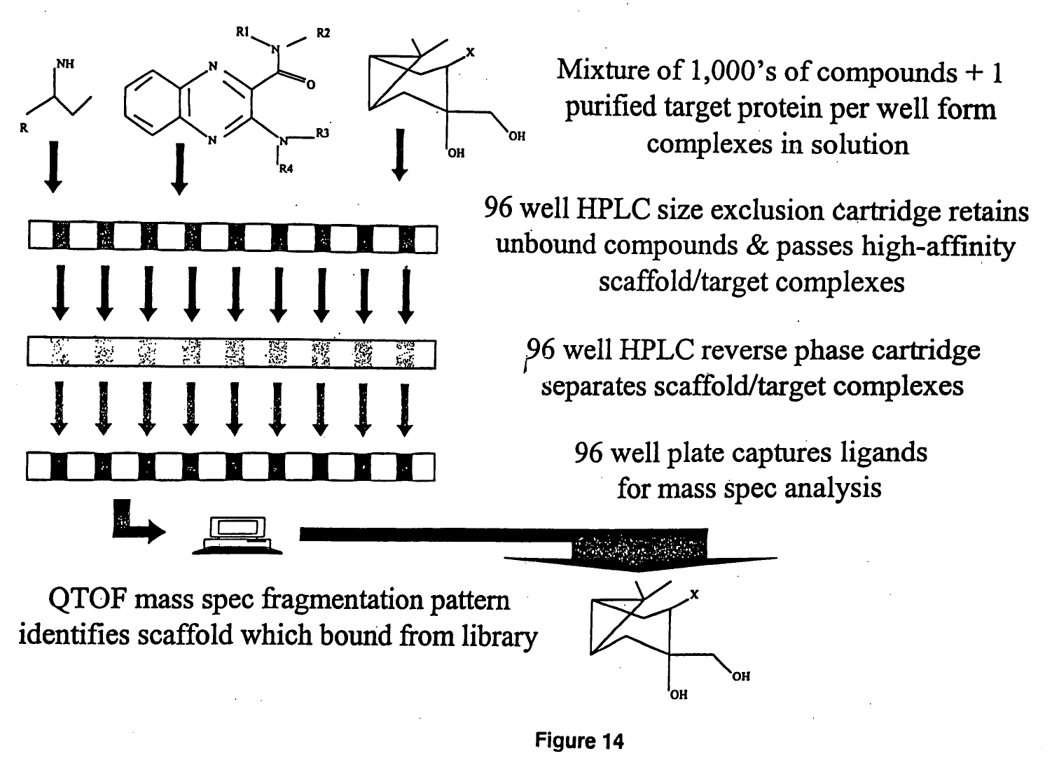

5 uM Bovine serum albumin (BSA, Sigma) was mixed with the 100 compound mixture at a final concentration of 5 uM of each compound (FIG. 13). Half (50 uL) of the mixture was layered on top of a Micro-Spin G-25 column and centrifuged. The protein containing fraction was collected at the bottom of the microfuge tube. When the initial protein/compound mixture was compared with the protein/compound mixture after separation using the spin column separation method, a significant purification of the protein was observed based on UV absorbance. When the same protocol was applied to a mixture of 20 uM tubulin and 20 uM of the 100 compound mixture and the mass spectrum was determined for the eluted protein-containing fraction, the spectrum showed the peaks characteristic of Colchicine at a level far higher than other peaks. Although the background peak was slightly higher than that observed using the HPLC column separation (FIG. 14), the speed and scalability of this spin column separation make it highly attractive. For example, these methods may be used to analyze a library of over 10, 20, 40, 50, 75, 100, 200, 500, 1000, 2000, 5000, 10000, or more compounds or more chemical scaffolds.

5.1.4.2. Exemplary Methods for the Use of Pattern Recognition Software to Identify Isolated Ligand(s)

The present invention provides methods for using pattern recognition analysis of a mass spectrum to identify a compound from a mixture that has been isolated using a protein target and any of the separation techniques described herein.

In these methods, mass spectrometry fragmentation patterns are determined for many or all of the compound present in the initial mixture of candidate compounds. Alternatively, isotope or other mass spectrometry patterns are determined for these compounds (e.g., M+1 or M+2 isotope peaks). The mass spectrometer sorts the compounds, their isotopes, and/or their fragments on the basis of their mass to charge ratio, denoted m/z. The mass spectrometry conditions can be adjusted so that most or all of the peaks represent molecules having a charge of +1 (or −1), so that the value of some of the peaks is equal to the mass of the parent compound, an isotope, or a fragment of the parent compound (i.e., m/z=m/1=m). In some cases, other mass spectrometry conditions can be used so that some or all of the peaks represent molecules having a charge of +2 or greater (or −2 or lower), so that the value of some of the peaks is less than the mass of the parent compound, an isotope, or a fragment because the mass to charge ratio is less than the mass of the molecule (e.g., m/z=m/2). Thus, the mass spectrometry patterns consist of mass spectral peaks corresponding to masses (or mass to charge ratios if the charge on the molecules is greater than one) of the parent compounds, their fragments, and/or their isotopes.

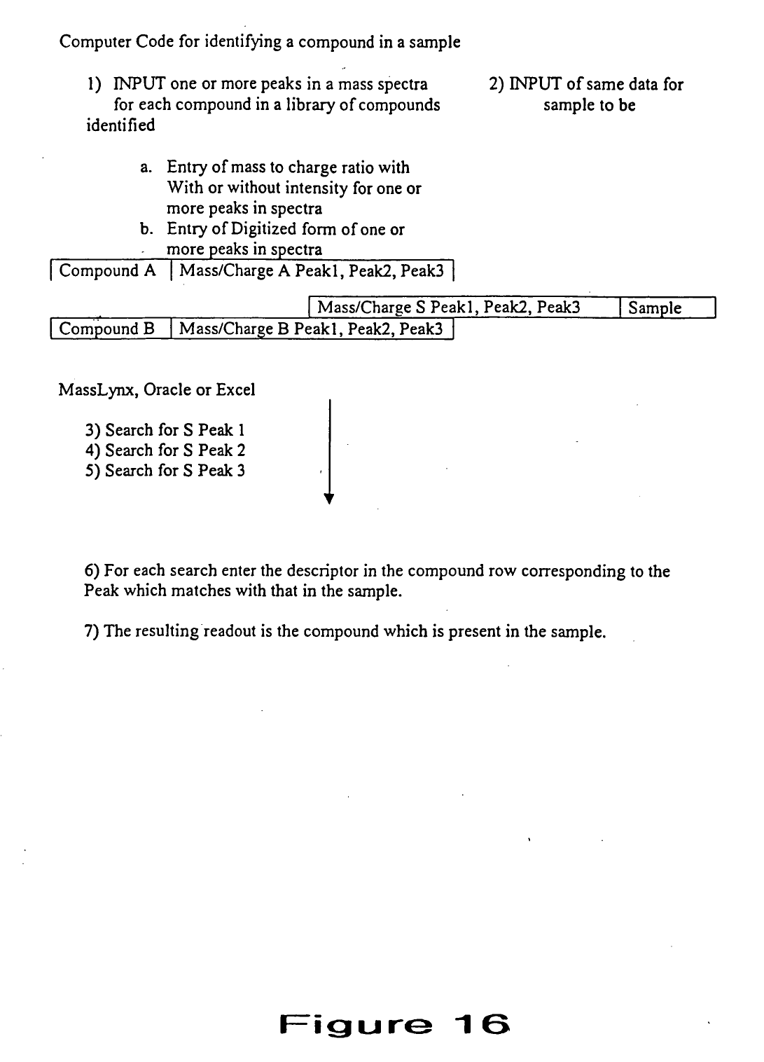

The mass (or mass to charge ratio) of each of these peaks is entered into the database of an information retrieval system. The mass spectrum of a compound of interest that was released from a protein target is generated, and then pattern recognition software is used to compare this pattern with those contained in the database. A match positively identifies the compound of interest. In one embodiment, peaks corresponding to two, three, or more of the most characteristic masses (compound 1: peaks A, B, and C; compound 2: peaks D, and E; etc.) are entered into the database for each of the compounds in the initial mixture. Software (e.g., MassLynx, version 3.5 from Micromass) is used to search the mass spectrum of the compound(s) released from a protein target for peak A followed sequentially by a search for peaks B, C, D, E, etc. The presence of a particular peak is entered into a second database to indicate that the peak is present in the mass spectrum. In another possible method, the searches for particular peaks in the mass spectrum are performed in any order. Iterative search commands may also be used to analyze the mass spectrum. For example, if peak A corresponding to a particular compound is present in the mass spectrum, then the mass spectrum can be analyzed to determine whether another peak (e.g., peak B) characteristic of the same compound is also present in the mass spectrum. Alternatively, if a peak characteristic of a particular compound is not present in the mass spectrum, then the mass spectrum can be analyzed to determine whether a peak (e.g., peak D) characteristic of another compound is present in the mass spectrum. In yet another alternative method, multiple peaks are searched together by overlaying a macro program over MassLynx. The peaks identified as present are compared with those in the first database from the compounds in the initial mixture to identify the compound(s) released from the protein target. FIG. 16 A contains an exemplary flow chart illustrating the steps for some embodiments of these methods.

In another embodiment, two, three, or more masses (or mass to charge ratios) corresponding to the most characteristic peaks of the mass spectrometry pattern are entered into the database for each compound in the initial mixture. In an exemplary method, this database uses a Microsoft Excel or Oracle program. Once the mass spectrum for the sample released from the protein target is determined and the two or three main peaks in the mass spectrum (e.g., the two or three peaks with the highest signal) are located, a search is performed on the database for the initial compound mixture using the masses (or mass to charge ratios) corresponding to those peaks. For example, the values of the masses can be used in the “Find” command of these programs to search for candidate compounds that produce peaks of that mass. The combination of masses identified in the search thus identifies the compound(s) present in the sample.

In a yet another embodiment, the intensity of the signal at a particular mass (or mass to charge ratios) is used to positively identify a compound. This technique is particularly applicable if the pattern being used is an isotope pattern. In this case, a database of compounds in the mixture is generated that contains both the mass as well as the intensity of each of the two or three most characteristic peaks. This information is then collected for the sample of interest. The search function of the database program is used to search for the correlated mass and intensity parameters. A match positively identifies a compound present in the sample.

In various embodiments for any of the methods of the present invention for the identification of one or more compounds of interest (e.g., compounds released from a target), one or more mass spectral peaks corresponding to one or more fragments of a compound and/or one or more mass spectral peaks corresponding to one or more isotopes of a compound is used to identify the compound. In other embodiments, the parent peak is used in the identification of the compound. In various embodiments, the parent peak is the only spectral peak used in the identification of a compound. In yet other embodiments, the parent peak is used in conjunction with one or more peaks corresponding to a fragment or an isotope in the identification of a compound. In still other embodiments, a parent peak is not used in the identification of the compound. In other embodiments, the compound is a component recovered from a mixture of at least 5, 10, 20, 40, 50, 75, 100, 200, 500, 1000, 2000, 5000, 10000 or more compounds that were contacted with a target of interest. In other embodiments, the compound is a component recovered from a mixture of compounds that includes at least 5, 10, 20, 40, 50, 75, 100, 200, 500, 1000, 2000, 5000, 10000 or more different chemical scaffolds. In particular embodiments, a parent peak is used in the identification of a compound from a mixture of compounds that includes at least 5, 10, 20, 40, 50, 75, 100, 200, 500, 1000, 2000, 5000, 10000 or more different chemical scaffolds.

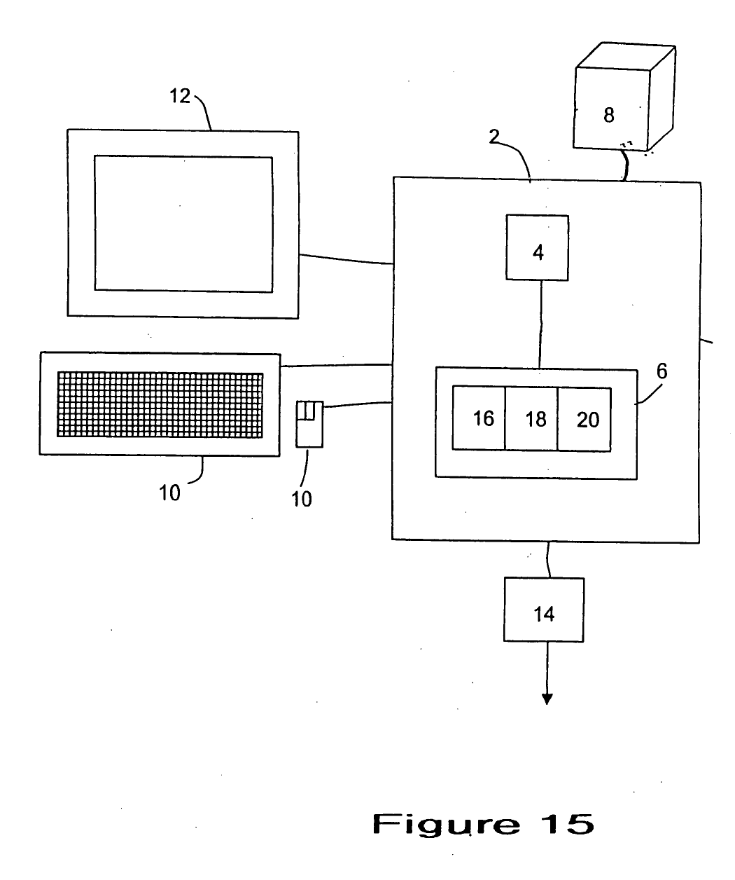

Any of the methods described herein may be implemented using virtually any computer. FIG. 15 shows such an exemplary computer system. Computer system 2 includes internal and external components. The internal components include a processor 4 coupled to a memory 6. The external components include a mass-storage device 8, e.g., a hard disk drive, user input devices 10, e.g., a keyboard and a mouse, a display 12, e.g., a monitor, and usually, a network link 14 capable of connecting the computer system to other computers to allow sharing of data and processing tasks. Programs are loaded into the memory 6 of this system 2 during operation. These programs include an operating system 16, e.g., Microsoft Windows, which manages the computer system, software 18 that encodes common languages and functions to assist programs that implement the methods of this invention, and software 20 that encodes the methods of the invention in a procedural language or symbolic package. Languages that can be used to program the methods include, without limitation, Visual C/C⁺⁺ from Microsoft. In preferred applications, the methods of the invention are programmed in mathematical software packages that allow symbolic entry of equations and high-level specification of processing, including algorithms used in the execution of the programs, thereby freeing a user of the need to program procedurally individual equations or algorithms. An exemplary mathematical software package useful for this purpose is Matlab from Mathworks (Natick, Mass.). Using the Matlab software, one can also apply the Parallel Virtual Machine (PVM) module and Message Passing Interface (MPI), which supports processing on multiple processors. This implementation of PVM and MPI with the methods herein is accomplished using methods known in the art. Alternatively, the software or a portion thereof is encoded in dedicated circuitry by methods known in the art.

5.1.5. Analysis of Target Function

To systematically classify target function, the hits for each target may be screened in cell and tissue based assays representing each of the major molecular mechanisms in disease pathogenesis. Where the target is originally selected based on differential expression analysis, assays which are particularly relevant to that differential expression are preferred (e.g., a proliferation assay would be particularly relevant where the target arose from differential expression analysis of carcinoma cells). This panel of assays includes but is not limited to assays to detect and or measure: apoptosis, proliferation, ischemia/necrosis, inflammation, fibrosis, angiogenesis, metabolic signaling, infection and development/differentiation. By focusing on pathogenic pathways and studying disease specific and cell specific targets, novel targets for a number of therapeutic areas may be identified. The goal of this panel is to screen for small molecule/protein members of the molecular pathways leading to significant diseases including but not limited to chronic degenerative diseases (e.g., Alzheimer's disease, osteoarthritis, osteoporosis), metabolic diseases (e.g., diabetes, obesity), inflammatory diseases, cancer, cardiovascular (e.g., coronary artery disease, hypertension, congestive heart failure cardiomyopathy, chronic renal failure) and infections (e.g., viral, bacterial, protazoan, and mechanisms of drug resistance). The assays are designed such that the same assay can be used in cells first with follow up in tissue biopsied from patients with the disease. To identify potentially toxic molecules, necrosis assays may be performed on all molecules. The standard industry microtitre plates of 96 wells provide sufficient scale to conduct these phenotypic screens though high throughput and ultra high throughput formats are not precluded. Assays may be performed on cell lines, primary cell culture, tissue biopsies, tissue models, in vivo animal models, or other organisms. In a preferred embodiment, the bioassays are performed using human cell lines and tissues. According to other embodiments, the bioassays may be performed using cells, tissues, organs or whole organisms of any species. Though ligands can be pooled in these assays, it is useful that each phenotypic assay be performed with one species of molecule per well to avoid agonist and antagonist interactions which may mask the phenotypic effect. The assays include but are not limited to allowing the diseased cell or tissue to enrich for genes which may be relevant to disease or a therapeutic response.

Although applications of the invention toward target identification in cancer, diabetes and stimulation of cells with TGFβ are described in the examples, the approach set forth above can be broadly applied to any disease, cell stimulus, biological modulator or condition. Other assays than those described and those for other molecular pathways relevant to diseases can also be used. By taking this approach starting with genes up-regulated or down-regulated in diseased cells relative to normal cells or tissues or in cells in the presence of an agonist or antagonist (or partial of each) one is enriching for targets with specificity and a good therapeutic index. By crossing this specificity with molecular mechanisms in disease pathogenesis, one is enriching for targets which may be therapeutic. By sequentially combining a biochemical binding assay which selects hits in a highly efficient manner from large libraries and using these hits in a low throughput high quality phenotypic bioassay reflective of the human disease, one can determine the function of the gene.

5.2. Phenotype to Genotype

In an alternative series of embodiments, the present invention relates to a method of screening a plurality of potential ligands in at least one bioassay, selecting ligands which produce a change in phenotype in a bioassay, and using the ligand to screen candidate targets to identify the particular target(s) responsible for the altered phenotype. In various preferred embodiments, individual species of ligands are separately screened in bioassay(s). A ligand which produces a change in phenotype in a bioassay may be exposed to a plurality of potential targets under conditions which permit ligand-target interaction. In various preferred embodiments of the invention, the target is a peptide or protein and each peptide or protein target is associated with a polynucleotide which encodes that target (e.g., by phage display or cell surface display). Selected targets and their corresponding polynucleotides are collected. The DNA sequence encoding targets which are proteins may be sequenced, cloned, and validated. The differential expression of these targets may then be studied in human disease tissue biopsies particularly where the molecular mechanism of the phenotype may be phenotypically relevant. Similarly the ligand may be studied in diseased tissues and/or in vitro or in vivo models of these diseases. One embodiment is outlined in FIG. 2. As noted above, the embodiments listed in sections 5.1.1 to 5.1.5 can be used in any of these methods.

High throughput phenotype cell based assays according to the invention differ from high throughput screening methods as they are currently practiced. The typical high throughput screen is a mechanism based assay where the gene for a validated target is transfected into a cell line with a reporter system (e.g., green fluorescent protein, luciferase, etc.) and members of a chemical library are screened for activation of the reporter. Instead of conducting this type of screen, the present invention focuses on looking for a significant change in phenotype in cell lines without predetermining the molecular target in a bioassay. These bioassays are designed to look for ligands which modulate an important biological stimulus or an important pathogenic mechanism. Non-limiting examples include apoptosis, proliferation, ischemia, necrosis, inflammation, fibrosis, invasion, angiogenesis, metabolism, infection and embryogenesis. In addition, individual pathways of cellular stimuli with pluripotent effects can be blocked by antisense, translocating peptides, antibodies or other techniques to identify targets which are more specific in their effect. In this way we achieve an association of ligands from the library (as described above) with a phenotype in a bioassay. Assays for molecular mechanisms in disease including but not limited to those described above may be adapted to high throughput screening.

Although applications of the invention toward target identification in cancer are discussed herein, the invention can be broadly applied to any disease, cell stimulus or condition. Other assays than those described related to biological stimuli and those for other molecular pathways relevant to diseases or biology can also be used. By sequentially combining a bioassay in which a ligand is associated with a particular phenotypic change of interest and using these hits to select for the target in a protein or peptide display library, one can clone the gene for and identify the target. The differential expression of the target in human disease tissue may then be studied. In addition, the specificity of a ligand's effect in an in vitro or in vivo bioassay may reveal the utility of that ligand in modulating a biological affect or treating a particular disease.

5.3. Mapping Molecular Signaling Pathways

Once a number of genes have been shown to be involved in a particular molecular pathway of disease pathogenesis the targets can be mapped within the molecular pathway relative to one another and to known members of the pathway. The ligands binding to the different proteins may be derivatized with photoactivatable crosslinkers and used to position each member in the pathway. For example, one member of a pathway is first labeled (e.g., GFP). Next, members of the pathway are exposed to ligands derivatized with functional groups which may be crosslinked. Then, the mixture is exposed to the crosslinking stimulus. Lastly, the selected member of the pathway is collected using the label (e.g., GFP) and any compounds which have become associated with it are identified. This may be repeated stepwise to identify earlier or later pathway members. These methods have the advantage of not requiring the prior identification of the binding sites for the ligands or the determination of the secondary or tertiary structure of the target molecule prior to crosslinking.

Pathway members may then be used as targets in ligand screens. By comparing the phenotype of each ligand which selectively binds each pathway member, positional information about each pathway member relative to others may be obtained. This information can be used to validate and select the best target for a given disease indication and eventually select the best therapy through pharmacogenetic based diagnosis.

5.4. Optimization of Leads

The present invention provides a method for optimizing leads and increasing the hit ratio. The term “lead” as used herein refers to a ligand with pharmaceutically desirable properties. Preferably the molecule would be considered a “small” molecule in the art, for example having a molecular weight between 50 Da and 3000 Da. The method has broad application, but is particularly useful for obtaining ligands which interfere with protein-protein interactions.

Proteins usually have a distinct region on their surface or a region buried deeper as a pocket, which displays increased affinity towards binding small molecules. These so called binding sites have relatively well defined shape and size. Many drug molecules bind one at a time to different regions in the protein. To identify small, drug-like molecules which bind to a target protein, one approach is to test the binding capabilities of “drug-like” molecules in a binding assay (see, for example, Lipinski, et al., Adv. Drug Delivery Rev., 23, 3-25, 1997, for characteristics of “drug-like” molecules). For example, the binding assays (e.g., size exclusion chromatography-based assays) described herein are uniquely suitable to investigate a large number of small molecules under physiological conditions and rapidly identify reasonably strong binders. The binding assays according to the invention can be any assay which measures binding including, but are not limited to, size exclusion chromatography based assays, chip based assays, filter based assays, array based assays, column based assays, filtration based assays, and binding assays in solution or in solid phase. A preferred assay is one which can pull ligands from a mixture of compounds (e.g., the size-exclusion chromatography based assay described herein) because of its highly parallel nature and ability to multiplex. The identified small molecules (“hits”) can be further optimized. In this case, any one of the molecules are considered to be an early drug candidate. Many of these molecules have a molecular weight within, or close to, 200-500 daltons. As described further below, combinatorial chemistry using the hits from the binding assay can be used to react two or more molecules to generate a product with higher affinity for the target protein (FIG. 23). The binding assay can then be repeated using concentrations of reagents designed to identify ligands (e.g., products from the combinatorial chemistry reactions) with higher and higher affinity. For example, while the first hit may have a K_{d} in the micromolar range, the optimized lead may be selected for an affinity with a K_{d} in the nanomolar or higher affinity range. In one preferred embodiment, mixed combinatorial chemistry in solution phase is performed. The method overcomes a common bottleneck in combinatorial chemistry: the purification of individual compounds from mixtures and culling is not needed because a target molecule (e.g., a target protein) can be used to purify the high affinity binders from a mixture of compounds.

Because a large number of chemical leads may be characterized at the biochemical and phenotypic levels, a structure activity relationship may be established to serve as a basis for lead optimization. If molecules with similar activities are identified, the structure activity relationship (SAR) can be determined. A target directed synthesis technology can be employed to crosslink molecules binding close to each other indicating if their activity is mediated through the same active subsite on the protein or through different subsites on the protein target. In one embodiment, one of the molecules contains a photactivatable crosslinker, or one molecule contains a reactive group that is reactive with a group on a second molecule. In this way additional different functional subsites on the target can be mapped and different mechanisms can be interpreted from the phenotypic findings with molecules binding to those subsites (e.g., agonist vs. antagonist). Photoactivatable crosslinkers on one of the functional groups of the ligand scaffold may be used to link ligands bound to the target thus using the target molecule as a template.

This different approach to lead optimization and synthesis is based on the fact that the majority of drug and drug-like molecules—due to their size which matches the size and shape of a binding site in the target while also taking advantage of its polarity and charge distribution—consist of two or more smaller subunits that have a molecular weight about from a third to a half of a drug or drug-like molecule. In some embodiments, these subunits have a molecular weight of less than 1,000, 500, or 200 daltons, may or may not contain an entire drug-like scaffold, and bind with μM or less than μM K_{d} affinity. These subunits act as building blocks that are connected either directly or through a linker to form a larger but still drug-like molecule. Also these individual building blocks usually bind to the binding site with a decreased but still useful affinity. Alternatively, building blocks may be included which impart different characteristics important to lead optimization (e.g., solubility, membrane crossing, bioavailability, and/or up or down-regulation of metabolism). The size exclusion chromatography based assay technology offers a unique opportunity to identify two or more such small “building blocks” from mixtures containing hundreds or thousands of individual subunit molecules. Two or more building blocks may bind together to one protein binding site.

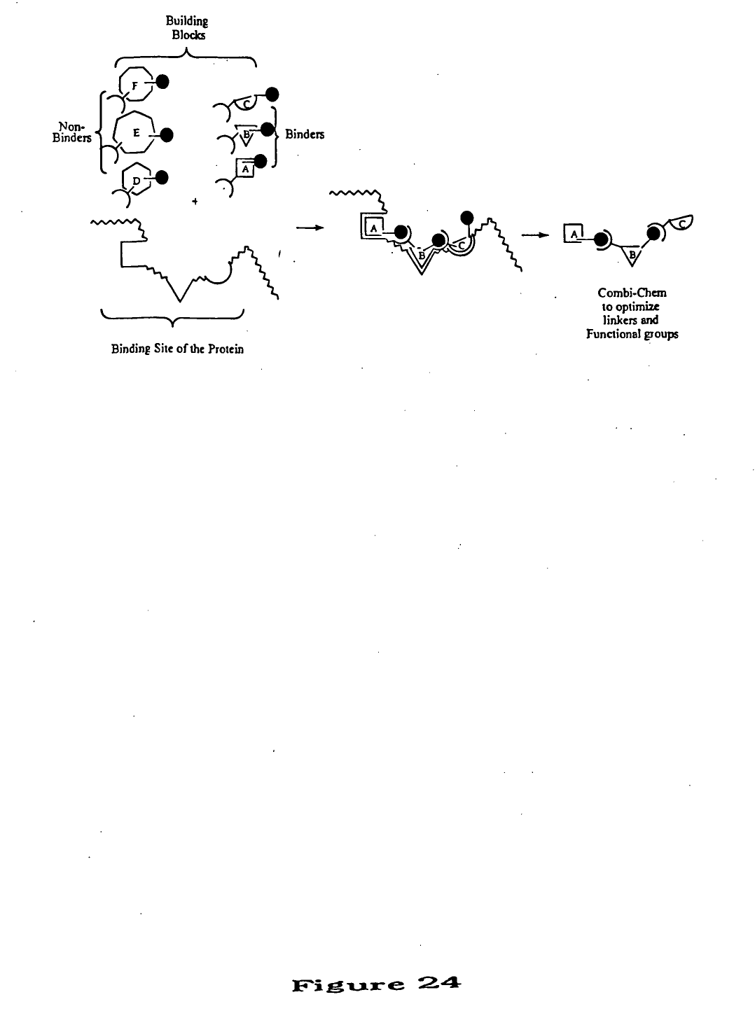

The protein's ability to select suitable small molecule pairs or triplets can be exploited for small molecules that contain reactive groups and for small molecules that do not contain reactive groups. In the former case, the building blocks have complimentary reactive groups on them or attached to them with linkers (FIG. 24). As the small molecules are organized and selected by the protein's binding site, they are located next to each other. The close proximity of those reactive groups may trigger the “coupling” reaction in which the small molecules react to form a product. The resulting products with the highest affinity for the protein may be identified using the size exclusion chromatography assay or any other described herein together with high resolution LCMS. In this case, a mixture of the building blocks preferably has the reactive groups in different orientations on them. Preferably, a combinatorial library of such variations are tested. This method may take advantage of, for example, condensation, substitution, and addition reactions. Any reaction is suitable which uses moderately reactive groups, so that they wouldn't react or react only very slowly in absence of the protein’ binding site which orients them in very close proximity to each other. This slow kinetics of the reactions can be accelerated if the reactants are close to each other. The protein's binding site is providing a “template” for the different small fragments to find their pairs and “self assemble.” In some embodiments, the small molecules react in the presence of the protein but not in the absence of the protein. In certain embodiments, the amount of product formed in the presence of the protein is at least 2, 5, 10, 20, 30, or 50-fold more than the amount of product formed in the absence of the protein. In preferred embodiments, the crosslinking or reaction occurs under physiological conditions.

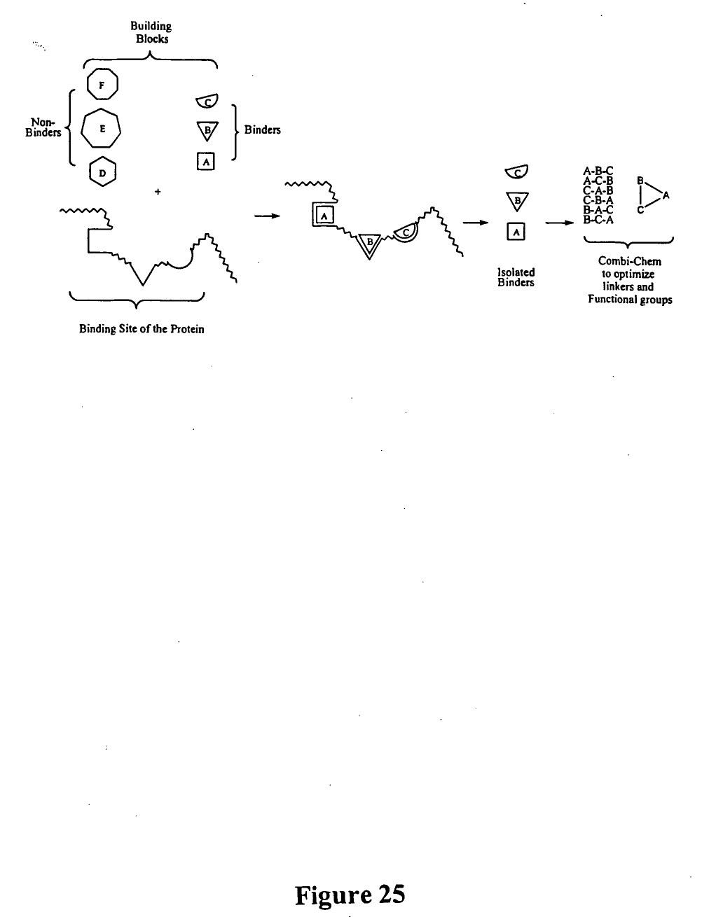

In other embodiments, the building blocks are relatively non-reactive stable, small molecules including, but not limited to, small heterocycles, amino acids, carbohydrates, aromatic rings, ureas, thioureas, guanidines, amines, acids, sulfones, sulfoxides, or any small molecule subunit of any drug or drug-like molecule (FIG. 25). These small molecules may bind as described above in pairs or triplets and the resulting products with high affinity for the protein may be identified using the size exclusion chromatography based binding assay. The functionalized distinct pairs or triplets than may serve as scaffolds for solid or solution phase combinatorial chemistry, and a number of combinations may be synthesized and retested. The strong binders then may be used as staring scaffolds for further combinatorial chemistry, using the targeted protein as the main directing force for selecting promising small molecules. In some embodiments, the small molecules react in the presence of the protein but not in the absence of the protein. In certain embodiments, the amount of product formed in the presence of the protein is at least 2, 5, 10, 20, 30, or 50-fold more than the amount of product formed in the absence of the protein. In preferred embodiments, small molecule fragments are minimally substituted (e.g., substituted with a group that causes only a small change in molecular weight), but “meaningfully” substituted (e.g., substituted with a group that improves binding affinity for the target, improves solubility or biodistribution, or increases reactivity with other subunits) for applications without linkers. These molecules include, but are not limited to, the following small ring systems: hexoses, pentoses, and 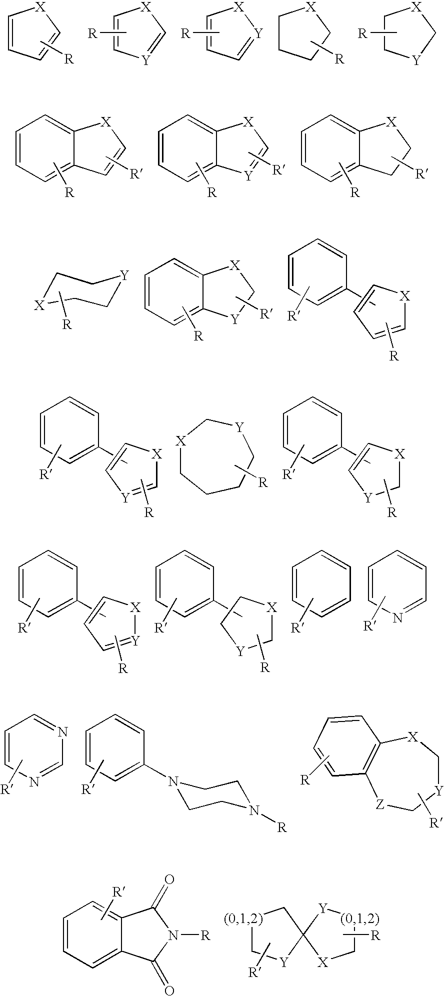
R, R′ are the same or different, and are selected from the group consisting of hydrogen, small alkyl, alkenyl, hydroxyalkyl, aminoalkyl, chloroalkyl, alkoxy, acyl, carbonyl (where appropriate), carboxyl, and variations thereof.
X,Y,Z: are the same or different, and are selected from the group consisting of C, O, S, and N
Acyclic small molecules may be selected from any class as long as they don't contain pharmacologically unacceptable groups (e.g., formyl halide, acyl halide, reactive formyl, aliphatic ketones, 1,2-dicarbonyls, haloketones, phosphonate esters, sufonate esters/halides, thiols, or vinyl-ketones). Some examples of pharmacologically acceptable small molecules include, but are not limited to, substituted ureas, thioureas, guanidines, alcohols, ethers, amines, amides, oximes, hydrazones, esters, carboxylic acids, and nitrites.

In another exemplary method, small molecule A and small molecule B can be mixed alone or in the presence of other nonbonding small molecules with the target (s) and a bifunctional crosslinker capable of reacting with both A and B in which one functional group is protected and the other is free. Alternatively, A can be reacted with a crosslinker, and the resulting product can be reacted with B. Functional groups can include any reactive group, including, but not limited to, amine, carboxylic acid, nitrile, and halides. The same or different functional groups can be on A or B. In one example of a pair of small molecules A and B that can react with each other, A contains an amine functional group, and B contains a crosslinker with a carboxylic acid, an activated ester, and anhydride, an acylhalide, or any other group which can react with the amide in an acylation or an alkylation reaction. Linkers can include a molecule which only contains two functional groups or contains a component in between the functional groups including, but not limited to, polyethylene glycol. Exemplary protective groups include amine protecting groups such as BOC, FMOC, or benzyl. The CBZ protecting group can be used to protect carboxylic acids benzylester, allylester, and nitrites. In one embodiment, protective groups are photoactivated to deprotect a functional group, such as Nitrobenzyl or azo groups. In another embodiment, linkers containing functional groups which do not react with proteins and compounds which do not contain the functional groups on proteins (i.e., amines, carboxylic acids, alcohol, and SH groups) are used. In an example, the compound contains or is modified to contain a halide (e.g., Cl). A linker containing double bonds, triple bonds, halides, or aromatic groups can then be linked to the compound through a Heck coupling reaction or a Suzuki reaction resulting in a linkage of the linker with the compound without reacting with the protein. Such chemical compounds are available from Aldrich. Linkers and protective groups for the above reactions are available from Advanced Chemtech and Novobiochem among others. This linking may increase the affinity of binding to the target in a preferred embodiment between 2 and 100 fold or more. Thus, a superior lead with higher affinity can be obtained. This approach can also be used to further enhance the structural diversity of a chemical library in a target directed and biologically relevant way.

These methods are enabled by the high-throughout binding assays described herein. These methods are suitable to rapidly identify small fragments of a drug candidate from a mixture of a large number of other non-binders. The identification, assembly, and further optimization of small molecules towards drug candidates is directed and controlled by the protein. The whole “auto-selection” process is taking place under physiological conditions, thus approximating very close conditions in the protein's natural structure and environment. The assay technique enables a very fast progress and can use widely diverse mixtures of small building blocks. In some embodiments, information about an identified subunit or a product of two or more subunits is used in the synthesis of other compounds.

In other methods, the hits (i.e., the identified ligands with affinity for a target molecule) from binding assays described herein are reacted in the absence of the target molecule to generate products that contain moieties from two or more ligands. If desired, the rate of reaction between the hits can be increased by means including, but not limited to, altering the pH, solvent, catalyst concentration, or temperature of the reaction mixture. The resulting products may then be applied to a binding assay described herein to identify the products with the highest affinity for the target molecule.

5.5. De Novo Synthesis of Leads

Methods identical to those described in the Section 5.4 can be used for the de novo synthesis of lead compounds that bind a target molecule. In particular, compounds such as small molecules from a library can be reacted in the presence of a target molecule, such as a target protein. The target molecule promotes or catalyzes the reaction of small molecules that bind the target to generate products with higher affinity for the target. In some embodiments, the small molecules react in the presence of the protein but not in the absence of the protein. In certain embodiments, the amount of product formed in the presence of the protein is at least 2, 5, 10, 20, 30, or 50-fold more than the amount of product formed in the absence of the protein. In other embodiments, the target isolates fragments which can be reacted in the absence of the target to form additional lead compounds. The resulting products can be applied, without prior purification, to a binding assay described herein to identify the products with the greatest affinity for the target. Thus, the assay can serve, and enables the target to serve, as the universal director of combinatorial synthesis.

### 6. GENOTYPE TO PHENOTYPE

### 6.1. Example 1

### Breast Cancer

6.1.1. Targets

A biopsy is first collected from at least one breast cancer patient. Laser capture microdissection and ANRNA or RT PCR may be used in conjunction with microarray analysis to isolate genes which are differentially expressed in the cancerous cells. For example, these techniques may be used to identify transcripts which are present in cancer cells at levels more than 2-fold higher than non-cancerous cells in the same biopsy. Alternatively, the genes may be overexpressed in non-cancerous cells. Genes may further be selected for those which are expressed at such levels in a significant fraction of patients tested.

Tissue may be embedded in Tissue Tek OCT medium (VWR), frozen in liquid nitrogen, and sectioned in a cryostat. Sections may be mounted on uncoated glass slides and stored at −80° C. Slides may be fixed in 70% ethanol for 30 s, stained with H&E followed by 5 s dehydration steps in 70%, 95%, and 100% and a 5 min dehydration step in xylene. After air drying, the sections may be laser microdissected using the PixCell I and II LCM system (Arcturus Engineering). 5×10⁴ each of morphologically normal breast epithelial cells, malignant invasive breast carcinoma cells and malignant metastatic breast carcinoma cells (e.g., from the axillary lymph node) may be captured. The total RNA may be isolated from each of these cell populations by transferring a transfer film with adherent cells into guanidinium isothyocyanate at room temperature, extracting with phenol/chloroform/isoamyl alcohol, and precipitating with sodium acetate and 10 μg/μL glycogen in isopropanol. The RNA pellet may then be resuspended and treated with 10 units DNase (Gene Hunter) in the presence of RNASE inhibitor (Life Technologies) for 2 hours at 37° C. Following reextraction and precipitation, the pellet may be resuspended in 27 μL of RNASE free water. ANRNA or RT PCR may be performed followed by sequencing. Sequences identified by this technique which are EST's may be used to select a full length cDNA from a cDNA library (CLONTECH). These cDNA's may be enriched in diseased but not normal cells/tissues but their function may be unknown.

Selected cDNA's may be each tagged with hexahistidine (6his) inserted at the carboxy terminal end and glutathione synthetase (GST) at the amino terminal end of the gene each with a protease cleavage site. These genes may be cloned into a Drosophila expression system vector with the bip protein leader, co-transfected with hygromicin vector into Drosophila using CaPO₄. Cells may be maintained in selective media and gene expression may be induced with copper sulfate (Invitrogen). After 48 hours, supernatant containing 5-10 mg/L of each protein may be collected. The resulting proteins may then be purified from the supernatant by Ni(2+)-NTA chromatography, as a first purification step, and glutathione affinity chromatography, as a second step, followed by specific protease removal by cleavage of the tags. Up to milligram quantities of each protein may be recovered.

6.1.2. Binding, Ligand-Target Pair Selection, and Ligand Identification

Diverse chemical, natural product-like and peptide combinatorial libraries containing up to 2 million ligands may be synthesized in a pooled fashion in fluid phase. In addition, natural product libraries (Terragen, Yonsei), and chemical libraries (Arqule, Coelocath) may be purchased. From 1,000 to 10,000 ligands may be mixed together with 1 μg of protein in a volume of up to 100 μL to have a 1 μM concentration in the well of a 96 well plate. After a 30 minute incubation on ice, the samples may be loaded into 96 well plates with cartridges to serve as HPLC columns for each well (Waters 2790 HPLC). The first cartridge/column may be a size exclusion resin (G25 Pharmacia) to hold the unbound molecules in the resin but allow the bound ligand and protein to pass through. A small and narrow column (e.g., 2 mm length×5 mm diameter Rocket Column, Biorad) is used to minimize dilution at this step. The next cartridge/column used is a hydrophobic or hydrophilic reverse phase HPLC resin, the choice of which depends upon the hydrophobicity of the ligand library being used. For example, a hydrophobic C18 silica column may be used with less hydrophobic ligands, while a hydrophilic C8 column may be used for more hydrophilic ligands. Another example is the SB8U column from Agilant which may be used for either hydrophilic or hydrophobic ligands. The reverse phase HPLC may concentrate the small molecules and protein by allowing them to bind onto the resin after which the small molecules may be eluted from the protein and the resin. The eluants containing the small molecules may be collected in a 96 well plate. These eluants may then be transferred to the mass spectrometer (Micromass Quattro LC) and the spectra determined using the MassLynx, MAxENT software (Micromass). In this way theoretically up to 100 ligands per protein may be deconvoluted such that the exact member of the library may be identified except for chirality. Specifically, mass spectroscopy can be used to detect isotopes of compounds or fragmentation patterns any of which can be used as an alternative or in combination with true molecular weight to identify a compound. In addition, IR or FTIR analysis may be performed to identify ligand functional groups or units. Each ligand may then be synthesized or a larger scale. Peptide ligands may be fused with the TAT transducing sequence.

The affinity of the ligands identified will depend in part on the concentration of the library used in the screen, but should range from at least nanomolar to micromolar. The actual affinity of each ligand may be determined by competition studies. These ligands may then be tested in bioassays.

6.1.3. Bioassays

Where the cDNAs are selected based on their differential expression in cancer cells, the ligands may be tested in assays which detect or measure apoptosis, proliferation, necrosis, angiogenesis, inflammation, or metastatic tumor invasion. According to the invention, assays are designed using models which are as close to the human disease as possible (e.g., pathological tissue biopsies, in vitro tissue models, in vitro disease models, human cell lines) and which are based upon cell lines and are easily applied to primary tissue from human pathology samples. These assays may be developed using tissue from mice transgenic for a gene known to be involved in cancer, bcl-2. Human breast cancer cell lines which may be assayed include: MCF-7, NCI/ADR HS578T, MDA-MB-22231/ATCC, MDA-MB-4335, MDA-N, BT-549, T-47D (NCI, ATCC). Other cell lines and tissues may also be used. Non-limiting examples of bioassays are shown in Table 1.

TABLE 1
Bioassays in cell lines, human tissue biopsies, and human
tissue biopsies transplanted into host (e.g., nude mouse).

| | |
|---|---|
| Pathogenic | Bioassay [in breast, colon, lung, and prostate cell lines (e.g., breast cancer, |
| Mechanism | MCF-7, NCI/ADR HS578T, MDA-MB-22231/ATCC, MDA-MB-4335, |
| | MDA-N, BT-549, T-47D |
| Apoptosis | 1.5 hour in vitro incubation with ligand then stain with FITC Annexin V; DAPI |
| | stain nuclear morphology confirmation. |
| Necrosis | 8 hour incubation with ligand (in nude mouse); vital dye stain with propidium |
| | iodide or TOTO-3, confirm with MTT assay. |
| Proliferation | 2 hour incubation with ligand then stain with FITC anti-PCNA; confirm with |
| | BRDU. |
| Angiogenesis | Incubate tumor in nude mouse with ligand, stain with fluorescein factor VIII related |
| | antigen to measure endothelial cell density; confirm in migration of cultured human |
| | dermal microvasculature endothelial cells towards β-FGF. |
| Inflamation | 2 hour incubation with ligand and measure TNF, INF, IL-4, IL-2, IL-10, TGFβ, |
| | VCAM, NκFB via ELISA. |
| Invasion | 30 hour incubation of cells labeled with CSFE dye in matrigel cell invasion |
| | chamber; confirm by study in nude mice. |
| Fibrosis | 48 hour incubation with ligand followed by fibronectin ELISA assay or |
| | immunohistochemistry. |
| Metabolism | 2 hour incubation with insulin and ligand then measure glucose levels; test in 3T3- |
| | L1 adipocyte and L6 monocyte cell lines followed by type II diabetes compared to |
| | normal patient fat biopsies. |
| Development/ | Incubate ligand with either MHC class II-negative cells or single pluripotent |
| Differentiation | ML-IC cells and assess cell fate by cytological and immunologal techniques |
| | according to either Inaba K et al., 1993, PNAS 90: 3038 or Punzel M et al., |
| | 1999, Blood 93: 3750. |

6.1.3.1. Apoptosis

Apoptosis may be assayed using a cell membrane phosphatidyl serine binding dye (FITC Annexin V; alternative dyes such as Cy5.5 may also be used). Selected ligands for each of the proteins identified in the binding assay may be tested for an effect on apoptosis on various cell lines. From 2×10⁵ to 2×10⁸ cells may be plated in each well of a 96 well plate and medium containing 1 μM to 10 μM of each ligand is added to wells in triplicate. Minimally, a negative (no ligands) and a positive (bcl2 reactive ligand) control are also performed. After 1.5 hours, FITC Annexin is added to the wells, incubated with the cells for 15 minutes and, after 3 washing steps, the level of fluorescence is determined using a plate reader.

The assays may be demonstrated to be transferable from cells to tissues by using bcl-2 expressing cells and tissues from bcl-2 transgenic mice (Charles River). Ligands which induce apoptosis may be tested on fresh tumor biopsies from breast cancer patients. One advantage of using primary tissue biopsy is that the assay may be performed within two hours of tissue collection, i.e. before the tissue has begun showing the changes associated with ischemia. Small pieces of tumor biopsy may be plated in wells of a 96 well plate and the same assay as above is repeated with each sample in duplicate. After, the fluorescence is read, the samples may be stained with DAPI staining (Molecular Probes, Eugene Oreg.) and nuclear morphology may be assessed under a fluorescence microscope for nuclear condensation and fragmentation for confirmation. Alternatively, the classic TUNEL (terminal deoxynucleotidyl transferase mediated biotinylated deoxyuridine triphosphate nick end labeling) method to label DNA strand breaks may be used.

6.1.3.2. Proliferation

Cell proliferation may be assayed by exposing cells to a fluorescein labeled anti-PCNA antibody (e.g., PC-10, Santa Cruz Biotechnology) which binds to proliferating cell nuclear antigen (PCNA). Selected ligands for each of the proteins identified in the binding assay may be tested for an effect on proliferation on cell lines. From 2×10⁵ to 2×10⁸ cells may be plated in each well of a 96 well plate. Medium containing 1 μM to 10 μM of each ligand may then be added to wells in triplicate. Minimally, a negative (no ligands) and a positive control are also performed. After 2 hours, FITC anti-PCNA may be added to the wells, incubated with the cells for 15 minutes and, after 3 washing steps, the level of fluorescence may be determined using a plate reader. The PCNA assay has already been used in cells and in tissues (Kulldorff M et. al., 2000, J. Clin Epidemiology 53:875). Ligands which inhibit proliferation may be tested on fresh tumor biopsies from breast cancer patients. Small pieces of tumor biopsy may be plated in wells of a 96 well plate and the same assay as above repeated with each sample in duplicate. After the fluorescence is read, the samples may be assessed under a fluorescence microscope to confirm that the cells whose proliferation indeed is being affected are the cancer cells.

In a second approach cell proliferation is classically measured looking at BRDU or ³H-thymidine uptake. According to a third approach, cells may be labeled with the CSFE dye (5-and-6 carboxyfluorescein diacetate succinimidyl ester). As the cells proliferate over 7 to 8 generations, the dye is diluted. A fourth approach uses a fluorescence-based AttoPhos assay to measure endogenous enzyme acid phosphatase may be used to measure cell numbers. Other methods for detecting cells undergoing proliferation may be used, including 7-ADD (7-amino-actinomycin-D) which is used to determine the stage of proliferation or by staining with the Ki67 antibody.

6.1.3.3. Necrosis

Techniques to detect necrosis include but are not limited to the classic techniques of DNA binding dyes such as propidium iodide or TOTO-3. Alternatively, a colorimetric methylthiazole tetrazolium (MTT) assay for the mitochondrial enzyme release can also be used to determine cell viability. In a preferred embodiment of the invention, cell viability is determined using the DNA binding dyes propidium iodide and TOTO-3. Conducting these assays in cell lines may enable one to distinguish between necrosis and apoptosis which will facilitate distinguishing ligands have specific effects from ligands which are broadly cytotoxic. This distinction may also be facilitated by performing necrosis and apoptosis assays in parallel. Selected ligands for each of the targets identified in the binding assay may be tested for an effect on necrosis of the cell lines. From 2×10⁵ to 2×10⁸ cells may be plated in each well of a 96 well plate and medium containing 1 μM to 10 μM of each ligand is added to wells in triplicate. Minimally, a negative (no ligands) and a positive control are also performed. After 8 hours, propidium iodide or TOTO 3 is added to the wells, incubated with the cells for 15 minutes and after 3 washing steps, the level of fluorescence is determined using a fluorescent plate reader.

Necrosis may be a difficult assay to transfer to tissue biopsies because it is generally assayed after at least 8 hours and there is a lot of necrosis due to ischemia in tissue biopsies after such an interval providing a high background. To overcome this problem, human biopsy tissue may be transplanted into nude mice, thereby preventing ischemia induced necrosis during the 8 hour assay period. To insure that growth in the nude mouse does not alter the tumor, a tumor, grown in a nude mouse for 1 month, may be explanted and tested in the short term apoptosis and proliferation as outlined above. The tumor may also be viewed histologically and compared with the fresh tumor explant to assess differences. The ligands which bind to the same target and induce necrosis in 50% of the cases may be injected into the tumor in the animal, collected after 8 hours, and stained with propidium iodide. Histological examination may reveal that the tumor cells are undergoing necrosis while the other cells in the biopsy are not.

6.1.3.4. Angiogenesis

The in vitro assay used to test for a pro or anti-angiogenic effect assays the migration of cultured human dermal microvascular endothelial cells towards β-FGF or bovine serum albumin (negative control) with increasing concentrations of angiostatin as an inhibitory control and increasing concentrations of the ligands in different wells (Clonetics, San Diego; Polyerini P J et. al., 1991, Methods in Enzymology 198: 440). Angiogenesis is also a longer term event so modeling in human biopsies will absolutely require growth in nude mice. Should ligands with an anti-angiogeneic activity be discovered in the future, they may be assayed by daily injection into the tumor for 3 to 5 days and subsequent removal and staining with Fluorescent anti-Factor VIII related antigen to measure endothelial cell density.

Other models for angiogenesis are contemplated by the invention. In vivo models include implantation of hydron pellets with the test molecules on them implanted into the avascular rat cornea (cornea micropocket assay). Growth of vessels from the limbus to towards the pellet at 7 days is scored as a positive response which can be negated by the removal of the angiogenic or anti-angiogeneic protein by antibody on protein A beads (Poverini P J et. al., 1991, Methods in Enzymology 198: 440). These vessels can be characterized as to the density, length and luminal sizes of the vessels. A similar assay can also be performed in the mouse eye (L Smith, Children's Hospital, Boston). Angiogenic molecules can also be tested in vivo in the rabbit model of hindlimb ischemia (Shyu K G et. al., 1998 Circulation 98:2081). Other in vitro tissue modeling systems include endothelial cells in 3 dimensional culture where they form tubular structures that resemble immature capillaries (Springhorn et. al., 1995, In vitro Cell Dev Biol Anim 31, 473; Sierra-Honigmann M R et. al., 1998, Science 281:1683). Smooth muscle cell recruitment can be measured using anti-smooth muscle actin immunohistochemistry.

6.1.3.5. Invasion

Tumor invasion may be assayed using the a basement membrane cell invasion chamber which is a chamber coated with Matrigel extracellular matrix. The matrix coats the wells used to separate one chamber from the other in 24 well plates (Becton Dickinson Labware). Selected ligands for each of the proteins identified in the binding assay may be tested for an effect on invasion on the cell lines. Cells labeled with CSFE dye can be measured by FACS or used to follow cell fate in vivo. Alternatively, cells may be labeled with ³H-thymidine or another marker. About 2×10⁵ labeled cells may be plated in each well and medium containing 1 μM or 10 μM of each ligand is added to the top half of the wells in triplicate. After 30 hours in a CO₂ incubator, the membrane chambers may be rinsed 3 times on both sides with DMEM/0.1% BSA and the top surface is scrubbed with a cotton swab. The amount of dye present in the bottom well may be determined using a fluorescent plate reader. In positive wells, the membrane can be cut out and the number of cells on the bottom can be counted. Ligands affecting tumor invasion in this in vitro assay may be further tested in vivo by histological analysis of human tumor biopsies in nude mice.

6.1.3.6. Development and/or Differentiation

Various assays to test the effect of a ligand on the development and/or differentiation of cells, tissues, organs and organisms are contemplated. Non-limiting examples include incubating a ligand with either major histocompatibility complex (MHC) class II-negative cells or single pluripotent myeloid-lymphoid initiating cells (ML-IC) and assessing cell fate by cytological and immunologal techniques according to either Inaba K et al., 1993, PNAS 90:3038 or Punzel M et al., 1999, Blood 93:3750.

### 6.2. Example 2

### Diabetes

Peripheral insulin resistance is the major pathogenic mechanism which causes type II diabetes, the fourth leading cause of death by disease and is the leading cause of blindness, renal failure and amputation. Insulin stimulates glucose uptake in muscle and fat cells, glycogen synthesis in liver and muscle cells and fat synthesis in fat and liver cells and the inhibition of glucose production in liver cells. NIDDM is characterized by impaired insulin-stimulated glucose uptake into skeletal muscle and adipocytes, impaired inhibition of liver gluconeogenesis and potentially misregulated insulin secretion. The pathway is only partially understood and the molecules responsible for peripheral insulin resistance are not known making it amenable to the methods of the instant invention.

Insulin binds to the α subunit of its dimeric receptor inducing the receptor's cytosolic β subunit tyrosine kinase activity to phosphorylate itself and nearby proteins. Insulin triggers activation of DNA and protein synthesis, activation of anabolic metabolic pathways and inhibition of catabolic metabolic pathways. A series of proteins IRS-1, IRS-2, IRS-3, IRS-4, Gab-1 and p62 dok proteins all can bind the phosphorylated insulin receptor and can be substrates for it. IRS-1 appears to be most involved with the receptor but all of these are activators of phosphatidylinositol 3 kinase, which causes the transport of the striated muscle/adipose tissue specific glucose transporter GLUT 4 from the golgi in the cytoplasm to the plasma membrane where it transports glucose which is then phosphorylated by hexokinase. (Glut 2 is present on liver and β cells of pancreas). Insulin also up regulates glycogen synthase which catalyzes the final step of the conversion of glucose into glycogen but it is believed that the defect occurs in the first half of this signaling pathway.

The liver and the muscle account for most of the glucose metabolized and hence cells from these organs will be used in these studies. Diabetic patient muscle biopsies may be challenged with insulin and/or gliclazides as may be muscle biopsies from healthy individuals. The individuals may be relatives of the patients, some of whom have no overt symptoms of diabetes and a completely normal response to insulin. Defects in insulin action precede overt disease and are seen in nondiabetic relatives of diabetic patients. Differential display cDNA libraries may be prepared from diabetic patients and healthy individuals. A second differential display cDNA libraries may be prepared from patient biopsies challenged with insulin and/or gliclazides and biopsies from healthy patients. These cDNA libraries may then be expressed as proteins. Ligands which bind the expressed proteins may be isolated using the methods described in the invention (e.g., HPLC/mass spectroscopy).

The ligands may be assayed for the effect on glucose uptake following insulin stimulation. 3T3-L1 adipocyte and L6 myocyte cell lines (ATCC) may be used as cell models for glucose metabolism. From 2×10⁸ to 1×10¹⁰ cells may be plated in each well of a 96 well plate and medium containing a known concentration of glucose and 1 μM to 10 μM of each ligand is added to wells in triplicate. Minimally, a negative (no insulin, no ligands) and a positive (insulin, no ligands) control are performed. Insulin is next added to the wells at a low and a high concentration. After 2 hours incubation in a CO₂ incubator, glucose levels may be determined using a glucose meter. The ligands which affected glucose metabolism following insulin stimulation in the cell lines may then be tested using the same assay with fresh skeletal muscle and adipose tissue biopsy from Type II diabetic patients. Cells suspended from the tissue biopsy may be plated at the same density in wells of a 96 well plate and the same assay as above repeated with each sample in duplicate. If the ligands decreased peripheral insulin resistance in these tissue biopsies, the ligand gene combination may represent a validated target in the treatment of peripheral insulin resistance which may be tested further and mapped in the metabolic signaling pathway of insulin.

6.3. Identification of Targets in Molecular Pathways of Known Genes

The approach used above may be used to identify and determine the function of unknown genes within the signaling pathways of pluripotent secreted proteins and to isolate the therapeutic effect from the toxic effect in a tissue specific way. TGFβ1 is a well known potent growth inhibitor in many cell types and the type II TGFβ receptor, Smad 2 or Smad 4 are known to be mutated in a number of cancers (Kim S J, 2000, Cytokine Growth Factor Rev. 11: 159). Some tumor suppressor genes (DPC4) are members of this SMAD family and are potent down regulators of T cell immune responses (Prud'homme G J, 2000, J. Autoimmun. 14:23). Modulation of this growth inhibition and apoptosis induction pathway may be used to develop novel therapies to inhibit cancer cell growth, induce tolerance of T cells in autoimmunity and break tolerance to cancer antigens by blockade of this TGFβ pathway.

One of the limiting factors has been that TGFβ1 also induces deposit of the extracellular matrix including up regulation of fibronectin, collagen, plaminogen activator inhibitor-1 and tissue inhibitors of matrix metalloproteases while down regulating matrix degrading proteases such as interstitial collagenase. Massague, 1990, J Ann Rev Biochem 6:597. Overproduction of matrix components is the major finding in tissue fibrosis an important cause of end stage renal and other diseases (Blobe G C, 2000, NEJM 342:1350). Decreased fibronectin production is often observed in cancer causing decreased cellular adhesion and increased metastasis (Kornblihtt et al., 1996, FASEB J 10:248). TGFβ induces these effects on ECM through a Smad independent pathway in which c-jun N-terminal kinase (JNK; a member of the MAP kinase family) activated to modulate cJUN (member of the AP-1 family of transcription factors) and ATF-2 (another transcription factor) (Hocevar et al., 1999, EMBO J. 18:1345). The pluripotent effects of TGFβ may be dissected out by targeting jun and smad pathways separately.

To this end, primary human T cells and fibroblasts may be split into two and half of the cells may be transfected with a retroviral vector containing antisense jun or SMAD. Alternatively this may be achieved with a different vector or the cells may be transduced with a peptide reactive with either smad or jun. The resulting cell lines may then be stimulated with TGFβ and cDNA's may be cloned which may be differentially expressed between stimulated and unstimulated cells and then cells with either pathway blocked using microarray analysis or other techniques of differential expression. Once cDNAs have been identified the expression of which is only associated with one of the pathways (but the function of which is unknown), these cDNAs can then be expressed as proteins, ligands binding to them can be isolated using the biochemical binding assay and resolution by HPLC and mass spectroscopy. The ligands can then be tested for the ability to block or induce either proliferation (in a PCNA based assay as described above) or secretion of the extracellular matrix. The extracellular matrix assay would measure fibronectin deposition, a major component of the extracellular matrix over a 48 hour period in a 96 well plate using an ELISA assay for fibronectin. In this way, genes can be identified and targets can be validated which are associated with the antiproliferative effect of the protein but not the profibrotic effect and visa versa. A similar approach may be used to look at any stimulus to a cells or tissue to identify new members of the molecular pathway and validate them as drug targets.

7.1. Phenotype to Genotype

7.1.1. Phenotype Detection

Tumor cell apoptosis and proliferation assays described in Sections 6.1.3.1 and 6.1.3.2. may be adapted to high throughput screening using, for example, a 384 well plate format (Applied Biosystems FMAT 8100). Apoptosis and necrosis may be assayed simultaneously. For apoptosis and necrosis the Cy5.5 Annexin V assay and TOTO 3 reagents respectively may be used (Applied Biosystems). Cy5.5 labeled anti-PCNA antibody (PC-10, Santa Cruz Biotechnology) may be used to assay cell proliferation. Non-limiting examples of human breast cancer cell lines which may be assayed include: MCF-7, NCI/ADR HS578T, MDA-MB-22231/ATCC, MDA-MB-4335, MDA-N, BT-549, T-47D (NCI, ATCC). Non-limiting examples of human prostate cancer cell lines which may be assayed include: DU-145, PC-3, LNCaP. Non-limiting examples of human colon cancer cell lines which may be assayed include: COLO 205, HCC-2998, HCT-15, HCT-116, HT29, KM12, SW-620. Non-limiting examples of human lung cancer cell lines which may be assayed include: A549/ATCC, EKVX, HOP-62, HOP-92, NCI-H23, NCI-H226, NCI-H322M, NCI-H460, NCI-H522. From 1×10⁵ to 1×10⁸ cells may be plated in each well of a 384 well plate. Medium containing 1 pM to 1 M and preferably 1 μM to 10 μM of each potential ligand in a ligand library (non-limiting examples of which are listed in section 5.1.2 above) is added to wells are tested in triplicate. Negative (no ligands) and positive (staurosporine) controls are included. The ligands having the phenotypic effect at a concentration of ≦20 μM and are good candidates for target identification according to the invention.

7.1.2. Target Identification

An important advantage of the invention is that, unlike the prior art, the target of a ligand which is found to have an affect in one or more bioassays, may be identified using the ligand. There are a number of approaches which may be used to identify the target according to the invention.

In a first series of embodiments, a potential target is a protein displayed on the surface of a cell. According to one non-limiting example, a full-length human cDNA library is expressed in the pDisplay vector (Invitrogen). This vector targets the protein to and anchors it in the cell membrane on the surface of eukaryotic cells. In another non-limiting embodiment of the invention, a full-length human cDNA library is expressed in the pYD1 yeast display vector or similar vector transfected into the EBY100 Saccharomyces cerevisiae strain (Invitrogen). In still another non-limiting embodiment of the invention, a full-length human cDNA library is expressed on the surface of insect cells using baculovirus vector (Ernst W et. al. 1998, Nucleic Acids Research 26:1718). These systems allow full-length proteins to be expressed on the surface as opposed to prokaryotic systems which only allow peptides to be expressed.

In alternative embodiments, a polynucleotide library can be expressed as a peptide alone or a fusion on the surface of a cell or a virus (e.g., bacteriophage, T7, or M13). Non-limiting examples include a polynucleotide library generated from human or infectious agent. In a specific embodiment of the invention, a cDNA library is expressed as dodecapeptides in the pFliTrx vector (Invitrogen) or similar. According to this embodiment when the vector is expressed in E. coli, the peptide is displayed in the active site loop of the thioredoxin protein and inside the bacterial flagellin gene. In another embodiment of the invention, potential targets may be displayed as peptides on a ribosome display system in which the peptide is fused to the RNA encoding it by treatment with puromycin (Roberts R W et al., 1977, PNAS 94:12297). All other display systems (including but not limited to retrovirus, adenovirus) may be used in accordance with the invention to display cDNAs or peptides.

7.1.3. Separation

Potential targets displayed by any of the above methods may be exposed to the ligand. The ligand may be either immobilized on a surface, bead or column or it may be in solution depending on the separation method to be used. In a first embodiment of the invention, the ligands may be directly immobilized on the surface, directly labeled or detected. In a second embodiment of the invention, the ligands may be derivatized with an affinity label to facilitate collection of the ligand-target pair where the target is displayed as illustrated in the foregoing examples. Non-limiting examples of such affinity labels include biotin, digoxygenin, or an antibody. Displayed targets which bind the ligand may then be separated from those which do not bind and the sequence encoding the target is identified by standard cloning and DNA sequencing techniques.

In a first embodiment of the invention, cells can be “stained” with fluorescently labeled or biotinylated ligand (the latter combined with FITC avidin) and sorted using a flow cytometer (MoFlo HTS Cytometer, Becton Dickinson FACS) into wells of a plate, a tube, etc. The cells may then be grown using standard cell culture techniques. According to a first non-limiting example, the gene encoding the drug's receptor may then be cloned by plasmid recovery from COS 1 cells by using the effect of the large T antigen effect on the SV40 origin of replication. According to a second non-limiting example, PCR may be used to recover the plasmid insert.

In a second embodiment of the invention, cells, viral particles or peptide-nucleotide fusions may be selected using drug coated magnetic beads, a drug coated surface (e.g., a well for panning) or a drug coated column. A high density of drug ligands on the surface, beads or column is desirable to increase the avidity of low affinity interactions. The drug may be attached to the surface, beads or column via an affinity label (e.g., avidin, digoxygenin) and elution may be achieved after one or more washing steps. In the case of magnetic beads, magnets may then be used to isolate beads during the wash to recover bound cells, viral particles or peptide-nucleotide fusions. In the case of panning, the supernatant is poured off after each successive washing step with the cells, viral particles or peptide-nucleotide fusions retained in the wells. Elution from a column may be achieved by standard techniques. In the case where the ligands were derivatized with an affinity label, cells, viral particles or peptide-nucleotide fusions may be eluted from the column by applying excess free affinity label to the column.

Once separated, target expressing cells or viral particles can be grown as appropriate. Then the cDNA encoding the target may be recovered by standard molecular biology techniques (e.g., plasmid recovery or PCR). In the case of purified peptide-nucleotide complexes, the partial cDNA sequence would be identified using RT PCR. Using the above approach the target can be purified and cloned using one or more rounds of selection. In this way, the DNA sequence encoding a previously unknown drug target can be isolated and used to clone the cDNA encoding the drug target.

Once the cDNA encoding the drug target has been identified, the cDNA can be used to study differential expression in cells from disease tissues as in section 6.1. If the target is differentially expressed between disease and normal cells, specificity is established and the ligands interacting with that target may be tested in vitro and in vivo bioassays for that disease.

Thus the target associated with a function in the phenotypic assay is identified employing the invention.

7.2. Target Identification by Proteomics

Target identification may also be achieved by adapting the method set forth in section 6.1.2. to combine the ligand of interest with one a plurality of potential targets, collecting ligand-target pairs, and optionally dissociating the ligand and target. Subsequently, the target may be identified. In one embodiment of the invention, the target is a protein which may be identified by common techniques (e.g., amino acid sequencing, mass spectroscopy and/or NMR). Once the protein has been identified, its association with diseased cells may be determined using standard proteomics techniques.

8.1. Mapping Signaling Pathways

Once a number of genes have been shown to be involved in a particular molecular pathway of disease pathogenesis, a targeted component can be mapped within the molecular pathway relative to other molecular pathway components. Ligands which bind to different molecular pathway components may be derivatized with photoactivatable crosslinkers. At least one of the known molecular pathway components is fused with a marker such as GFP. Then the following may be combined in vivo or in vitro: (i) a derivatized ligand which binds the known molecular pathway component, (ii) the marked pathway component, e.g., GFP fusion protein, (iii) at least one derivatized ligand which binds or may bind another molecular pathway component, and (iv) other molecular pathway components. The crosslinking stimulus is applied and each component of the resulting complex is identified. In this way each molecular pathway components may be mapped relative to other components with which it interacts. A further advantage of the invention is that pathway effectors may be identified by this method. In addition, the profile of each pathway component may be compared with known drugs acting via that pathway, if any, and comparative studies can be done in cell based assays of different diseases caused by that pathogenic pathway. This information can be used to validate and select the best target for a given disease indication. As an alternative, this information may be used to select the best therapies for a particular patient using pharmacogenetics.

9.1. Lead Optimization

Because a large number of chemical leads may be characterized at the biochemical and phenotypic levels, a structure activity relationship (SAR) may be established to serve as a basis for lead optimization. If a few molecules with similar activities are identified, the SAR can be determined by comparing their structures with activity in the assays. The target directed synthesis technology can be employed to crosslink or react molecules binding close to each other indicating if their activity is mediated through the same active subsite on the protein or through different subsites on the protein target. In this way additional different functional subsites on the target can be mapped and different mechanisms can be interpreted from the phenotypic findings with molecules binding to those subsites (e.g., agonist vs. antagonist).

The second use of target directed synthesis is to increase the affinity of a ligand for its target and thus make the ligand more useful to link phenotype to genotype as well as making a better drug lead. Photoactivatable crosslinkers on one of the functional groups of the ligand scaffold may be used to link ligands bound to the target thus using the target molecule as a template. This linking should increase the affinity of binding to the target by at least 2- to 10-fold and further enhance the structural diversity of the library in a target directed and biologically relevant way.

### 10. IN SILICA APPROACH TO LINKING PHENOTYPE WITH GENOTYPE

The instant invention provides a method to establish a chemical fingerprint of ligand-target (genotype) and ligand-bioassay (phenotype) for each ligand or set of ligands which can be matched in silica to associate phenotype with genotype.

The present invention provides a first information retrieval system wherein ligand-target pairing experimental data will be stored. The present invention provides a second information retrieval system wherein the effects of each ligand in each bioassay tested will be stored. The present invention provides a third information retrieval system wherein the function and/or the expression pattern of each target, if known, will be stored. These systems may be optionally integrated to facilitate use.

In one embodiment of the invention, data entered into the systems may be obtained by a shotgun approach wherein all targets are tested for binding to ligands or all ligands are tested in each bioassay. For example, the set of targets may encompass up to all expression products of up to and including all genes in the genome of a selected organism. Each target is then used to screen a library of ligands to identify ligands which bind. This data is entered into the first information retrieval system.

According to another example, the effect of each member of a large combinatorial chemical library of ligands may be assayed in each available bioassay. This data is entered into the second information retrieval system.

In another embodiment of the invention, data entered into the system is obtained by a focused analysis of ligands which bind selected targets in a specific disease or the phenotype induced by selected ligands in selected bioassays. This data is entered into the first or second information retrieval system as appropriate.

These systems may then be used to guide the user in predicting target function even in the absence of differential expression data or a particular disease focus. In addition, these systems may guide the user in selecting ligands and targets with specific effects. A further advantage is that this system may reduce the number of binding experiments and bioassays necessary. Other advantages will be apparent to one skilled in the art.

In one embodiment of the invention, a user selects a target of interest. Next, the user identifies ligand(s) which bind the target of interest either experimentally or from the first information retrieval system. The user then queries the second information retrieval system with the identified ligand(s) to determine the phenotype(s) associated with each ligand. In this way, a target may be associated with one or more phenotypes.

In another embodiment of the invention, a user selects a phenotype of interest. Next, the user identifies ligand(s) which modulate the selected phenotype either experimentally or from the second information retrieval system. The user then queries the first information retrieval system with the identified ligand(s) to identify target(s) to which the ligand(s) binds. In this way, a phenotype may be associated with one or more targets.

In another embodiment of the invention, these information retrieval systems may be combined with target functional information and/or expression analysis data to guide the user in validating targets and drug leads. In a first example of this embodiment, a user may choose targets X and Y which are proteins. The user obtains expression data which indicates that the gene encoding X is expressed in normal cells but is not expressed in tumor cells. The user obtains further expression data which indicates that the gene encoding Y is not expressed in normal cells but is expressed in tumor cells. The user then queries the first information retrieval system. The results of this query are shown in Table 2.

TABLE 2

| | Ligands that |
|---|---|
| Target | Bind |
| X | 1 |
| X | 2 |
| X | 3 |
| Y | 2 |
| Y | 3 |
| Y | 4 |

The user then queries the second information retrieval system. The results of this query are shown in Table 3.

TABLE 3

| Ligands | Phenotype |
|---|---|
| 1, 2, 3 | Angiogenesis |
| 2, 3, 4 | Proliferation |

According to this example, the user may select target Y as a valid target for cancer therapy and may select ligand 4 for its ability to specifically bind Y and not X. Thus, the invention is able to guide the user in validating targets and identifying drug leads.

In a second example of this embodiment, the phenotype to genotype approach has been used to determine that ligands 1, 2, and 3 induce apoptosis in a bioassay; ligands 3, 4, and 5 stimulate angiogenesis; and ligands 1, 3, and 6 induce necrosis. This information is stored in an information retrieval system. In a high throughput binding assay, it is discovered that ligands 3 and 4 bind to target X with K_{d}<50 μM. A search of the information retrieval system will indicate to one skilled in the art that (i) target X may be involved in angiogenesis, (ii) ligand 3 is a poor candidate for a drug lead, and (iii) ligand 4 may be a good candidate for a drug lead.

### 11. AUTOMATION OF THE METHODS OF THE INVENTION

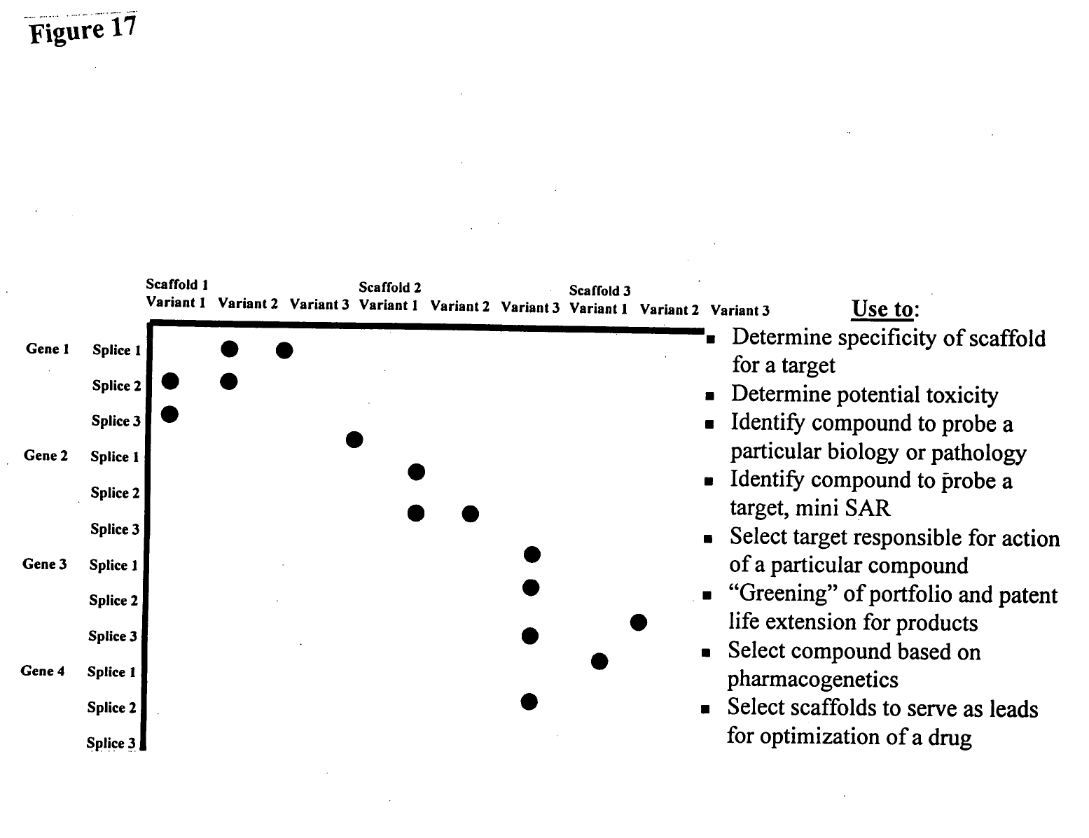

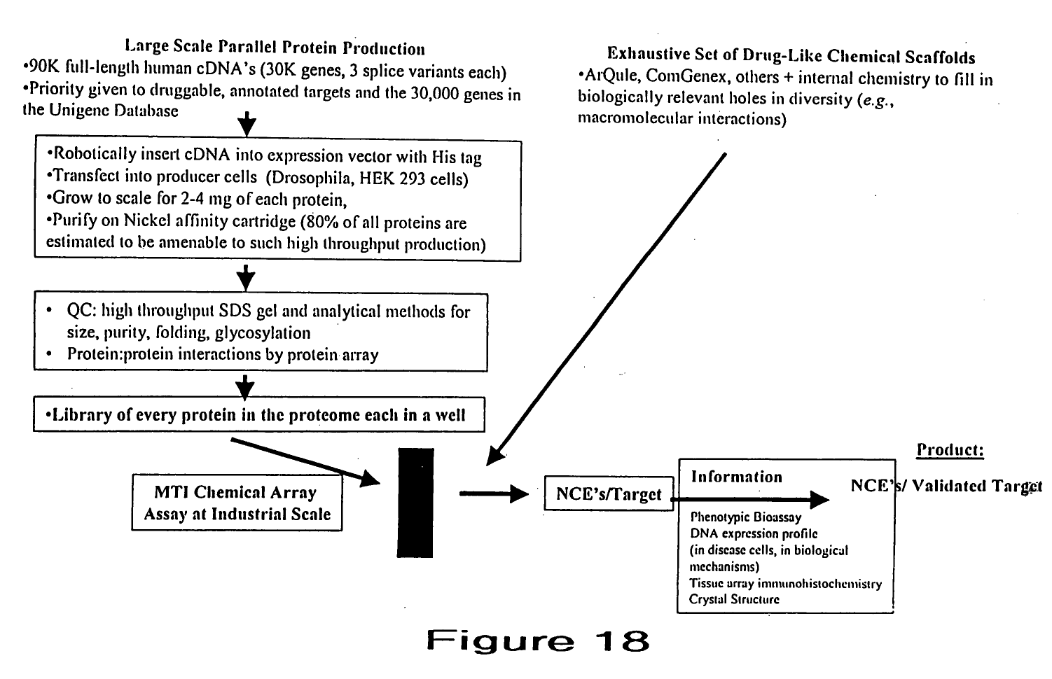

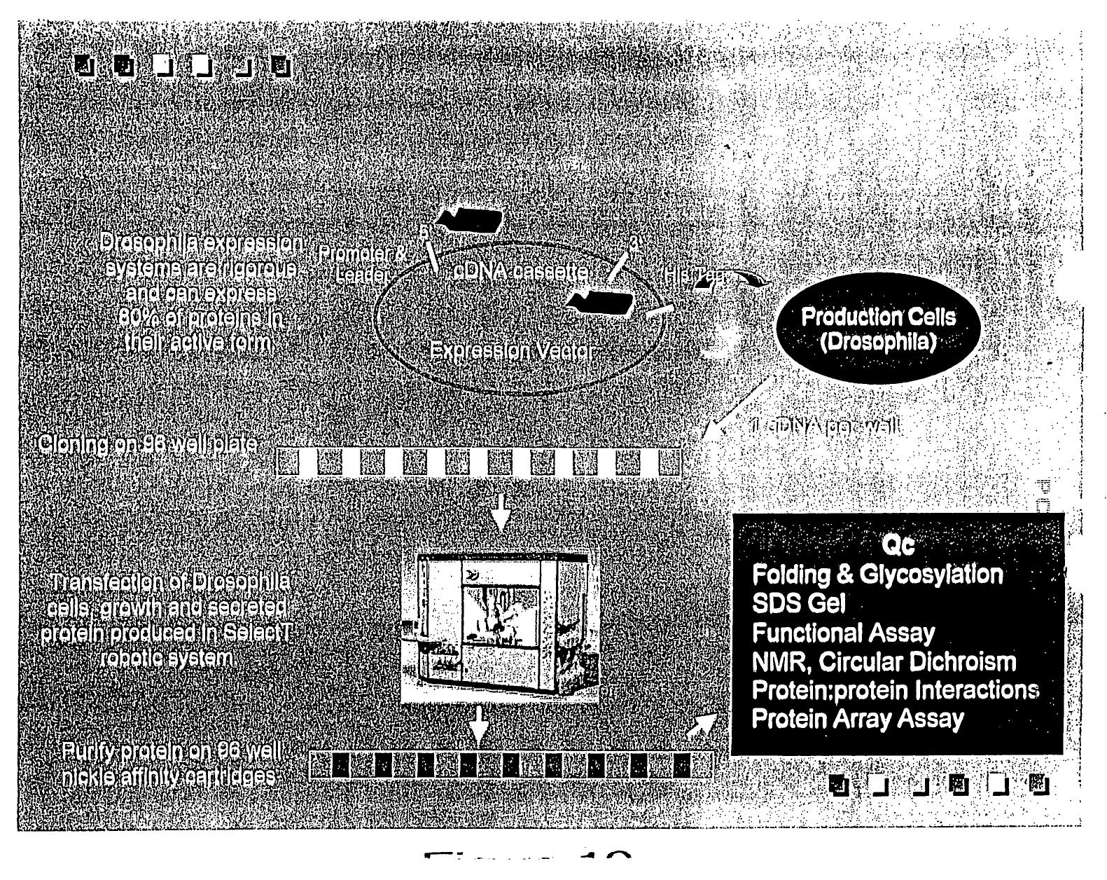

A highly automated approach such as those shown diagramatically in FIGS. 18 and 19 is another embodiment of the present invention. This includes high throughput expression vector construction, protein production, and purification facility capable of producing >20 proteins a week in sufficient amounts to determine ligands from a compound library. This is followed by the use of a high throughput assay such as the Chemical Array Assay to identify scaffold target pairs. These scaffold target pairs comprise the chemical array database which has the uses outlined in FIG. 17.

For high throughput expression vector construction, a cDNA encoding one of the proteins in the human proteome from, for example, NCBI, Stratagene, or Incyte is inserted into a DES expression vector (Invitrogen) using an automated fluid handling system (Tecan) in a 96 well format. The DES expression vector adds a secretion signal and a his-tag to the encoded protein so that it is secreted into the media and can be purified using a nickel column that binds the his-tag.

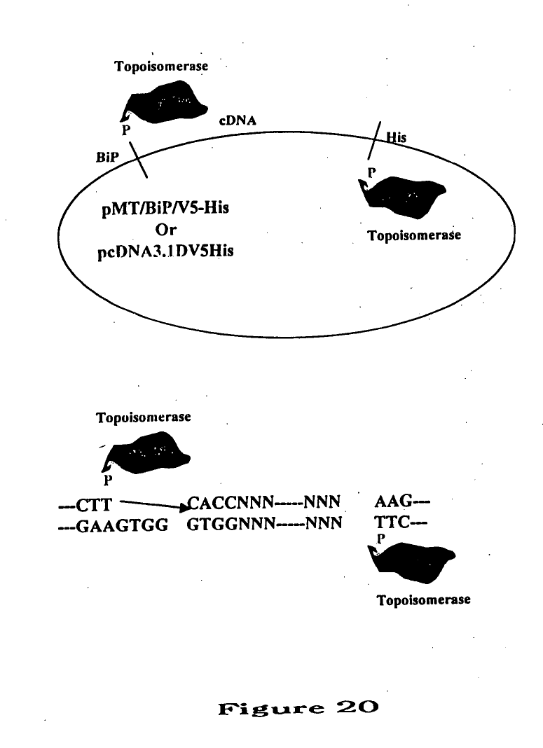

In an exemplary method, the sequence of a cDNA of interest is verified by DNA sequencing, and the 5′ end of the cDNA is PCR tagged with a 4-mer. The cDNA is Topoisomerase (TOPO) cloned into pMT/BiPN5-His A, B, or C (Invitrogen) depending on reading frame for expression in insect cells or into pcDNA3.1DV5His TOPO (Invitrogen) for expression in 293 cells using standard methods (FIG. 20). To assure that the resulting protein will be secreted from the 293 cells, the cDNA may be analyzed by sequence homology to determine if a secretory leader is present and a transmembrane domain is not present. A secretory leader (e.g., Ig K chain leader or CD59 leader) may be added to the 5′ end of the cDNA, and the transmembrane domain may be deleted from the cDNA using standard molecular biology techniques. This method is particularly useful if there is a single transmembrane domain. If there are multiple transmembrane domains or one wants to use a form of the protein which can be integrated into micelles or a membrane, one can produce the protein as a membrane protein (Section 11.1).

The vectors are then transfected into competent E. coli cells, and the cells (e.g., 2 colonies per vector) are propagated (e.g., in an overnight culture). The expression vector can be extracted from the E. coli cells using a robotic fluid handler to add a standard lysis reagent to lyse the cells and to apply the lysate to Qiagen columns to purify the expression vector. In a particular embodiment, the lysate is purified using the QIAwell 96 Ultra Plasmid Kit which uses a Qiafilter 96 well plate for lysate clearing, QIAwell 96 well plates for purification of the plasmid DNA, and QIAprep 96 well plates for desalting each plate sequentially on the QIAvac 96 automated vacuum device. If desired, cells containing the expression vector with the cDNA insert in the proper reading frame are selected using standard methods. For example, the expression vector can be restriction enzyme digested or sequenced to determine whether it contains the cDNA insert in-frame.

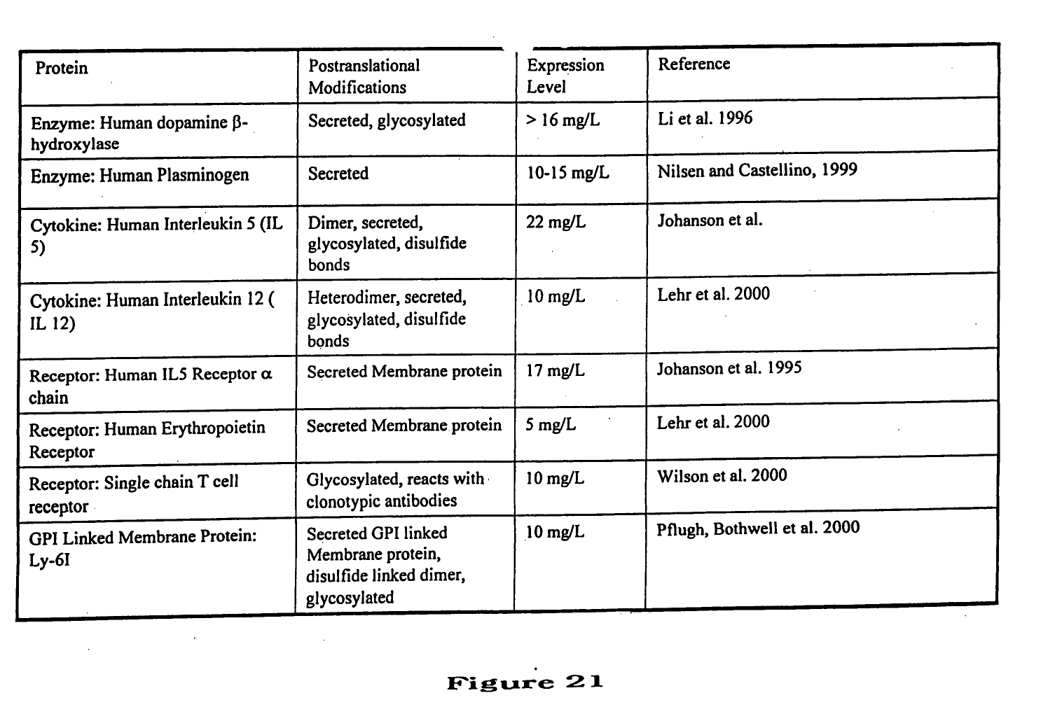

The expression vector containing the insert is then transfected with Cellfectin into Drosophila S2 cells (Invitrogen) using standard calcium phosphate transfection methods and grown in Drosophila expression media (Invitrogen) in 5-12 flasks per vector in the SelecT automated tissue culture system (Automation Partnership) (FIG. 21). Each SelecT system can handle up to 150 flasks or up to 40 separate cell lines expressing different proteins, and using multiple SelecT's in parallel can increase throughput to 600 proteins per week. In one possible method, copper sulfate is added to the medium after 24 hours to induce protein expression and on day 3 and 7 the supernatant is collected for protein purification. In other methods, transient expression is induced on day 3, and the supernatant is harvested on days 4 and 6. Using 20 Select T robots that each handles 150 T175 flasks with 150 mL media and Drosophila cells that express approximately 10 mg/L, every two flasks may produce 2 to 4 mg of protein with one harvest. To increase the amount of protein, the supernatant can be harvested additional times, such as 1, 2, 3, or more addition times. If five flask are used per protein, each Select T system produces 30 proteins. Thus 2 to 4 mg of protein can be produced for 600 proteins (i.e., 30 proteins for each of the 20 Select T robots) per week.

The supernatant is passed through the nickel column in 96 well format (Qiagen QIAexpress protein purification system or Qiagen nickel affinity magnetic plates) on a Biorobot (Qiagen). A Tecan fluid handler then transfers an aliquot of this protein to PHAST gel (Pharmacia) for SDS analysis, bioassays, or other quality control analysis (Qc). The rest of the sample is transferred by the reagent storage retrieval system (Haystack) to the Chemical Array Assay (e.g., in any of the assay methods described herein) and to the freezer for storage. For example, a robotic fluid handler (Tecan) can be used to combine the purified protein target with a library of candidate ligands to allow one or more of the candidate ligands to bind the target protein in the wells of a 96 well plate. This 96 well plate can than be transferred to an HPLC (Waters 2790) which can inject the assay mixture containing the target protein and candidate ligands from 96 well plates and run up to 6 columns in parallel for the isolation of the target protein with bound ligands. The fraction containing the target with bound ligand can be collected using a fraction collector (Gilson). In an alternative embodiment, a robotic fluid handler (Tecan) is used to combine the purified protein target with a library of candidate ligands to allow one or more of the candidate ligands to bind the target protein in the wells of a 96 well plate. This 96 well plate contains, for example, cartridges with a resin capable of separating target proteins from unbound ligands to isolate the target protein with bound ligands into a second 96 well plate upon evacuation by a robot (Tecan or Qiagen). In an alternative embodiment, the binding occurs in a 96 well plate, and then a fluid handler (Tecan) transfers the sample to a second 96 well plate including the cartridges for separation. In still another embodiment, the cartridges are spin columns which are available in multiwell formats (Pharmacia). Chip based and capillary LC based separations can also be used. A detergent or other denaturant can be added by the fluid handler (Tecan) to release the bound ligands from the protein, and then the released ligands are added to an appropriate instrument for analysis. For example, the ligands can be injected into a mass spectrometer using a reverse phase column on an HPLC containing an autoinjector (Waters), spotted on a filter for MADLITOF mass spectrometry analysis, or applied to an NMR, IR, FTIR, or UV spectrometer. In an alternative embodiment, the target protein with bound ligands is loaded or spotted onto the 96 well format MALDITOF (Bruker Daltonics) using a fluid handler (Tecan). In another alternative embodiment, the target protein with bound ligands is evacuated onto a filter (for example, nitrocellulose) in a 96 well format by evacuation with a robot (Tecan). In another embodiment, the evacuation onto this same filter is performed in the same step as the as the evacuation of the 96 well cartridges by placing the filter between the cartridges and the vacuum device. The MALDITOF then dissociates the target protein and ligands from each of the 96 spots and generates a mass spectrum for the compound and/or complex. After data processing by the information systems described herein, the identity of the ligand and its target are entered into the Chemical Array Database. Any of these methods can be performed in 384, 1536 well, chip based, or other formats. Similarly, any of the data can be entered and managed using a laboratory information management system (LIMS) based on IDBS Activity Base or Price Waterhouse, or other LIMS software/systems.

Similar methods can be applied for other transient expression based production systems including, but not limited to, HEK293 cells, CHO, or COS cells. Alternatively, other automated or semi-automated production systems can be used, such as roller bottle systems, Stir tank systems (e.g., Celligen Plus from New Brunswick), or capillary cell culture systems (Amicon). In another embodiment, a semiautomated process, such as a 1 L or larger bioreactor from New Brunswick, is used to grow cells such as HEK293 cells (Life Technologies) transiently transfected with expression constructs constructed as described above based upon the pCDNA family of vectors (Invitrogen). Transiently transfected CHO cells can also be used. The transfection in these cell types can be efficiently achieved using Lipofectamine 2000 (Life Technologies). In alternative embodiments, other transfection strategies are used (for example, electroporation, Calcium Phosphate, Lipofectin, Lipofectamine Plus (Life Technologies), or other standard techniques). These cells are grown in DMEM or in other standard mediums with serum or in serum free forms using standard methods. In addition, alternative expression vectors, such as those appropriate for the various cell lines mentioned as indicated in the catalogue of Invitrogen, other vector companies, the scientific literature, or those which would be apparent to those skilled in the art.

In an exemplary method for the semi-automated transfection, protein production, and purification of 600 proteins per week (2 to 4 mg each), CHO cells or HEK 293 cells are used. In particular, CHO cells (e.g., CHO-F line stably transfected with T antigen) or 293 cells are grown in suspension culture to a volume of 1.4 L in a 2.2 L bioreactor (New Brunswick) or bag (Wave System) or a large vessel (e.g., 5.5 L or 10.5 L vessels). The cells are allowed to settle or are pelleted by centrifugation. Alternatively, the HEK 293 or CHO cells are grown as confluent cells (e.g., grown using Semi automated Cell Mate) and Lipofectamine 2000 is used as the transfection agent. The media is temporarily removed, and the cells are transfected with the expression construct and D MRIE-C reagent in a 60 mL volume using standard methods, such as Invitrogen's protocol. The media is added back to the bioreactor or bag, and the cells are cultured. After two to three days, the supernatant is harvested. The protein is analyzed and purified as described above for the protein production methods using Drosophila cells. For large scale protein production, 150 BioFlow 110 Bioreactor Systems with 4 vessels per system (New Brunswick) can be used. Because mammalian cells produce less protein (approximately 1 mg/L) than insect cells (approximately 1 mg/L), 2 to 4 L of culture are used to produce 2 to 4 mg of protein.

If desired, a clone selection step can be performed, resulting in stable producer cell line based production systems (e.g., CHO or E. coli based systems). Exemplary clone selection steps include growing the cells in the presence of an selective antibiotic, e.g., Geneticin, in a multi-well format to select cells likely to contain the expression vector, and then checking each well for the presence of the secreted protein using a standard ELISA assay or other standard assay to detect the his-tag present in the protein.

In addition, high throughput production and screening techniques can be used for any of the methods of the invention. For example, any binding assay (chip, filter, radiolabelled, flourescent, surface plasmon resonance, etc.), production method (e.g., mammalian cells such as CHO, HEK 293, Cos; insect cells such as Drosophila, bacteria such as E. coli, or yeast such as pichia), production systems (e.g., bioreactors (New Brunswick systems by Brandel, flask based, cell cube, surface bound, suspension cultures, serum containing media, or serum free media), and any purification method (HIS tag/nickel column, GST/glutathione, intein, or other affinity column) can be used. Any of these automated and/or high throughput methods can be performed with multiple systems acting in parallel, such as multiple robotic systems (such as multiple SelecT robots from Automation Partnership). For example, 2, 2, 4, 5, 6, 8, 10, 10², 10³, 10⁴, 10⁵, 10⁶, or more targets can be assayed in parallel to select ligands that bind the targets. Similarly, 2, 5, 10, 10², 10³, 10⁴, 10⁵, 10⁶, 10⁷, 10⁸, or 10⁹ or more small molecules of interest can be assayed in parallel to select target molecules that bind the small molecules. Because columns with GFF resin can be regenerated in only seven minutes, multiple assays can also be performed sequentially using the same column with little down time between assay. Additionally, the assay can be automated by sequentialy injecting columns in an HPLC (FIG. 26).

11.1 High-Throughput Production of Membrane Proteins

For the production of membrane proteins, expression constructs such as pMTN5 His-TOPO for expression in Drosophila cells or pcDNA3.1D/V5-His-TOPO for expression in CHO or 293 Cells can be used without a secretory leader sequence but must at least have a membrane leader sequence. Though it is unlikely to be necessary for a membrane protein since the cDNA encodes at least one transmembrane domain, an exogenous transmenbrane domain (e.g., PDGFR transmembrane domain) may be optionally added at the 3′ end of the cDNA to assure insertion into the membrane. This transmembrane domain may be especially useful in the case that the cDNA is not full length A cleavage site is inserted between the 3′ end of a cDNA encoding a membrane protein of interest and V5-His (e.g., a thrombin, Tobacco Etch Virus, or intein-based self-cleaving site). This can also be done for the secreted proteins above. The Drosophila, CHO, or 293 cells are transfected and cultured as described above for secreted proteins. The cells are pelleted and homogenized in Tween 20 (0.05%) containing Lysis Buffer. The mixture is then cleared by centrifugation and purified using a nickel affinity column as described. The V5-His tag is removed by cleavage, and the protein is integrated into micelles. For example, the protein can be dissolved in methanol and mixed with Dodecylphosphocholine (Avanti) in methanol. The methanol is evaporated, and the mixture is dissolved in aqueous buffer without detergent. The protein is then analyzed and used in the binding assays of the present invention as described above. The methods described by Lahiri et al. (J. Amer. Chem. Society 118, 2347-2358, 1996) can also be used to assay the binding of ligands to micelles containing these membrane proteins.

11.2 High-Throughput Production of Linear Expression Constructs

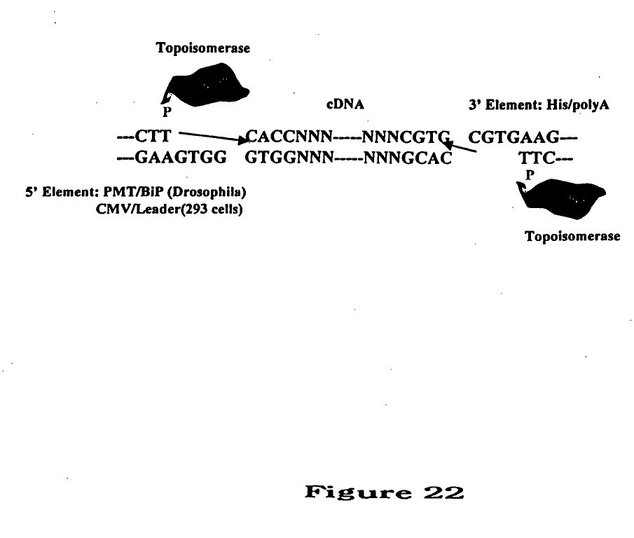

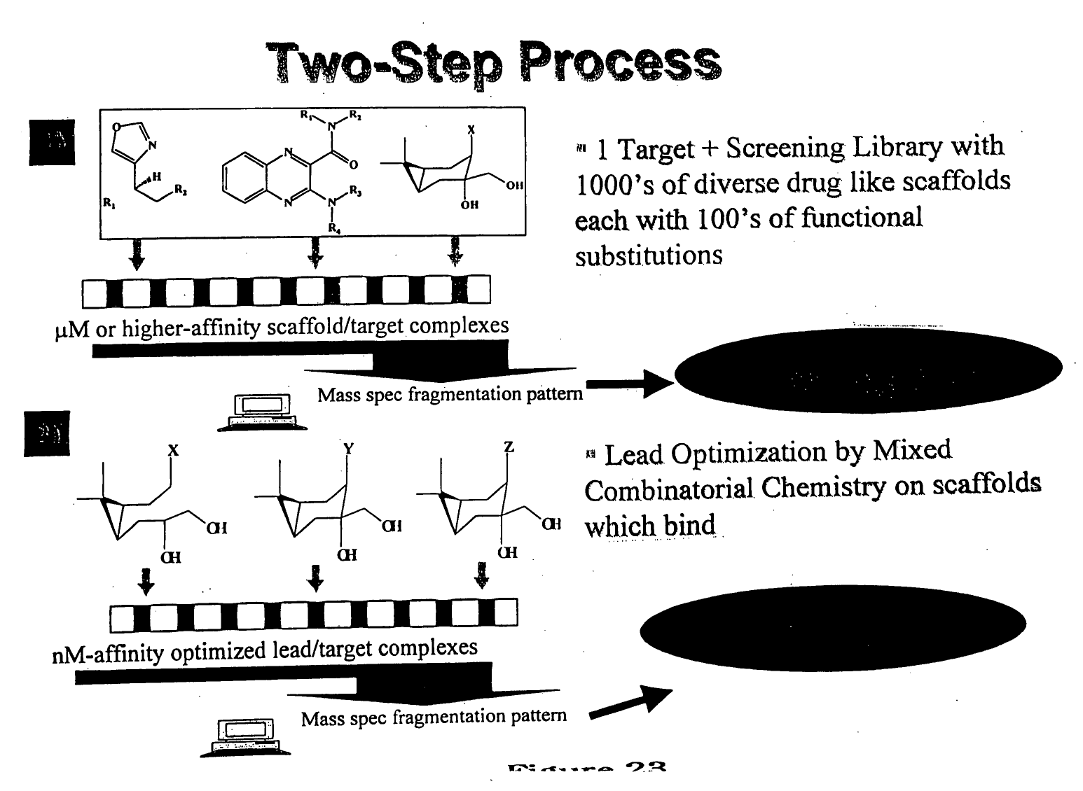

Linear expression constructs may be used instead of circular vectors for the expression of proteins of interest. In contrast to circular vectors which are often amplified by being transfected into bacteria, replicated, and purified; linear expression constructs can be PCR amplified and directly transfected into the cells used for protein expression (e.g., Drosophila cells). As illustrated in FIG. 22, the linear expression constructs are generated by reacting a topoisomerase labeled 5′ nucleic acid containing a promoter and an optional secretory or leader sequence, a nucleic acid (e.g., a cDNA) encoding a protein of interest, and a 3′ nucleic acid containing a sequence encoding an affinity tag (e.g., a hexahistidine tag) and a polyA tail. For a membrane protein, a sequence encoding the PDGFR transmembrane domain may be inserted upstream of the sequence encoding the affinity tag, or this domain may alternatively be present in the cDNA. Preferably, the 5′ component contains a 5′ primer for PCR amplification after the cDNA is inserted; a promoter compatible with the cell type used for expression; an optional leader sequence to target a protein to be secreted, an internal protein, or a membrane protein; and a TOPO sequence. Preferably, the 3′ component contains a 3′ TOPO sequence, a His tag coding sequence or another sequence encoding an affinity tag for standardized purification, a Poly A sequence, and a primer for PCR amplification after cDNA insertion. For expression of two genes, a third component is also used that preferably contains a first 3′ TOPO sequence, a His tag coding sequence or other sequence to facilitate protein purification, a polyA sequence, a spacer, and a promoter for the cell type to be used for expression, an optional leader, and a TOPO sequence. Examples of the components of the 5′ and 3′ ends of these linear constructs are listed in Table 4.

TABLE 4
Construction of topoisomerase linear expression constructs

| Expression system | 5′ end | 3′ end |
|---|---|---|
| Drosphila Secreted | pMT/BiP | His/PolyA |
| Drospophila Membrane | pMT | His/PolyA |
| 293/CHO Secreted | CMV/Leader | His/PolyA/SV40ori |
| 293/Cho Membrane | CMV | His/PolyA/SV40ori |

For the generation of these linear expression constructs, a polylinker containing restriction enzyme sites such as EcoRI can be used. The polylinker may contain any number of restriction enzyme sites including, but not limited to, EcoRI, BamHi, XbaI, SalI, HindIII, PvuII, XhoI, EcoRV, SacI, and BglII. Alternatively, the construct can be made without the polylinker (e.g., made with just one restriction enzyme site). In addition, the SV40 promoter, RSV promoter, EF-1α promoter, ubiquitin promoter, or any other promoter can be substituted for CMV. Similarly dual gene expression constructs can be constructed with expression cassettes containing two promoters (e.g., CMV and EF-1α). Promoters and leaders may be selected to enable constitutive, inducible, transient, stable, surface, secreted, or internally targeted expression. The SV40 origin sequence may be included to allow amplification in the presence of SV40 T antigen expressed in the cell lines. Other origins including, but not limited, to the EBV oriP may alternatively be used. These constructs may be produced using standard molecular biology techniques either as a linear element or as part of a plasmid followed by release by restriction enzyme digestion or by PCR amplification. Each of the elements may be synthesized as an oligomer for elements less than 100 nucleotides in length, isolated by restriction digestion, PCR amplification, or other techniques from a plasmid (e.g., including, but not limited to, PMT/BiP/V5-His A, B, or C, or pCDNA3.1, In vitrogen) and sequentially linked as individual components or groups using standard molecular biology techniques. In the case of PCR amplification of the 5′ element from a plasmid, a primer upstream of the promoter and a second primer (e.g., preferably including a CCCTT sequence for adaptation with topoisomerase and a GTGG or other sequence for directional cloning, see below) downstream of the promoter and the leader may be used. In the case of PCR amplification of the 3′ element, a primer upstream of the V5-His or at least the polyA (e.g., preferably including the CCCTT sequence for adaptation with Topoisomerase) and a second primer downstream of the polyA signal or the Ori, may be used. Alternative construction methods known to those skilled in the art may also be employed.

Once these constructs are made, the EcoRI site is cleaved, and the 3′ strands of DNA at both the 5′ and the 3 end are PCR extended with the CCCTT sequence. Alternatively, an oligo containing the CCCTT sequence may be inserted and cleaved using standard molecular biology techniques. Other slight modifications of these sequences may alternatively be used including an A or a T. These 3′ strands are then adapted with topoisomerase (TOPO; Vaccinia Topisomerase I—Sigma) to produce a covalent DNA (3′ phosphotyrosyl) protein adduct between tyrosine 274 of topoisomerase I and the 3′ T in the DNA sequence. This reaction can be performed by mixing pmole levels of DNA containing the 3′ CCCTT topoisomerase sequence and topoisomerase at a 5 fold excess of topoisomerase in 50 mM Tris at pH 8 (e.g., 0.2 pmole duplex DNA to 1 pmole topoisomerase) using the methods of Sekiguchi et al. (J. Biol. Chem. 272: 15721-15728, 1997). The 5′ and 3′ ends can be modified in this fashion in their linear form or attached to a plasmid with a restriction site which allows their release from the plasmid after they have been labeled with topoisomerase.

These constructs are made in all three reading frames by modifying the PCR amplified element by adding either a single N or a double N on the 5′ strand upstream of the CCCTT topoisomerase sequence. To perform the ligation, each cDNA is PCR amplified to contain a 5′ A on each strand which is complimentary to the 3′ T in the topoisomerase sequence and mixed with the linear TOPO reagents. For a directed ligation in the 5′ and 3′ orientation, the cDNA is PCR amplified using a primer at the 5′ end with CACC, and the 5′ end of the vector is modified with GTGG at the end of the 5′ and 3′ strand by PCR amplification prior to TOPO labeling. A blunt end or an end containing other sequences to achieve directed ligation may also be used. In this case, the 3′ end is either (i) blunt ended on both the cDNA and the 3′ end expression construct by using a proofreading polymerase or (ii) they are as above. The ligation may be performed with high fidelity polymerase (0.5 U Pst). The whole construct is then PCR amplified using the two primers on the 5′ and 3′ ends which rapidly results in linear DNA for transfection into cell lines and does not require bacterial growth. Thus, this method is easily automated. The linear DNA typically integrates into chromosomal DNA and is expressed by the transfected cell. Optionally, the PCR primer distal ends may be ligated into circular form to facilitate Origin based (e.g., SV40 or another ori) amplification after transfection into a cell line expressing the transactivator (e.g., T antigen in the case of SV40 ori). These constructs can be used for transient or stable transfection.

Transfection of the CHO-F line (Life Technologies) with a plasmid expressing the SV40 T antigen adapts these cell lines, which are the classic mammalian cell lines for stable protein production, into a cell line appropriate for high level transient expression with SV40 based or CMV based promoters. Alternatively, 293 cells can be transfected with large T if it is not already expressed. Alternative amplification systems can also be used including transfecting CHO, 293, or anther cell line with other viral proteins such as EBNA 1 from Epstein-Barr Virus for plasmids or linear expression elements containing EBV Ori-P. The cell lines may also be transfected with genes encoding enzymes involved in posttranslational modification, including, but not limited to, those involved in glycosylation (e.g, such as fucosyl transferase 7). Such cell lines produce targets with alternative posttranslational modifications which may be in a specific cell type relevant to the pathology/physiology or pathology. Other examples of cells that can be transfected with a linear construct of the invention include bacteria such as E. coli, insect cells such as a Drosophila cells, or mammalian cells such as a Cos, HEK293, or CHO cells.

### Other Embodiments

From the foregoing description, it will be apparent that variations and modifications may be made to the invention described herein to adopt it to various usages and conditions. Such embodiments are also within the scope of the following claims.

Various publications and patent applications are cited herein, the contents of which are hereby incorporated by reference in their entireties to the same extent as if each independent publication or patent application was specifically and individually indicated to be incorporated by reference.

1. A method for selecting a candidate ligand which binds a target molecule, said method comprising:
(a) contacting an in vitro sample comprising a target molecule with a library of candidate ligands under conditions that allow complex formation between said target molecule and one or more said candidate ligands, wherein said library comprises at least two different chemical scaffolds or comprises at least 11 different compounds;
(b) isolating said complex;
(c) recovering one or more said candidate ligands from said complex; and
(d) identifying one or more recovered candidate ligands.

2. The method of claim 1, wherein step (d) comprises determining the MS, IR, FTIR, NMR, and/or UV spectrum of said recovered candidate ligand.

3. The method of claim 1, wherein at least 100 different candidate ligands are simultaneously contacted with said target molecule.

4. A method for selecting a candidate ligand which binds a target molecule, said method comprising:
(a) contacting an in vitro sample comprising a target molecule with a library of candidate ligands under conditions that allow complex formation between said target molecule and one or more said candidate ligands;
(b) isolating said complex;
(c) recovering one or more said candidate ligands from said complex; and
(d) determining the mass to charge ratio of an isotope or fragment peak in the mass spectrum of a recovered candidate ligand, thereby identifying said recovered candidate ligand.

5. The method of claim 4, wherein at least 100 different candidate ligands are simultaneously contacted with said target molecule.

6. The method of claim 4, wherein step (d) further comprises determining the mass to charge ratio of the parent peak in the mass spectrum of said recovered candidate ligand.

7. A method for selecting a candidate ligand which binds a target molecule, said method comprising:
(a) contacting an in vitro sample comprising a target molecule of unknown biological function with a library of candidate ligands under conditions that allow complex formation between said target molecule and one or more said candidate ligands;
(b) isolating said complex;
(c) recovering one or more said candidate ligands from said complex; and
(d) determining the MS, IR, FTIR, NMR, and/or UV spectrum of a recovered candidate ligand, thereby identifying said recovered candidate ligand.

8. The method of claim 7, wherein at least 100 different candidate ligands are simultaneously contacted with said target molecule.

9. A method for selecting a candidate ligand which binds a target molecule, said method comprising:
(a) contacting an in vitro sample comprising a target molecule with one or more candidate ligands under conditions that allow complex formation between said target molecule and one or more said candidate ligands;
(b) isolating said complex;
(c) recovering one or more said candidate ligands from said complex; and
(d) determining the IR, FTIR, NMR, and/or UV spectrum of a recovered candidate ligand, thereby identifying said recovered candidate ligand.

10. The method of claim 9, wherein at least 100 different candidate ligands are simultaneously contacted with said target molecule.

11. A method for selecting a candidate ligand which binds a target molecule, said method comprising:
(a) contacting an in vitro sample comprising a first target molecule and a second target molecule with a library of candidate ligands under conditions that allow complex formation between said first target molecule and one or more said candidate ligands and allow complex formation between said second target molecule and one or more said candidate ligands;
(b) isolating a first complex comprising said first target molecule bound to a candidate ligand and isolating a second complex comprising said second target molecule bound to a candidate ligand;
(c) recovering one or more said candidate ligands from said first complex and/or from said second complex; and
(d) identifying one or more recovered candidate ligands.

12. The method of claim 11, further comprising contacting said sample with a competitor ligand known to bind said target molecule, said first target molecule, or said second target molecule.

13. A method for determining the biological function of a target molecule, said method comprising:
(a) contacting an in vitro sample comprising a target molecule of unknown biological function with a library of candidate ligands under conditions that allow one or more said candidate ligands to bind said target molecule;
(b) selecting a candidate ligand which binds said target molecule; and
(c) measuring the effect of said selected candidate ligand in a biological assay, thereby determining the biological function of said target molecule.

14. The method of claim 13, further comprising identifying said selected candidate ligand.

15. A method for determining the biological function of a target molecule, said method comprising:
(a) contacting an in vitro sample comprising a target molecule that is upregulated or downregulated in a disease state, in the presence of a physiological stimulus, or during a specific cellular or biological process with a library of candidate ligands under conditions that allow one or more said candidate ligands to bind said target molecule;
(b) selecting a candidate ligand which binds said target molecule; and
(c) measuring the effect of said selected candidate ligand in a biological assay, thereby determining the biological function of said target molecule.

16. The method of claim 15, further comprising identifying said selected candidate ligand.

17. The method of claim 15, wherein said selected candidate ligand increases the activity of said target molecule in said biological assay.

18. The method of claim 15, wherein said selected candidate ligand decreases the activity of said target molecule in said biological assay.

19. A method for determining the biological function of a target molecule, said method comprising:
(a) contacting an in vitro sample comprising a target molecule with a library of candidate ligands under conditions that allow one or more said candidate ligands to bind said target molecule;
(b) selecting a candidate ligand which binds said target molecule; and
(c) measuring the effect of said selected candidate ligand on a tissue from a organism having a disease or disorder or undergoing a specific cellular or biological process in the presence or absence of a physiological stimulus, thereby determining the biological function of said target molecule.

20. The method of claim 19, wherein said tissue is human tissue.

21. A method for reacting two or more ligands that bind a target molecule of interest, said method comprising contacting a cell or in vitro sample comprising a target molecule of unknown secondary or tertiary structure with a first ligand comprising a first crosslinker and with a second ligand under conditions that allow said target molecule to bind said first ligand and said second ligand and allow said first crosslinker to covalently bind said second ligand, thereby generating a crosslinked product comprising said first ligand and said second ligand.

22. A method for reacting two or more ligands that bind a target molecule of interest, said method comprising contacting a cell or in vitro sample comprising a target molecule with a first ligand comprising a first crosslinker and with a second ligand, wherein the location or the tertiary structure of the binding site in said target molecule for said first ligand or said second ligand is unknown, and wherein said contacting is conducted under conditions that allow said target molecule to bind said first ligand and said second ligand and allow said first crosslinker to covalently bind said second ligand, thereby generating a crosslinked product comprising said first ligand and said second ligand.

23. A method for reacting two or more ligands that bind a target molecule of interest, said method comprising contacting a cell or in vitro sample comprising a target molecule with a first ligand and with a second ligand, wherein said contacting is conducted under conditions that allow said target molecule to bind said first ligand and said second ligand and allow said first ligand to covalently bind said second ligand, thereby generating a product comprising said first ligand and said second ligand that has an affinity for said target molecule that is greater than the affinity of said first ligand or said second ligand for said target molecule.

24. A method for reacting two ligands that bind different target molecules, said method comprising contacting a cell or in vitro sample comprising a first target molecule and a second target molecule with a first ligand and with a second ligand, wherein said contacting is conducted under conditions that allow
(i) said first protein to bind said first ligand,
(ii) said second protein to bind said second ligand, and
(iii) said first ligand to covalently bind said second ligand, thereby generating a product comprising said first ligand and said second ligand; and wherein the location or the tertiary structure of the binding site in said first target molecule for said first ligand and/or the location or the tertiary structure of the binding site in said second target molecule for said second ligand is unknown.

25. The method of claim 24, wherein the generation of said product indicates that said first protein and said second protein interact in vivo.

26. A method for isolating a second protein which binds a first protein, said method comprising:
(a) contacting a cell or an in vitro sample comprising a first protein and a second protein with a first ligand comprising a first ligand and with a second ligand under conditions that allow
(i) said first protein to bind said first ligand,
(ii) said second protein to bind said second ligand, and
(iii) said first ligand to covalently bind said second ligand, thereby generating a product comprising said first ligand and said second ligand and generating a complex comprising said product, said first protein, and said second protein;
(b) isolating said complex; and
(c) identifying said first protein and/or said second protein in said complex or recovered from said complex.

27. The method of claim 26, wherein said first protein comprises a detectable group.

28. The method of claim 26, wherein said second ligand comprises a crosslinker.

29. The method of claim 26, wherein the generation of said product indicates that said first protein and said second protein interact in vivo.

30. The method of claim 26, wherein the affinity of said product for said target molecule is greater than the affinity of said first ligand or said second ligand for said target molecule.

31. The method of claim 26, wherein said product is used in drug discovery or development or lead optimization.

32. The method of claim 26, wherein said product is used in the development of an agricultural or environmental agent.

33. A method for selecting a candidate target molecule which binds a small molecule of interest, said method comprising:
(a) contacting an in vitro sample comprising a small molecule of interest having a moiety other than an amino acid or having a molecular weight less than 4000 daltons with a library of candidate target molecules under conditions that allow complex formation between said small molecule of interest and one or more said candidate target molecules; wherein said target molecules are not expressed on the surface of phage;
(b) isolating said complex; and
(c) recovering one or more said candidate target molecules from said complex, thereby selecting one or more candidate target molecules which bind said small molecule of interest.

34. The method of claim 33, wherein, prior to step (a), said small molecule of interest is selected from a library of small molecules based on its effect in a biological assay.

35. A method for selecting a target protein which binds a small molecule of interest, said method comprising:
(a) expressing in a population of cells a protein fusion comprising a target protein covalently linked to surface protein, said expression being carried out under conditions that allow the display of said protein fusion on the surface of said cells;
(b) contacting said cells with a small molecule of interest having a moiety other than an amino acid or having a molecular weight less than 4000 daltons; and
(c) selecting said cells which bind said small molecule of interest, thereby selecting said target proteins which bind said small molecule of interest.

36. The method of claim 35, wherein said cell is a mammalian, bacterial, yeast, or insect cell.

37. A method for selecting a target protein which binds a small molecule of interest, said method comprising:
(a) expressing in a population of cells a protein fusion comprising a target protein covalently linked to surface protein, said expression being carried out under conditions that allow the display of said protein fusion on the surface of viruses released from said cells infected with said virus;
(b) contacting said viruses with a small molecule of interest, wherein said small molecule of interest
(i) is a nucleic acid,
(ii) is a carbohydrate,
(iii) is a lipid
(iv) has a moiety other than an amino acid,
(v) has a molecular weight less than 750 daltons, or
(vi) is not a molecule naturally produced by bacteria, and
(c) selecting said viruses which bind said small molecule of interest, thereby selecting said target proteins which bind said small molecule of interest.

38. The method of claim 37, wherein said virus is a bacteriophage or adenovirus.

39. A method for selecting a target protein which binds a small molecule of interest, said method comprising:
(a) expressing in a population of cells or an in vitro sample a library of target proteins, wherein each target protein is covalently linked to a nucleic acid encoding said target protein;
(b) contacting said cells or in vitro sample with a small molecule of interest having a moiety other than an amino acid or having a molecular weight less than 4000 daltons; and
(c) selecting said target proteins which bind said small molecule of interest.

40. The method of claim 39, further comprising identifying said selected target protein.

41. The method of claim 39, wherein at least 100 human target proteins are contacted with said small molecule of interest.

42. The method of claim 39, wherein said small molecule of interest is a non-naturally occurring molecule.

43. A method for selecting a candidate compound that binds or modulates the activity of a target molecule prior to validation of said target molecule as a drug target, said method comprising:
(a) contacting a cell or an in vitro sample comprising a target molecule that has not been previously validated as a drug target with a library of candidate compounds under conditions that allow one or more said candidate compounds to bind or modulate the activity of said target molecule; and
(b) selecting a candidate compound which binds or modulates the activity of said target molecule.

44. The method of claim 43, wherein said library comprises at least five candidate compounds.

45. The method of claim 43, further comprises the step of (c) measuring the effect of said selected candidate compound in a biological assay, thereby determining the biological function of said target molecule.

46. A method for selecting candidate compounds that bind or modulate the activity of target molecules, said method comprising:
(a) contacting a cell or an in vitro sample comprising a first target molecule and a second target molecule with a library of candidate compounds under conditions that allow one or more said candidate compound to bind or modulate the activity of said first target molecule and allow one or more said candidate compound to bind or modulate the activity of said second target molecule;
(b) selecting a candidate compound which binds or modulates the activity of said first target molecule; and
(c) selecting a candidate compound which binds or modulates the activity of said second target molecule.

47. The method of claim 46, wherein said cell or in vitro sample comprises at least five target molecules, and wherein, for each of said target molecules, a candidate compound is selected that binds or modulates the activity of said target molecule.

48. An electronic database comprising at least 10 records of target molecules correlated to records of ligands and their ability to bind or modulate the activity of said target molecules.

49. The database of claim 48, comprising records for at least 0.5% of the proteins in the proteome of an organism.

50. An electronic database comprising at least 10 records of target molecule domains correlated to records of ligands and their ability to bind said domains.

51. An electronic database comprising a plurality of records of target molecules that have not been previously validated as drug targets correlated to records of ligands and their ability to bind or modulate the activity of said target molecules.

52. A computer comprising the database of claim 48, 50, or 51, and a user interface (i) capable of displaying one or more ligands that bind or modulate the activity of a target molecule whose record is stored in said computer or (ii) capable of displaying one or more target molecules that bind or have an activity that is modulated by a ligand whose record is stored in said computer.

53. An electronic database comprising at least 1000 records of compounds correlated to records of a phenotype in one or more biological assays effected by said compounds; wherein said biological assay involves a cell or in vitro sample that does not contain an exogenous copy of a nucleic acid encoding a protein that binds said compound.

54. A computer comprising the database of claim 53 and a user interface (i) capable of displaying one or more phenotypes in one or more biological assays for a compound whose record is stored in said computer or (ii) capable of displaying one or more compounds that effects a phenotype whose record is stored in said computer.

55. An electronic database comprising at least 10 records of target molecules correlated to records of an expression profile or activity of said target molecules.

56. An electronic database comprising a plurality of records of target molecules that have not been previously validated as drug targets correlated to records of an expression profile or activity of said target molecules.

57. A computer comprising the database of claim 55 or 56 and a user interface (i) capable of displaying one or more expression profiles or activities of a target molecule whose record is stored in said computer or (ii) capable of displaying one or more target molecules that have an expression profile or activity whose record is stored in said computer.

58. A method of identifying a target molecule associated with a phenotype of interest, said method comprising:
(a) providing a first electronic database comprising a plurality of records of phenotypes in a biological assay correlated to records of the ligands and their ability to contribute to said phenotypes;
(b) receiving a selection of a phenotype of interest;
(c) identifying one or more ligands in said first database which cause said phenotype of interest;
(d) providing a second electronic database comprising a plurality of records of ligands correlated to records of the target molecules which bind said ligands or have an activity that is modulated by said ligands; and
(e) identifying one or more target molecules in said second database that bind or are modulated by said ligand(s) which cause said phenotype of interest, thereby identifying one or more target molecules associated with said phenotype of interest.

59. The method of claim 58, wherein said phenotype of interest is associated with a disease state, and said target molecule is determined to promote or inhibit said disease state.

60. The method of claim 58 wherein said method is computer implemented.

61. A method of identifying a phenotype that is associated with a target molecule of interest, said method comprising:
(a) providing a first electronic database comprising a plurality of records of target molecules correlated to records of the ligands and their ability to bind or modulate the activity of said target molecules;
(b) receiving a selection of a target molecule of interest;
(c) identifying one or more ligands in said first database which bind or modulate the activity of said target molecule of interest;
(d) providing a second electronic database comprising a plurality of records of ligands correlated to records of phenotypes in a biological assay caused by said ligands; and
(e) identifying one or more phenotypes in said second database caused by said ligand(s), thereby identifying one or more phenotypes associated with said target molecule of interest.

62. The method of claim 61, wherein said method is computer implemented.

63. A method of identifying a ligand that binds or modulates the activity of a target molecule of interest, said method comprising:
(a) providing an electronic database comprising at least 10 records of target molecules correlated to records of the ligands and their ability to bind or modulate the activity of said target molecules;
(b) receiving a selection of a target molecule of interest; and
(c) identifying one or more ligands in said database which bind or modulate the activity of said target molecule of interest.

64. The method of claim 63, wherein said ligand is used in drug discovery or development or lead optimization.

65. The method of claim 63, wherein said ligand is used in the development of an agricultural or environmental agent.

66. The method of claim 63, wherein said method is computer implemented.

67. The method of claim 63, further comprising comparing the chemical structures of two or more ligands which bind or modulate the activity of said target molecule of interest, thereby identifying functional groups in said ligands which promote the binding or modulation of said target molecule of interest.

68. The method of claim 63, further comprising comparing the chemical structures of two or more ligands which bind or modulate the activity of said target molecule of interest, thereby determining the frequency of one or more functional groups or scaffolds in the collection of said ligands.

69. The method of claim 63, further comprising generating one or more compounds that have one or more functional groups that are present in two or more of said ligands; wherein said compound is used in drug discovery or development or lead optimization.

70. A method of identifying a target molecule that binds or has an activity that is modulated by a ligand of interest, said method comprising:
(a) providing an electronic database comprising at least 10 records of ligands correlated to records of the target molecules which bind or have an activity that is modulated by said ligands;
(b) receiving a selection of a ligand of interest; and
(c) identifying one or more target molecules in said database which bind or have an activity that is modulated by said ligand of interest.

71. The method of claim 70, wherein said method is computer implemented.

72. A method for determining the selectivity of a ligand of interest, said method comprising:
(a) providing an electronic database comprising at least 10 records of target molecules correlated to records of the ligands and their ability to bind or modulate the activity of said target molecules;
(b) receiving a selection of a ligand of interest; and
(c) determining the number of target molecules in said database that bind or are modulated by said ligand, thereby determining the selectivity of said ligand of interest.

73. The method of claim 72, wherein said method is computer implemented.

74. The method of claim 72, wherein said ligand increases an activity of a target molecule, wherein said activity is associated with a disease state, an adverse side-effect, or toxicity and said ligand is eliminated from drug discovery or development or lead optimization.

75. The method of claim 72, wherein said ligand decreases an activity of a target molecule, wherein said activity is associated with a disease state, an adverse side-effect, or toxicity and said ligand is selected for drug discovery or development or lead optimization.

76. A method of for selecting a therapy for a subject for the treatment, stabilization, or prevention of a disease or disorder, said method comprising:
(a) providing an electronic database comprising at least 10 records of target molecules correlated to records of the therapeutics and their ability to bind or modulate the activity of said target molecules;
(b) determining a target molecule in said subject that has a mutation associated with said disease or disorder; and
(c) selecting a therapeutic from said database that binds or modulates the activity of said target molecule and thereby treats, stabilizes, or prevents said disease or disorder.

77. The method of claim 75, wherein said method is computer implemented.

78. A method of for selecting a therapy for a subject for the treatment, stabilization, or prevention of a disease or disorder, said method comprising:
(a) providing an electronic database comprising at least 10 records of target molecules correlated to records of the therapeutics and their ability to bind or modulate the activity of said target molecules;
(b) determining a target molecule in said subject that has a mutation associated with said disease or disorder;
(c) selecting a therapeutic from said database that does not bind or modulate the activity of said target molecule.

79. The method of claim 78, wherein said target molecule is a protein.

80. The method of claim 78, wherein said target molecule is a nucleic acid.

81. The method of claim 78, wherein said method is computer implemented.

82. A method of determining whether a compound of interest is present in a sample, said method comprising:
(a) providing reference mass spectra for two or more compounds from a library of compounds;
(b) providing a test mass spectrum of a sample comprising one or more compounds from said library; and
(c) determining whether peaks of a reference mass spectrum are included in said test mass spectrum, thereby determining whether the compound that generated said reference mass spectrum is present in said sample.

83. The method of claim 82, wherein said reference mass spectra are sequentially or simultaneously analyzed until all of the peaks in said test mass spectrum have been assigned to a compound.

84. The method of claim 82, wherein step (c) comprises a sequential determination of whether the peaks of one or more reference mass spectrum are included in said test mass spectrum.

85. The method of claim 82, wherein step (c) is repeated until either
(i) all of the peaks in said reference mass spectrum are determined to be present in said test mass spectrum, thereby determining that the compound that generated said reference mass spectrum is present in said sample; or
(ii) a peak in said reference mass spectrum is determined to be absent in said test mass spectrum, thereby determining that the compound that generated said reference mass spectrum is not present in said sample.

86. The method of claim 82, wherein step (a) comprises determining the mass spectrum of each compound in said library.

87. The method of claim 82, wherein at least one of the peaks in said reference spectrum is an isotope peak or a fragment peak.

88. The method of claim 82, wherein at least one of the peaks in said reference spectrum is a parent peak.

89. The method of claim 82, wherein said reference mass spectrum are contained in a database comprising records of one or more properties of mass spectra correlated to references of compounds that generate said mass spectra.

90. The method of claim 82, wherein step (c) is computer implemented.

91. A method of determining whether a compound of interest is present in a sample, said method comprising:
(a) providing reference mass spectra for two or more compounds from a library of compounds;
(b) providing a test mass spectrum of a sample comprising one or more compounds from said library;
(c) determining whether one or more peaks of said test mass spectrum are included in a reference mass spectrum; and
(d) determining whether all of the peaks in a reference mass spectrum are present in said test mass spectrum, wherein said reference mass spectrum is a reference mass spectrum from step (c) that contains a peak present in said test mass spectrum, thereby determining whether the compound that generated said reference mass spectrum is present in said sample.

92. The method of claim 91, wherein step (d) comprises a sequential determination of whether the peaks of one or more reference mass spectrum are included in said test mass spectrum.

93. The method of claim 91, wherein step (d) comprises determining whether a peak in said reference mass spectrum is present in test mass spectrum, wherein said determination is repeated until either
(i) all of the peaks in said reference mass spectrum are determined to be present in said test mass spectrum, thereby determining that the compound that generated said reference mass spectrum is present in said sample; or
(ii) a peak in said reference mass spectrum is determined to be absent in said test mass spectrum, thereby determining that the compound that generated said reference mass spectrum is not present in said sample.

94. The method of claim 91, wherein step (a) comprises determining the mass spectrum of each compound in said library.

95. The method of claim 91, wherein at least one of the peaks in said reference spectrum is an isotope peak or a fragment peak.

96. The method of claim 91, wherein at least one of the peaks in said reference spectrum is a parent peak.

97. The method of claim 91, wherein said reference mass spectrum are contained in a database comprising records of one or more properties of mass spectra correlated to references of compounds that generate said mass spectra.

98. The method of claim 97, wherein said property is selected from the group consisting of: the mass to charge ratio of an isotope peak, the mass to charge ratio of a fragment peak; the mass to charge ratio of a parent peak, and the intensity of a peak.

99. The method of claim 97, wherein step (c) or step (d) is computer implemented.

100. A computer-readable memory having stored thereon a program for determining whether a compound of interest is present in a sample comprising:
a) computer code that receives as input mass spectrometry data comprising the mass to charge ratio for one or more peaks in reference mass spectra for two or more compounds from a library of compounds;
b) computer code that receives as input mass spectrometry data comprising the mass to charge ratio for one or more-peaks in a test mass spectra of a sample comprising one or more compounds from said library; and
(c) computer code that determines whether peaks of a reference mass spectrum are included in said test mass spectrum, thereby determining whether the compound that generated said reference mass spectrum is present in said sample.

101. A computer-readable memory having stored thereon a program for determining whether a compound of interest is present in a sample comprising:
a) computer code that receives as input mass spectrometry data comprising the mass to charge ratio for one or more peaks in reference mass spectra for two or more compounds from a library of compounds;
b) computer code that receives as input mass spectrometry data comprising the mass to charge ratio for one or more peaks in a test mass spectra of a sample comprising one or more compounds from said library;
(c) computer code that determines whether one or more peaks of said test mass spectrum are included in a reference mass spectrum; and
(d) computer code that determines whether all of the peaks in a reference mass spectrum are present in said test mass spectrum, thereby determining whether the compound that generated said reference mass spectrum is present in said sample.

102. A method of producing two or more vectors encoding proteins of interest, said method comprising:
(a) robotically contacting a first nucleic acid encoding a first protein of interest with a first backbone nucleic acid in a first compartment in a robotic device under conditions that permit their reaction, thereby producing a first vector encoding said first protein; and
(b) robotically contacting a second nucleic acid encoding a second protein of interest with a second backbone nucleic acid in a second compartment in said robotic device under conditions that permit their reaction, thereby producing a second vector encoding said second protein.

103. The method of claim 102, further comprising:
(c) robotically contacting said first vector with a first cell under conditions that allow the insertion of said first vector into said first cell; and
(d) robotically contacting said second vector with a second cell under conditions that allow the insertion of said second vector into said second cell.

104. The method of claim 103, wherein said first cell expresses said first protein and said second cell expresses said second protein.

105. The method of claim 102, wherein at least 5 vectors are produced simultaneously.

106. A method of purifying proteins, said method comprising:
(a) expressing a first protein in a first cell under conditions that result in the secretion of said first protein into a first medium in a robotic device;
(b) expressing a second protein in a second cell under conditions that result in the secretion of said second protein into a second medium in said robotic device;
(c) robotically transferring said first medium to a first chromatography column and said second medium to a second chromatography column; and
(d) purifying said first protein and said second protein.

107. The method of claim 106, wherein at least 5 proteins are purified simultaneously.

108. A DNA molecule comprising a promoter operably linked to a secretory or leader sequence, wherein said DNA molecule is linear and less than 3,500 nucleotides in length.

109. The DNA molecule of claim 108, wherein said DNA molecule is less than 1,000 nucleotides in length.

110. The DNA molecule of claim 109, wherein said DNA molecule is less than 500 nucleotides in length.

111. The DNA molecule of claim 108, wherein said DNA molecule is labeled with topoisomerase.

112. A DNA molecule comprising a promoter, wherein said DNA molecule is linear, less than 3,500 nucleotides in length, and labeled with topoisomerase.

113. The DNA molecule of claim 112, wherein said DNA molecule is less than 1,000 nucleotides in length.

114. The DNA molecule of claim 113, wherein said DNA molecule is less than 500 nucleotides in length.

115. A DNA molecule comprising a nucleic acid segment encoding a histidine affinity tag and a nucleic acid segment encoding a polyA region, wherein said DNA molecule is linear and less than 3,500 nucleotides in length.

116. The DNA molecule of claim 115, wherein said DNA molecule is less than 1,000 nucleotides in length.

117. The DNA molecule of claim 116, wherein said DNA molecule is less than 500 nucleotides in length.

118. The DNA molecule of claim 115, wherein said DNA molecule is labeled with topoisomerase.

119. A DNA molecule comprising a first promoter operably linked to (i) a nucleic acid segment encoding a first protein of interest and a histidine affinity tag and (ii) a first polyA region, wherein said DNA molecule is linear.

120. A DNA molecule of claim 119, wherein said nucleic acid segment encoding said first protein is operably linked to a secretory or leader sequence.

121. The DNA molecule of claim 119, wherein said DNA molecule is less than 3,500 nucleotides in length.

122. The DNA molecule of claim 121, wherein said DNA molecule is less than 1,000 nucleotides in length.

123. The DNA molecule of claim 119, wherein said DNA molecule is labeled with topoisomerase.

124. The DNA molecule of claim 119, further comprising a nucleic acid segment encoding a second protein of interest operably linked to said first promoter.

125. The DNA molecule of claim 119, further comprising a second promoter operably linked to (i) a nucleic acid segment encoding a second protein of interest and (ii) a second polyA region.

126. A method of producing a linear DNA molecule encoding a protein of interest, said method comprising robotically contacting a DNA molecule of claim 112, a linear DNA molecule encoding a first protein of interest, and a DNA molecule of claim 118 in a first compartment in a robotic device under conditions that permit their reaction, thereby producing a first linear DNA molecule encoding said first protein.

127. The method of claim 126, further comprising robotically contacting a DNA molecule of claim 112, a linear DNA molecule encoding a second protein of interest, and a DNA molecule of claim 118 in a second compartment in said robotic device under conditions that permit their reaction, thereby producing a second linear DNA molecule encoding said second protein.

128. The method of claim 127, further comprising:
(c) robotically contacting said first linear DNA molecule with a first cell under conditions that allow the insertion of said first linear DNA molecule into said first cell; and
(d) robotically contacting said second linear DNA molecule with a second cell under conditions that allow the insertion of said second linear DNA molecule into said second cell.

129. The method of claim 128, wherein said first cell expresses said first protein and said second cell expresses said second protein.

130. The method of claim 127, wherein at least 5 linear DNA molecules are produced simultaneously.

131. A method of purifying a protein, said method comprising:
(a) expressing a first protein in a first cell comprising a DNA molecule of claim 119 under conditions that result in the secretion of said first protein into, a first medium in a robotic device;
(b) robotically transferring said first medium to a first chromatography column; and
(c) purifying said first protein.

132. The method of claim 131, further comprising:
(d) expressing a second protein in a second cell comprising a DNA molecule of claim 119 under conditions that result in the secretion of said second protein into a second medium in said robotic device;
(e) robotically transferring said second medium to a second chromatography column; and
(f) purifying said second protein.

133. The method of claim 132, wherein at least 5 proteins are purified simultaneously.

134. A CHO cell that is transiently transfected with a nucleic acid encoding an mRNA or protein of interest.

135. The cell of claim 134, wherein said nucleic acid is a linear DNA molecule.

136. The cell of claim 134, wherein said cell is transiently or stably transfected with a nucleic acid encoding SV40 T antigen.

137. The method of claim 23, further comprising:
a) contacting an in vitro sample comprising said target molecule with one or more said products under conditions that allow complex formation between said target molecule and one or more said products;
(b) isolating said complex;
(c) recovering one or more said products from said complex; and
(d) identifying one or more said recovered products.

138. A method for selecting a candidate ligand which binds a target molecule, said method comprising:
(a) contacting an in vitro sample comprising a target molecule with a library of candidate ligands under conditions that allow complex formation between said target molecule and more than one candidate ligand;
(b) isolating said complex;
(c) recovering more than one candidate ligand from said complex; and
(d) contacting a cell or in vitro sample comprising said target molecule with a first recovered ligand and a second recovered ligand, wherein said contacting is conducted under conditions that allow said target molecule to bind said first recovered ligand and said second recovered ligand and allow said first recovered ligand to covalently bind said second recovered ligand, thereby generating a product comprising said first recovered ligand and said second recovered ligand that has an affinity for said target molecule that is greater than the affinity of said first recovered ligand or said second recovered ligand for said target molecule.

139. The method of claim 138, further comprising:
(e) contacting an in vitro sample comprising said target molecule with one or more said products under conditions that allow complex formation between said target molecule and one or more said products;
(f) isolating said complex;
(g) recovering one or more said products from said complex; and
(h) identifying one or more said recovered products.

140. A method for selecting a candidate ligand which binds a target molecule, said method comprising:
(a) contacting an in vitro sample comprising a target molecule with a library of candidate ligands under conditions that allow complex formation between said target molecule and more than one candidate ligand;
(b) isolating said complex;
(c) recovering more than one candidate ligand from said complex; and
(d) reacting a first recovered ligand and a second recovered ligand, thereby generating a product comprising said first recovered ligand and said second recovered ligand that has an affinity for said target molecule that is greater than the affinity of said first recovered ligand or said second recovered ligand for said target molecule.

141. The method of claim 140, further comprising:
(e) contacting an in vitro sample comprising said target molecule with one or more said products under conditions that allow complex formation between said target molecule and one or more said products;
(f) isolating said complex;
(g) recovering one or more said products from said complex; and
(h) identifying one or more said recovered products.


SEQUENCE LISTING (9 sequences)

SEQ ID NO: 1 - DNA, 350 bp, Drosophila
cgttgcaggacaggatgtggtgcccgatgtgactagctctttgctgcaggccgtcctatcctctggttccgataagagacccagaactccggccccccaccacccccatacatatgtggtacgcaagtaagagtgcctgcgcatgccccatgtgccccaccaagagttttgcatcccatacaagtccccaaagtggagaaccgaaccaattcttcgcgggcagaacaaaagcttctgcacacgtctccactcgaatttggagccggccggcgtgtgcaaaagaggtgaatcgaacgaaagacccgtgtgtaaagccgcgtttccaaaatgtataaaaccgagagcatctg

SEQ ID NO: 2 - DNA, 54 bp, Drosophila
atgaagttatgcatattactggccgtcgtggcctttgttggcctctcgctcggg

SEQ ID NO: 3 - DNA, 21 bp, artificial sequence
  His tag
catcatcaccatcaccattga

SEQ ID NO: 4 - DNA, 597 bp, cytomegalovirus
gcgcgttgacattgattattgactagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaagtacgtcaatgggtggactatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagc

SEQ ID NO: 5 - DNA, 13 bp, cytomegalovirus
tctctggctaact

SEQ ID NO: 6 - DNA, 78 bp, artificial sequence
  promoter initiation sequence
atggagacagacacactcctgctatgggtactgctgctctgggtactgctgctctgggttccaggttccactggtgac

SEQ ID NO: 7 - DNA, 21 bp, artificial sequence
  His tag
catcatcaccatcaccattga

SEQ ID NO: 8 - DNA, 156 bp, bos sp
gtttaaacccgctgatcagcctcgactgtgccttctagttgccagccatctgttgtttgcccctcccccgtgccttccttgaccctggaaggtgccactcccactgtcctttcctaataaaatgaggaaattgcatcgcattgtctgagtaggtgt

SEQ ID NO: 9 - DNA, 340 bp, Simian virus 40
ttgcaaaagcctaggcctccaaaaaagcctcctcactacttctggaatagctcagaggccgaggaggcggcctcggcctctgcataaataaaaaaaattagtcagccatggggcggagaatgggcggaactgggcggagttaggggcgggatgggcggagttaggggcgggactatggttgctgactaattgagatgcatgctttgcatacttctgcctgctggggagcctggggactttccacacctggttgctgactaattgagatgcatgctttgcatacttctgcctgctggggagcctggggactttccacaccctaactgacacacattccaca